(19) United States
(12) Patent Application Publication
(10) Pub. No.: US 2013/0297477 A1
(43) Pub. Date: Nov. 7, 2013

(54) CONTINUOUS MEASUREMENT AND INDEPENDENT VERIFICATION OF THE QUALITY OF DATA AND PROCESS USED TO VALUE STRUCTURED DERIVATIVE INFORMATION PRODUCTS

(71) Applicant: MINDMODE CORPORATION, (US)

(72) Inventors: Stephen Overman, Renton, WA (US); Geoffrey S.L. Shaw, Scottsdale, AZ (US)

(21) Appl. No.: 13/764,530

(22) Filed: Feb. 11, 2013

Related U.S. Application Data
(63) Continuation of application No. 12/577,692, filed on Oct. 12, 2009, now abandoned.
(60) Provisional application No. 61/195,836, filed on Oct. 11, 2008.

(51) Int. Cl. G06Q 40/04

(52) U.S. Cl. CPC G06Q 40/04
USPC 705/37

(57) ABSTRACT

One embodiment of the present invention relates to a system for measurement and verification of data related to at least one financial derivative instrument, wherein the data related to the at least one financial derivative instrument is associated with at least a first financial institution and a second financial institution, and wherein the first financial institution and the second financial instruction are different from one another.

### RELATED APPLICATIONS

This application is a continuation of application Ser. No. 12/577,692 filed Oct. 12, 2009, entitled Continuous Measurement and Independent Verification of the Quality of Data and Processes Used to Value Structured Derivative Information Products, which claims the benefit of U.S. Provisional Application Ser. No. 61/195,836, filed Oct. 11, 2008. The aforementioned applications are incorporated herein by reference in their entirety.

### FIELD OF THE INVENTION

Data processing systems or methods that are specially adapted for managing, promoting or practicing commercial or financial activities

### BACKGROUND OF THE INVENTION

Systems for managing data regarding derivatives trades in support of a clearinghouse are described in US 2005/0096931 A1 to Baker et al. published May 5, 2005. A system for providing automation or semi-automation of trade execution and record keeping services is described in US 2008/0140587 A1 to Murphy et al.

### SUMMARY OF THE INVENTION

In one example, measurement (e.g., continuous measurement) and/or verification (e.g., independent verification) of the quality of data and/or processes used to value one or more products (e.g., one or more structured derivative information products) may be provided.

One embodiment of the present invention relates to a system for measurement and verification of data related to at least one financial derivative instrument, wherein the data related to the at least one financial derivative instrument is associated with at least a first financial institution and a second financial institution, and wherein the first financial institution and the second financial institution are different from one another.

### BRIEF DESCRIPTION OF THE DRAWINGS

FIGS. 1-8 show block diagrams related to various data provenance examples according to embodiments of the present invention.

FIGS. 9-12 show block diagrams related to various mortgage backed securities/asset backed securities examples according to embodiments of the present invention.

FIG. 13 shows block diagram related to a policy example according to an embodiment of the present invention.

FIGS. 14-16 show block diagrams related to various business examples according to embodiments of the present invention.

FIG. 17 shows a block diagram related to a trusted data exchange example according to an embodiment of the present invention.

FIGS. 18-25 show block diagrams related to various model/simulation examples according to embodiments of the present invention.

FIG. 26 shows a block diagram related to a policy example according to an embodiment of the present invention.

FIGS. 27-29 shows block diagrams related to model/simulation examples according to embodiments of the present invention.

FIG. 30 shows a block diagram related to a high-level abstraction example according to an embodiment of the present invention.

FIG. 31 shows a block diagram related to a client framework development tools example according to an embodiment of the present invention.

FIGS. 32-33 shows block diagrams related to a “Perspective Computing” example according to embodiments of the present invention.

FIGS. 34-37 show block diagrams related to various tracking/license manager examples according to embodiments of the present invention.

FIG. 38 shows a block diagram related to a “Perspective Computing” services life cycle example according to an embodiment of the present invention.

FIGS. 39-50 show block diagrams related to various business capability exploration examples according to embodiments of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, some features may be exaggerated to show details of particular components (and any data, size, material and similar details shown in the figures are, of course, intended to be illustrative and not restrictive). Therefore, specific structural and functional details disclosed herein are not to be interpreted as limiting, but merely as a representative basis for teaching one skilled in the art to variously employ the present invention.

In one embodiment, a system for measurement and verification of data related to at least one financial derivative instrument, wherein the data related to the at least one financial derivative instrument is associated with at least a first financial institution and a second financial institution, and wherein the first financial institution and the second financial institution are different from one another is provided, comprising: at least one computer; and at least one database associated with the at least one computer, wherein the at least one database stores data relating to at least: (a) a first quality of the data metric related to the at least one financial derivative instrument, wherein the first quality of data metric is associated with the first financial institution (in various examples, the first quality of data metric may be input by the first financial institution (e.g., one or more employees and/or agents); the first quality of data metric may be made by the first financial institution (e.g., one or more employees and/or agents); and/or the first quality of data metric may be verified by the first financial institution (e.g., one or more employees and/or agents)); and (b) a second quality of the data metric related to the at least one financial derivative instrument, wherein the second quality of data metric is associated with the second financial institution (in various examples, the second quality of data metric may be input by the second financial institution (e.g., one or more employees and/or agents); the second quality of data metric may be made by the second financial institution (e.g., one or more employees and/or agents); and/or the second quality of data metric may be verified by the second financial institution (e.g., one or more employees and/or agents)); wherein the at least one computer is in operative communication with the at least one database; and wherein the at least one computer and the at least one database cooperate to dynamically map a change of the quality of the data, as reflected in at least the first data metric and the second data metric.

In one example, the measurement and verification of data may relate to a plurality of financial derivative instruments.

In another example, the financial derivative instrument may be a financial instrument that is derived from some other asset, index, event, value or condition.

In another example, each of the first and second financial institutions may be selected from the group including (but not limited to): (a) bank; (b) credit union; (c) hedge fund; (d) brokerage firm; (e) asset management firm; (f) insurance company.

In another example, a plurality of computers may be in operative communication with the at least one database.

In another example, the at least one computer may be in operative communication with a plurality of databases.

In another example, a plurality of computers may be in operative communication with a plurality of databases.

In another example, the at least one computer may be a server computer.

In another example, the dynamically mapping may be carried out essentially continuously.

In another example, the dynamically mapping may be carried out essentially in real-time. In another example, the system may further comprise at least one software application.

In another example, the at least one software application may operatively communicate with the at least one computer.

In another example, the at least one software application may be installed on the at least one computer.

In another example, the at least one software application may operatively communicate with the at least one database.

In another example, the system may further comprise a plurality of software applications.

In another example, the computing system may include one or more programmed computers.

In another example, the computing system may be distributed over a plurality of programmed computers.

In another example, any desired input (e.g., data input) may be made (e.g. to any desired computer and/or database) by one or more users (e.g., agent(s) and/or employee(s) of one or more financial institution(s); agent(s) and/or employee(s) of one or more other institution(s); agent(s) and/or employee(s) of one or more third party or parties).

In another example, any desired output (e.g., data output) may be made (e.g. from any desired computer and/or database) to one or more users (e.g., agent(s) and/or employee(s) of one or more financial institution(s); agent(s) and/or employee(s) of one or more other institution(s); agent(s) and/or employee(s) of one or more third party or parties).

In another example, any desired output may comprise hardcopy output (e.g., from one or more printers), one or more electronic files, and/or output displayed on a monitor screen or the like.

In another example, mapping a change of quality of data may be carried out over time.

In another example, mapping a change of quality of data may comprise outputting one or more relationships and/or metrics.

In another example, mapping a change of quality of data may be done for one or more “networks” (e.g., a network of financial institutions, a network of people, a network of other entities and/or any combination of the aforementioned parties).

In another example, a “network” may be defined by where a given instrument (e.g., financial instrument) goes.

In another example, a “network” may be defined by the party or parties that own (at one time or another) a given instrument (e.g., financial instrument).

In another example, a “network” may be discovered by contract or the like.

In another example, as a financial institution (e.g., a bank) begins to trade in derivatives (e.g., with one or more default contracts) so-called PERSPECTACLES according to various embodiments of the present invention may show transparency.

In another example, one or more computers may comprise one or more servers.

In another example, a first financial institution may be different from a second financial institution by being of a different corporate ownership (e.g. one financial institution may be a first corporation and another (e.g., different) financial institution may be a second corporation).

In another example, a first financial institution may be different from a second financial institution by being of a different type (e.g. one financial institution may be of a bank type and

Another (e.g., different) financial institution may be of an insurance company type). In another example, a financial derivative instrument may comprise debt.

In another embodiment a method performed in a computing system may be provided. In one example, the computing system used in the method may include one or more programmed computers.

In another example, the computing system used in the method may be distributed over a plurality of programmed computers.

In another embodiment one or more programmed computers may be provided. In one example, a programmed computer may include one or more processors.

In another example, a programmed computer may be distributed over several physical locations.

In another embodiment a computer readable medium encoded with computer readable program code may be provided.

In one example, the program code may be distributed across one or more programmed computers.

In another example, the program code may be distributed across one or more processors. In another example, the program code may be distributed over several physical locations. In another example, any communication (e.g., between a computer and an input device, between or among computers, between a computer and an output device) may be uni-directional or bi-directional (as desired).

In another example, any communication (e.g., between a computer and an input device, between or among computers, between a computer and an output device) may be via the Internet and/or an intranet.

In another example, any communication (e.g., between a computer and an input device, between or among computers, between a computer and an output device) may be carried out via one or more wired and/or one or more wireless communication channels.

In another example, any desired number of computer(s) and/or database(s) may be utilized.

In another example, there may be a single computer (e.g., server computer) acting as a “central server”. In another example, there may be a plurality of computers (e.g., server computers), which may act together as a “central server”. In another example, one or more users (e.g., one or more employees of one or more financial institutions, one or more agents of one or more financial institutions, one or more third parties) may interface (e.g., send data and/or receive data) with one or more computers (e.g., one or more computers in operative communication with one or more databases containing relevant data) using one or more web browsers.

In another example, each web browser may be selected from the group including (but not limited to): INTERNET EXPLORER, FIREFOX, MOZILLA, CHROME, SAFARI, OPERA. In another example, any desired input device(s) for controlling computer(s) may be provided for example, each input device may be selected from the group including (but not limited to): a mouse, a trackball, a touch sensitive surface, a touch screen, a touch sensitive device, a keyboard).

In another example, various embodiments of the present invention may comprise a hybrid of a distributed system and central system.

In another example, various instructions comprising “rules” and/or algorithms may be provided (e.g., on one or more server computers).

In another example (related to liquid trust-financial MBS business domain), practical fine grained control of macro-prudential regulatory policy as “Perspectacles” may be provided this may relate, in one specific example, to operational business processes and policies. Further, various “discriminators” associated with various software systems capabilities may be provided in other examples as follows: Perspectacles™; Situation Awareness of Complex Business Ecosystems; Data Provenance; Continuous Policy Effectiveness Measurement; Continuous Risk Assessment; Continuous Audit; Policy Control Management; and/or IP Value Management.

In another example, a new generation of LiquidTrust MBS Synthetic Derivatives may be provided.

For the purposes of this disclosure, a computer readable medium is a medium that stores computer data/instructions in machine readable form. By way of example, and not limitation, a computer readable medium can comprise computer storage media as well as communication media, methods or signals. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer.

Further, the present invention may, of course, be implemented using any appropriate computer readable medium, computer hardware and/or computer software. In this regard, those of ordinary skill in the art are well versed in the type of computer hardware that may be used (e.g., one or more mainframes, one or more mini-computers, one or more personal computers (“PC”), one or more networks (e.g., an intranet and/or the Internet)), the type of computer programming techniques that may be used (e.g., object oriented programming), and the type of computer programming languages that may be used (e.g., C++, Basic). The aforementioned examples are, of course, illustrative and not restrictive.

Of course, any embodiment/example described herein (or any feature or features of any embodiment/example described herein) may be combined with any other embodiment/example described herein (or any feature or features of any such other embodiment/example described herein).

While a number of embodiments/examples of the present invention have been described, it is understood that these embodiments/examples are illustrative only, and not restrictive, and that many modifications may become apparent to those of ordinary skill in the art. For example, certain methods may be “computer implementable” or “computer implemented.” Also, to the extent that such methods are implemented using a computer, not every step must necessarily be implemented using a computer. Further, any steps described herein may be carried out in any desired order (and any steps may be added and/or deleted).

In another example, the present invention may provide for adequate transparency and management oversight of overly complex products. In another example, the present invention may provide a mechanism for institutional responsibility and management accountability.

In another example, the present invention may provide mechanisms for revaluing and unwinding large inventories of troubled securities and corresponding credit default swap contracts. In another example, the present invention may take into consideration the sensitivity of bank portfolio valuation and pricing assumptions. In another example, the present invention may provide a common valuation approach without exposing the entire financial system to new vulnerabilities.

In another example, the present invention may provide a mechanism for effectively assessing risks associated with certain derivative information products packaged as structured investment vehicles, and independently verifying the quality of the data underpinning those instruments.

In another example, the present invention may provide a consultative model of a policy compliance risk assessment technology, referred herein as GRACE-CRAFT. In another example, GRACE may stand for Global Risk Assessment Center of Excellence. In another example, CRAFT may stand for five key attributes of the enabling risk assessment technology: Consultative, Responsibility, Accountability, Fairness, and Transparency.

In another example, the GRACE-CRAFT model of the present invention is a consultative model of a flexible mechanism for continuously and independently measuring the effectiveness of risk assessments of compliance with polices governing, among other things, data quality from provider and user perspectives, business process integrity, derivative information product quality, aggregation, distribution, and all other aspects of data use, fusion, distribution and conversion in information, material, and financial supply and value chains. In another example, the CRAFT mechanism is designed to provide a consistent, repeatable, and independently verifiable means of quantifiably assessing the degree of compliance with policies governing simple and complex relationships between specific policies and the processes, events and transactions, objects, persons, and states of affairs they govern.

In another example, the inventive model provides for processes, events, objects, persons, and states of affairs to be organized by individuals and organizations into systems to do things. In another example, the inventive model assumes that what those things are, and how they are accomplished is a function of the policies individuals and organizations define and implement to govern them.

In another example, GRACE CRAFT applications consist of collections of related polices called ontologies, and business processes that manage the relationships between these policies and the objects (including data and information products), events (including transactions), processes (including business processes as well as mechanical, electronic and other types of processes), persons (individual and corporate), and states of affairs that the policies govern. In another example, the inventive GRACE CRAFT model provides a consistent, and independently verifiable, e.g., transparent, means of assessing the relative effectiveness of alternative polices intended to produce or influence specific behaviors.

In another example, GRACE-CRAFT applications can support a high degree of complexity. In another example, the inventive model enables the quality and provenance of all data and derivative products, and the integrity of every process called by applications, to be continuously and independently verified. In another example, the inventive model provides a mechanism, and the transparency inherent in it, that effects change—anticipated or not—on assumptions underpinning policies, and on the data, processes, persons, and the relationships governed by those policies, which are clearly visible and retained for future analysis.

In another example, the model of the GRACE-CRAFT mechanism is intended to provide users with a clear view into complex relationships between the objects, events, processes, persons and states of affairs that might comprise a systems application. In another example, the inventive model allows for discovering how different assumptions related to asset pricing might change over time, for example. In another example, the inventive model allows for examining how various assumptions might be represented in policies that govern data quality and other system requirements.

In another example, the inventive model provides for 1 modeling existing derivative information products to discover and examine various assumptions, data quality metrics, and other attributes of the products that might not be readily apparent to buyers—or sellers. In another example, the inventive model supports retrospective discovery and analysis of derivative product pricing and valuation assumptions, and evaluating alternatives intended to reflect current conditions and policy priorities. In another example, the GRACE-CRAFT model and its underlying systems technology are equally applied to examine assumptions underpinning other data and process dependent business and scientific conclusions.

In another example, the inventive GRACE-CRAFT model provides a consistent modeling and experimentation mechanism for assuring continuous and independently verifiable compliance with policies governing high value data and information exchanges between government, industry and academic stakeholders engaged in complex global supply chain and critical infrastructure operations. In another example, the inventive model accounts for long term strategic frameworks spanning virtually all domains of knowledge discovery and exploration as well as international legal and policy jurisdictions and environments. In another example, the inventive model may be capable of dealing with dynamic change; and they must support continuous independent verification of multiple confidence building measures and transparency mechanisms underpinning trusted exchange of sensitive high value data and derivative information.

In another example, the inventive GRACE-CRAFT modeling approach recognizes that multiple, and often conflicting and competing policies will be used by different stakeholders to measure data quality, assess related risks, and govern derivative product production and distribution. In another example, the inventive model recognizes and anticipates that these policies will change over time as the environment they exist in changes and stakeholder priorities change.

From our perspective, this type of dynamic and ongoing change is normal, to be expected, and better planned for than ignored.

In another example, the inventive model provides for ability to consistently measure and independently verify the effectiveness of various polices, regardless of what institution makes them, so that their relative merits and defects can be as confidently and transparently evaluated as the information products and processes they seek to govern. In another example, the inventive model is capable of detecting and measuring the impact of whatever intended and unintended policy consequences result.

### An Example of the GRACE-CRAFT Model

The GRACE-CRAFT model of this example is a consultative model. As such its function is to guide, not to dictate; to illuminate assumptions, assertions, and consequences. The exemplary GRACE-CRAFT model is intended to support efficient simulation and assessment of the effectiveness of polices governing, among other things, data quality and processes used to create, use, and distribute data and derivative products to do work. The exemplary GRACE-CRAFT model can be used to track data provenance through generations of derivative works. Data provenance tracing and assurance is a key concept and functional capability of this model and the application mechanism it supports. Not being able to assess and verify the data provenance of derivative structured investment products is the fatal flaw of collateralized debt and credit swap instruments created prior to 2008. We maintain that data provenance assurance is critical to identifying and understanding how derivative product quality, value, and pricing will change over time.

Finally, we describe how the model supports continuous policy compliance. This objective function provides measureable feedback to agents and enables them to make adjustments to the policies and processes affecting their objectives. These objectives endure continuous state changes as the environment in which they exist morphs to reflect evolving relationships between the changing objects, persons, events, processes, and states of affairs that exist in it and that it consists of. The exemplary GRACE-CRAFT model by performing continuous policy compliance assurance provides independent feedback to agents to support adjusting to changing conditions as their environment and priorities evolve, and that this is a critical requirement because change is, indeed, the one certainty agents can count on. In accordance with the exemplary GRACE-CRAFT model agents can now count on two others: 1) that they can continuously and independently model the effects of change on their world view (Weltanschauung), the epistemological framework which supports their assumptions, policies and view of their world and their place in it, and 2) that they can continuously improve the results of their models by continuously and independently assessing and verifying the quality of the data they use to support their world view model(s).

The exemplary GRACE-CRAFT model and the comprehensive policy compliance risk assessment mechanism it supports can accelerate establishing trust in business relationships by providing a consistent mechanism for continuously and independently verifying the basis for that trust. The exemplary GRACE-CRAFT model provides for verifying and validating the basis of trust as defined by a given market, thus allowing its users to define and enforce a consistent ethic to sustain the market and its participants.

As an example, one can use supply chain and Bill of Materials analogies. In doing so, the exemplary GRACE-CRAFT model draws on ongoing work on two programs that share an underlying problem structure. One program focuses on continuous optimization and risk assessment for global intermodal containerized freight flow and supply chain logistics (The Intermodal Containerized Freight Security Program, ICFS). The ICFS program is funded by industry participants and the US Department of Transportation. The ICFS program is managed by the University of Oklahoma, College of Engineering. It is a multidisciplinary research and development program with researchers in public and corporate policy, business process, accounting and economics, computer science, sensor and sensor network design, ethics and anthropology. Participating colleges and universities include the college of Business and Economics and the Lane Dept. of Computer Science at West Virginia University, and the Wharton Center for Risk Management and Decision Processes at the University of Pennsylvania. Lockheed Martin Maritime and Marine Systems Company, VIACK Corporation, and the Thompson Advisory Group are among the industry sponsors.

The other program is the GRACE-National Geospatial-Intelligence Agency Climate Data Exchange Program. This program is a global climate data collection, exchange, and information production and quality assurance program funded by industry participants and the National Geospatial Intelligence Agency (NGA). The GRACE—NGA Climate Data Exchange Program is managed by the GRACE research foundation. Participating colleges, universities and research centers include those mentioned above as well as the Center for Transportation and Logistics at MIT, the Georgia Tech Research Institute, the University of New Hampshire Institute for the Study of Earth Ocean Space, Lockheed Martin Space Systems Company, Four Rivers Associates and others.

The GRACE-NGA Climate Data Exchange program tests policy-centric approaches to enhancing the capacity, operational effectiveness and economic efficiency of industry, government, and academic data collection and distribution missions and programs. In the exemplary GRACE-CRAFT model, a central activity of the program is the design, construction, testing and validation of robust ontologies of policies governing virtually all stakeholder-relevant aspects of data collection infrastructure and supply chain quality. This includes cradle to grave data provenance and quality assurance, proprietary data and derivative product production, protection and management, data and derivative product valuation and exchange process validation and quality assurance, and other requirements of supporting enterprise and collaborative data collection and analysis operations. As such, participation in this program might provide useful and timely policy representation and ontology implementation experience to financial industry and regulatory stakeholders.

### An Example of Applying the Inventive GRACE-CRAFT Model to Subprime Mortgage Derivatives

In another example, the inventive model supports independent data quality, provenance, and process transparency validation.

In another example, the inventive model allows sell-side producers and buy-side managers to readily and independently validate the quality of the data and processes used to create derivative information products being traded after they were originally packaged. In another example, the inventive model provides for supply chain transparency. In another example, the inventive GRACE CRAFT model includes a utility function that operates as a provenance recording and query function and tracks the provenance of any type of data from cradle to grave. In another example, the inventive model includes, the essential elements of data provenance consist of who, when, where, how, and why. The essential unifying element of what is defined by the policy ontology that governs the relationship between these six essential elements of provenance.

Of particular importance to market agents, the GRACE-CRAFT provenance recording function captures and stores changes in state of all attributes and sets of attributes of events which enables changes in data quality, for instance, to be identified when it occurs. This kind of transparency enables agents to more effectively assess risk and more efficiently manage uncertainty. Some might think of the GRACE-CRAFT provenance recording/query utility as analogous to a compass, and the corresponding policy ontology as a map. These are useful tools to have when one is uncertain of where one might be in a wilderness.

In another example, the inventive model provides for provenance of a structured investment product, assessing its quality. If one is relying on a “trusted” third party (who) to attest to the quality associated with a product one buys, and large sums are at stake, one should explicitly understand the basis of that trust (how and why) and be able to continuously verify the third party's ability to support it (who, when, how, why, where, and what). These are relatively simple elements and policies to understand and capture in an ontology governing a relationship between a buyer and a seller. One might think of that ontology as a type of independently and continuously verifiable business assurance policy.

In another example, the inventive model is able to continuously measure and independently verify the quality of component data and processes used to create complex structured derivative products provides rational support for markets and market agents; even as original assumptions and conditions change—which is both natural and inevitable. Not being able to do this will inevitably create Knightian risk and market failures, described in Caballero, J. Ricardo and Arvind Krishnamurthy, Collective Risk Management in a Flight to Quality, Journal of Finance, August, 2007, incorporated herein in its entirety. Market agents are typically out to serve their own interests first. They and other market stakeholders benefit when the quality of a market agent's data and the integrity of the processes used to convert that data to market valuation information, can be continuously and independently measured and validated.

In another example, the inventive GRACE-CRAFT model supports retrospective data quality analysis to support rational value and pricing negotiations between buyers and sellers in markets that have been disrupted or distorted by inadequate transparency and mandated mark-to-market asset valuation accounting rules. In another example, the inventive GRACE-CRAFT model e defines ontologies that reflect buyer and seller best current understandings of the data and process attributes associated with products they are willing to trade if a suitable price can be discovered.

In another example, the inventive GRACE-CRAFT-NGA Climate Data program provides a suitable venue for financial industry stakeholders to learn how to do it quickly and efficiently. In another example, the inventive GRACE-CRAFT model supports the integration of stakeholder defined ethics that can be transparently applied, independently assured, and consistently enforced.

Effective risk management decisioning is strongly correlated to the quality of information products. These decisions impact the cost of capital, agent cash flows and liquidity choices, and other financial market efficiencies. In another example, the inventive GRACE-CRAFT model is able to identify or track changes in state affecting the quality of data used to assess risk. In another example, the inventive GRACE-CRAFT model is able to identify and track how a change of state to one element of data affects the other elements and the relationships between elements. In another example, the inventive GRACE-CRAFT model helps to avoid Knightian risk perceptions, flight to quality, and diminished liquidity in financial markets. These problems can create solvency and other serious challenges in the real economies that depend on these markets. Knightian risk, coupled with mark-to-market valuation mandates, is a witch's brew that rapidly creates derivative fear and uncertainty across interconnected sectors of the financial community and real economy. When coupled with mark-to-market pricing mandates, the reduced liquidity attendant to Knightian risk can evolve quickly into cascading solvency issues. Peloton and Bear Sterns are examples. In another example, the inventive GRACE-CRAFT model 1 provides a rational, consistent, continuous, and independently verifiable mechanism for managing Knightian risk and overcoming the deficiencies of mark-to-market pricing in Knightian market conditions.

In another example, the inventive GRACE-CRAFT model supports a setting in which sell-side firms report their risk assessment metrics, analysis, and other valuation reasoning to the market. In another example, the inventive GRACE-CRAFT model provides for reporting that can be direct or via trusted agencies to safeguard competitive and other proprietary interests. In another example, the inventive GRACE-CRAFT model allows buy-side managers in this setting to independently assess and validate reported reasoning and, if they wish, counter with their own. In such a setting, when a trade is completed the established market value reflects both firms' reports back to the market. The quality of the reports, which includes independent assessment and verification, affects investment risk management decisioning. This, in turn, affects expected cash flows, cost of capital, and liquidity opportunities. This setting supports the notions that reporting to capital markets play a crucial role in allocating capital and that the quality of information affects an agent's future net cash flows and capital liquidity opportunities.

In another example, the inventive GRACE-CRAFT model has two prime utility functions called Data Process Policy and Data Provenance respectively. These two objective functions drive what we call “Data Process Policy Driven Events” that enable agents to define specific attributes of quality, provenance, etc. that the agent asserts the data to possess. The CCA-CRAFT Software Service Suite 7 will audit for these attributes of the original data and track them as they are inherited by derivative products produced with that data. As the quality of the data changes over time, represented by measurable state changes in the attributes, so will the quality of the derivative.

In another example, the inventive GRACE-CRAFT model has a third function, a metric function, that is called the GRACE-CRAFT Objective function. This function conducts continuous measurement of data quality and provides agents with independent verification of the effectiveness of risk assessments of compliance with polices governing events, processes, objects, persons, and states of affairs in capital liquidity markets. In another example, the inventive GRACE-CRAFT reduces the uncertainty of data and derivative product quality by providing a consistent mechanism for continuously assessing that risk and independently verifying the effectiveness of those assessments.

In another example, the GRACE-CRAFT consultative model can accelerate establishing trust in business relationships by providing a consistent mechanism for continuously and independently verifying the basis for that trust. To the degree that one can accelerate establishing trusted relationships, one can accelerate the flow of ideas, capital and other resources to exploit those ideas, create new knowledge, and broaden the market for ideas, products and services that the market values. To the degree one can continuously verify and validate the basis of trust as defined by a given market, one can define and enforce a consistent ethic to sustain the market and its participants.

In another example, the inventive GRACE-CRAFT model uses the context of a financial liquidity market where agents produce and consume information in order to conduct risk assessments and make risk management decisions and investments. Within this context, the model uses a semantic ontology as the framework to build our model. The ontology describes a vocabulary for interactions of events, processes, objects, persons, and states of affairs. The exchange of information is represented as linked relationships between entities (producers and consumers of information) and described using knowledge terms called attributes which are dependent on state^{s}. These attributes define the semantic meaning and relationship interconnections between surrounding entity neighbors. The model ontology may also include policies that are used to enforce rules and obligations governing the behavior of interactions (events) between entities belonging to the model ontology. Events are described as the production and exchange of information, i.e., financial information (data and knowledge). In the context of a financial liquidity market, the model may assume that agents exchange information to support effective risk assessments and improve the efficiency of risk management decisions and investments.

### Another Example of the Consultative Model: a Semantic Ontology Approach

Some definitions:

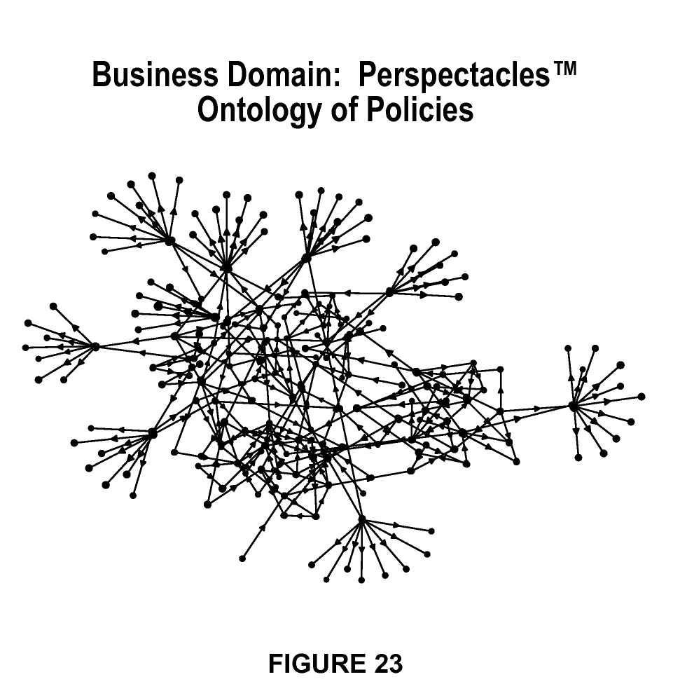

The ontology defined by Φ is the domain ontology representation for any particular business domain and can be described semantically in terms of classes, attributes, relations, instances. In another example, the inventive GRACE-CRAFT model uses the Semantic definition of ontology as described by Hendler, J., Agents and the Semantic Web, IEEE Intelligent Systems Journal, April 2001, incorporated herein in its entirety. The ontology may include t is a set of knowledge terms, including the vocabulary, the semantic interconnections and some simple rules of inference and logic, for some particular topic. A graphical domain ontology is represented, for example, in FIG. 23.

An entity (ν) is defined as ν∈φ and is uniquely distinguishable from other entities in φ. Entities can be thought of as nouns or objects in a domain of interest. Entities are semantically defined by an attribute set A=[a₁ . . . aₙ] and are the properties or predicates of an object and can change over time due to state changes in v. The existence or delineation of attributes can also be driven by the outcomes of predictable and unpredictable events in time that operate on all entities.

An agent (w) is an entity where (ω⊂ν) that has a need to make effective risk management decisioning based upon measurably effective risk assessments. An agent can be characterized as a producer, consumer or prosumer of derivative informational products for purposes of conducting measurably effective risk management for purposes of effective risk management decisioning. It is assumed that any given agent seeks information of measurable high quality but the market does not provide such efficiencies in most cases.

An event (ε), [ε]=f(ω), in the context of the model is an action that is data process policy driven. Events act on the states of other events, processes, objects, persons and states of affairs. We require, for purposes of this model, that events are trackable. We discuss mechanisms that meet this requirement later in this document. Events are based on the information lifecycle of data and with a lifecycle of events: creation, storage, review, approval, verification, access, archiving, and deletion. Events are collectively described as:

Where—location where an event happens

When—the time when an event occurs

Who—the people or organizations involved in data creation and transformation

How—documents actions upon the data. These actions are labeled as data processes. It describes the details of how data has been created or transformed.

Which—describes the instruments or software applications used in creating or processing the data.

Why—decision making rational of actions.

A State (s), s=f(α, β, ε) where functions a, β act on the attributes of a set of entities and their corresponding relational attributes to other entities respectively. These special functions are described in more detail later. Attributes are used to describe data and therefore are themselves data. A change in state reflects a change in the data that describes data acted upon by certain events. A single event can change unique set of attributes therefore changing the semantic meaning of any set of: Events, processes, objects, persons and states of affairs as defined in an ontology. This change is described as a state.

To simplify our model we use a directed acyclic graph representation of a subset of members of a semantically described ontology where the subset is defined by G⊂Φ where Φ is the domain ontology representation for any particular business domain or community of interest and can be described semantically as classes, attributes, relations, instances.

Events in Φ are defined as data process policy driven and can be synchronous and/or asynchronous. In Φ it is assumed that all business domain agents produce and consume data both synchronously and asynchronously for reasons of utility. We examine the subset G to simplify a mapping of events over a known time frame in order to simplify the model. Policies are used to govern behavior of data processes or other events on data. A policy set is evaluated based upon current state of the entities although during decisioning the state of the attributes of data can change and are captured in the model. We assume the physical nature of data can change in time and metadata used to track data provenance can change in state over time, but state changes in both can be mutually independent and are driven by recordable events.

The logical knowledge terms, the attributes, and the semantic interconnections of relations for a subset G in Φ can be used to describe a semantic topology of event paths driven by data process policy events and will be represented here as G where: To develop the model we create conditions that assist in simplifying our model's construct as we build in real world behaviors into the sub-ontology G.

First we define Condition (1.) for our model development as,

$$\frac{\partial G}{\partial ɛ} = 0 ⇒ s = f ( α , β ) \qquad Condition ( 1. )$$

Condition (1.) defines the rate of change of state for the sub-ontology G with respect to change in event as equivalent to zero. This implies that the state in G is a function of the entropy functions a and /1 respectively. Therefore our model is not influenced by any known events based upon the condition declaration. Then we can say our directed acyclic graph representation is operated on by the function,

G:−(V,E)→G[α,β3] for any given state S. (eqn. 1.)

That is to say the sub-ontology G is replaceable by the expression (V, E) and is mapped by the sub-ontology function G. In our modeling approach, we use a Directed Acyclic Graph that is a data structure of an ontology that is used to represent “state” graphically, and mapped or operated by an abstract function in our case represented as G, a function. The function's state changes are read as the rate of change in G with respect to events in [ε]. Therefore (eqn. 1.) is the graphical ontology representation with data properties identified in (V, E) driven by changes (remapping) in function G which is influenced by the dependent functions [a, β] respectively in Condition (1.).

Where:

V=Vertices (nodes) in G. V are the entities described semantically in Φ.

E=Edges between neighboring V. E⊂V×V where E is the set of all attributes that describe the relationship between vertex ν₁ to neighboring vertices in Φ.

To capture state changes of attributes that semantically describe any entity in Φ, two functions are identified by α and β respectively:

α=Function α: V→A_{α} operates on current state of semantic attributes describing V.

β=Function β:→A_{β}, operates on current state of semantic attributes describing E.

Where:

A_{α}=Set of all attributes that semantically describe uniquely all entities in G and are operated on by α or known events ε. Thus

A_{α}=[a₁, . . . ,aₙ]

A_{β}=Set of all attributes that semantically describe uniquely the relational interpretations between all entities, (i.e., the relational attributes and values of an entity to its neighboring entities), in G and are operated on by β or known events [symbol] . Thus

A_{β}=[a₁, . . . ,aₘ].

Therefore in any domain ontology, Φ, which semantically represents real world communities of interest that by nature are in a continuous change in state or entropy, (we use the definition of entropy, as in context of data and information theory, where measure of loss of information in the lifecycle of information creation, fusion and transmission, etc.), that classifies our system as having spontaneous changes in state. Our model represents functions that drive changes in state as the a and β functions.

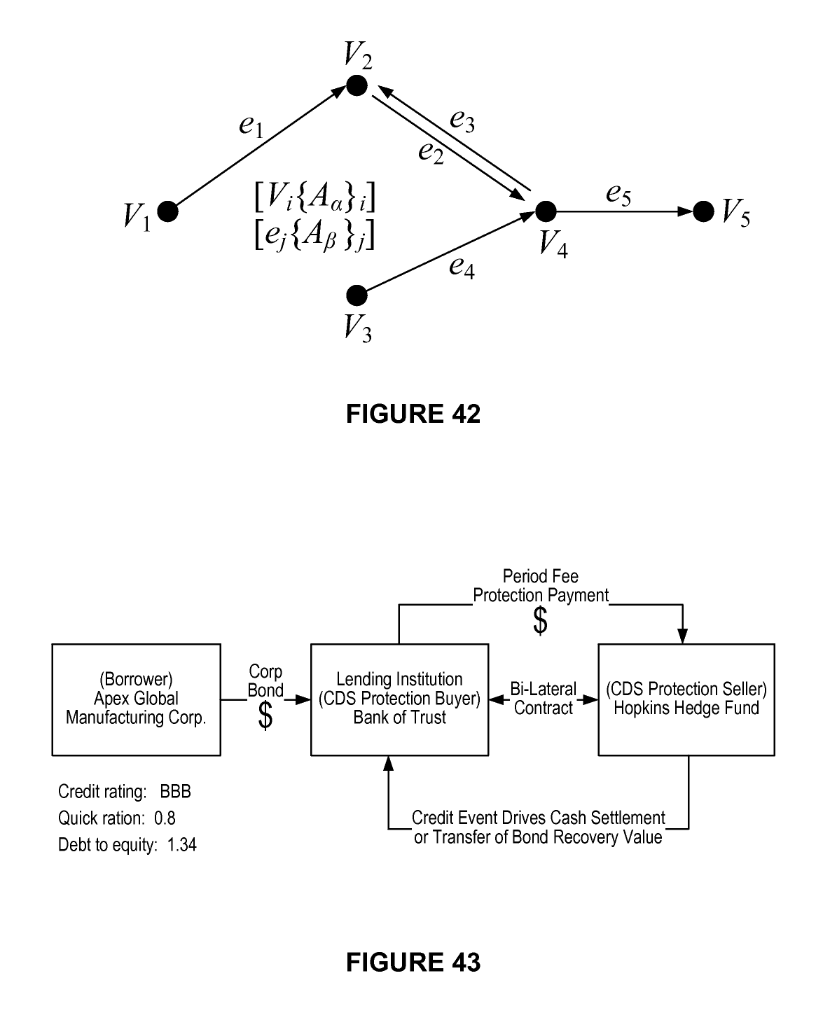

These functionally represent those natural predictable and unpredictable changes made by entities and their environment, (classified as events, processes, objects, persons and states of affairs), to the attributes that describe “meaning” to entities and to the strength of interpretive relations to neighboring entities. In this example, the inventive model 4600 operates under assumption that a state change in the attributes that describe data does not necessarily mean that the data itself has changed, but it can. As can be seen in FIG. 42, the model represented in (eqn. 1.) is shown as a directed acyclic diagram. This is an effective means of describing an entity as a member of a subset G shown as a spatial distribution of vertices ν₂, 4202, ν₂, 4204, ν₃, 4206, ν₄, 4208, and ν₅, 4210, and directional edges e₁, 4220, e₂, 4230, e₃, 4240, e₄, 4230, and e₅, 4260, representing interpretive relationships described as relational attributes to and from all vertices. An entity can exist in the ontology and have no relations with other entities, but this is not represented since it is not of interest in our business context. The arrows defined as edges represent an interpretive relation between vertices. Using arrows rather than lines implies they have direction. Therefore an arrow in one direction represents a relation defined by vertex (1) to vertex (2). It is important to understand that the graph does not represent “flow” but only representation either of a vertex or a relationship to others vertices as its membership in the ontology. Our representation is “acyclic” because the relations defined do not cycle back to vertex (1) from all other vertices. However they could be pointing back depending on the complexity of the business domain you are describing.

FIG. 42, Directed acyclic graph 4200 representation of G plotted in b mapped as attributes describing each vertex, contained in V and edge, contained in E semantic meaning The graph shows the strength and direction of relations between neighboring vertices at a current known state s.

Another example of the invention: Continuous Compliance Assessment Utility function.

In another example, the invention provides a means of tracking and controlling a trackable single event on G. For this example, such mechanism is defined as Continuous Compliance Assessment, a utility function.

In this example, a Condition (2.) for the continuation of our model development is defined as,

$$\frac{\partial G}{\partial ɛ} = c ⇒ s = f ( α , β , ɛ ) , \qquad Condition ( 2. )$$

where c is some arbitrary constant and [ε]=[ε₁], is a single event and occurs repeatedly over time T and is governed by a data process policy compliance mechanism. The Continuous Compliance Assessment Utility function is used to map onto the directed acyclic graph topology as:

G:=(V,E)→G[α,β,Γ(ε)] (eqn. 2.)

This function governs known events as in the definition of [symbol] as [symbol] operates in G over some time T.

The assumption is that agents desire to produce, consume or transact information with governance according to policy. We propose a mechanism that provides data process policy compliance and transparency into the state changes that describe the meaning of data.

The new term in (eqn. 2) as compared to (eqn. 1.) acts as a policy compliance function and tracking mechanism driven by policies that operate on events and govern their outcomes, i.e., changes to state, affected by [symbol] , as represented by the changes of attributes in G. The function is triggered by some occurrence of [symbol] . The function operates on G and can affect the outcome of future events and simultaneously record the effects of events, processes, objects, persons, and states of affairs like data and information.

We further define this Continuous Compliance Assessment Utility function and expand (eqn. 2.) as,

Γ[P(A_{α},A_{β},Π,Z_{π}),D(R_{A},Q_{A})] (eqn. 3.)

The functional elements of eqn. 1 are described as utility sub-functions and are defined respectively as:

### Data Process Policy Function

P(A_{α},A_{β},Π,Z_{π}) (eqn. 4.)

Π=Policy rule sets that contain rules or assertions

π=is a policy rule element where: π₁+, . . . , +πₙ₋₁∈Π

π is a single logical Boolean assertion that tests conditions by evaluating attributes, past outcomes of events and rules used to determining whether an event can conditionally occur or not, where outcomes of

ε→Π.

Z_{π} is the set of all obligations that operates in G. Obligations: Set Z_{π} is a collection of event like processes that are driven by policy rules in Π.

For example, an obligation can be characterized as an alert sent to the data owner about another data process policy driven event that is about to execute using “their” data with the objective of creating a new derivative informational product. The owner may have an interest in capturing and validating a royalty fee for the use of their intellectual property driven by policy, or the owner may be concerned with the quality inference based on the fusion of data that will exist relative to their data after the event.

Data Provenance Function

D(R_{A},Q_{A}) (eqn. 5.)

This utility function operates as a recording and querying function and tracks the provenance of any type of data where:

R_{A}=Data provenance recording function captures and stores state changes for all sets f attributes [|A_{α}, A_{β}] for an event ε, i.e., Δ₁₂, Δ_{23, . . . ,} Δ_{l-1,l} where Δ_{i,j}, is the difference from version i to version j.

Q_{A}=Data provenance querying function queries state changes for all sets of attributes [A_{α}, A_{β}] for an event ε, i.e., Δ₁₂, Δ_{23, . . . ,} Δ_{l-1,l} where Δ_{i,j}, is the difference from version i to version j. For example version A_{α,1} together with sequence of deltas Δ₁₂, Δ_{23, . . . ,} Δ_{l-1,l} is sufficient to reconstruct version i and versions 1 through i−1.

Data provenance is the historical recording and querying of information lifecycle data with a life cycle of events. We conceptualize data provenance as consisting of five interconnected elements including when, where, who, how and why. The disclosure of concepts of data provenance in Ram, Sudha and Lui, June, 2007, Understanding the Semantics of Provenance to Support Active Conceptual Modeling. Eller School of Management, University of Arizona, is incorporated by reference herein in its entirety.

In another example, the inventive ontology model provides the description of what events in the Data Process Policy evaluation, simply tracking and recording the what events that occurred is not sufficient to provide meaningful reconstruction of history. Without what is described in the ontology, the other five elements are irrelevant. Therefore the five elements listed meet the requirements of data provenance in our model.

Capturing data provenance in our model facilitates knowledge acquisition by active observation and learning. With this capability agents can reason about the dynamic aspects of their world, for example a capital liquidities market. This knowledge and the functional means to act on it facilitate prediction and prevention as we will see later in further model development. The Data Provenance function uniquely provides several utilities to agents seeking to continuously measure and audit data quality, conduct continuous risk assessments on data process policy driven events, and create or modify derivative informational products. These utilities are as described as:

Data quality: data provenance provides data lineage based on the sources of data and transformations.

Audit trail: Trace resource usage and detect errors in data generation.

Replication recipes: Detailed provenance information can allow repeatability of data derivation.

Attribution: Pedigree can establish intellectual property rights or IP that enables copyright and ownership of data and citation and can expose liability in case of erroneous data

Informational: Data discovery and can provide ability to browse data to provide a context to interpret data.

The full disclosure of utilities of data provenance function in Sinunlian, L. Yogesh, Hale Beth and Gannon Dennis, A Survey of Data Provenance in e-Science, SIGMOD Record, Vol. 34, No. 3, September 2005 is incorporated by reference herein.

In another example, the inventive model may reflect real would behavior by having, in Condition (3.), the rate of change of state for the sub-ontology G with respect to change in event to be equivalent to the entropy functions and the rate of change of the Continuous Compliance Assessment Utility function with respect to change in event ε. This implies that the state of G is a function of the entropy functions α and β respectively and the trackable known events driven by agents defined in the ontology. It is assumed that not all agents are aware of when the occurrence of a particular event driven by some arbitrary agent is to take place in the ontology. Therefore our model is influenced by all events and is represented in condition declaration as.

$$\frac{\partial G}{\partial ɛ} = G [ α , β , \frac{\partial }{\partial ɛ} Γ [ P ( {A}_{α} , {A}_{β} , Π , {Z}_{π} ) , D ( {R}_{A} , {Q}_{A} ) ] ⇒ \\ s = f ( α , β , [ ɛ ] ) \qquad Condition ( 3. )$$

where [ε]=[ε₁, . . . , εₙ] is a series of unique events respectively occurring over time period [T] and are governed by a data process policy compliance mechanism. This mechanism again is the Continuous Compliance Assessment Utility function.

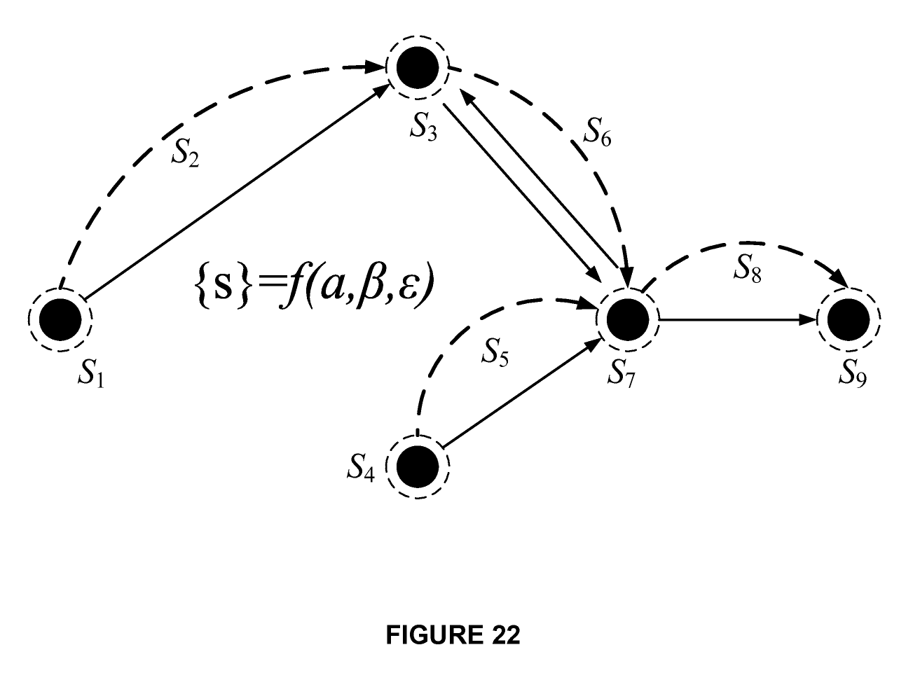

In another example, the inventive model predicts that events occurring in a market as modeled are defined as series of synchronous and asynchronous events occurring for some time period [T]. In another example, the inventive model assumes that a path in G can be layered on top of the ontological topology governed by the Data Process Policy Function F. For any event to proceed there was policy decisioning that governs the event, i.e., a process on a data transaction between two entities. The path is represented by the dotted state representations across G as shown in FIG. 22. The “overlay” of state changes (represented as dotted arcs and circles) onto G show that one could track “flow” through the map if one tracks the state changes (data provenance) for every event that operates on the ontology over time [T].

In FIG. 22, there is shown, by way of example, a process 2200, indicating how a model according to aspects of the disclosed and claimed subject matter can provide for state change tracking States are plotted over G based upon events ε that change states S₁ . . . Sₙ 2202, 2204, 2206, 2208 and 2210. Events 2220, 2230, 2232, 2240, and 2242 are governed by data process policies. The dashed 2260, 2264, 2266, 2268 and 2270 circles and arcs 2250, 2252, 2256 and 2258 represent policy driven event state changes of the attributes belonging to the vertices 2202, 2204, 2206, 2208 and 2210 and edges 2220, 2230, 2232, 2240 and 2242, i.e., (V, E) in G.

In another example, the inventive model assumes relative to Condition (3.) that data process policies can be introduced at any time into the model and that those agents of policy rarely update their policies due to reasons of economic costs, transparency, cultural conflicts or even fear of exposure associated with not having the capability to provide policy measurement and feedback. The interesting dilemma that impacts this condition is that, over time, the system (in our case a market) changes state independent of the influence of known or planned events due to its existence in nature which represents continuous change. These changes are driven by outside events that are generally unknown and unpredictable. Further, the independent relationships between the system's vertices and nature can introduce changes that can be amplified by interdependent relationships between vertices within, the system. What this implies is that the effectiveness and efficiency of agent polices will erode over time. What is needed is the ability to detect change and measure the impact it has on policy effectiveness so that adjustments can be considered, modeled, and evaluated to keep the system on course to the desired objective.

### Feedback and Learning

In another example, the inventive model provides a mechanism for measurement and feedback of policy and attribute. We assume all agents will frequently make adjustments to policies that govern certain event outcomes with the introduction of this mechanism. It is assumed that idiosyncratic risk exists in the market such that any one agent's information does not correlate across all agents in the market. By modeling entropy functions α, β into our ontology model in Condition (1.), we create unpredictable, and in some cases, probabilistic noise that influences event outcomes of “known” policy driven events. These effects may cause small perturbations to domain attribute ontology representations. Furthermore, large scale Knightian uncertainty (i.e., immeasurable risk) type events could be introduced into our model through α, β. One could test events of this nature by creating significant imbalances to a capital markets liquidity ontology model, an unknown event. The outcome is predicted to reflect market-wide capital immobility, agent's disengagement from risk, and liquidity hoarding. One can test and observe the quality of this prediction by auditing the evolution of agent's policies as Knightian conditions evolve. The full disclosure of Caballero, J. Ricardo and Arvind Krishnamurthy, Collective Risk Management in a Flight to Quality, journal of Finance, August, 2007, in incorporated by reference herein.

In another example, the inventive GRACE-CRAFT consultative model may enable both human and corporate resources to discover these effects and provide agents the ability to predict and manage Knightian risk, thus converting it from extraordinary to ordinary risk. In another example, let's look: Assume agents want to continuously measure outcomes of events and provide feedback as policy and attribute changes in (eqn. 1) by using some new function K evaluated at (ε−1), since we can't measure an event ε outcome before it occurs. We add K function to our model as seen in (eqn. 6). We assume K has sub-functions α, β, Γ.

$$G := ( V , E ) \to G [ α , β , \frac{\partial }{\partial ɛ} Γ [ P ( {A}_{α} , {A}_{β} , Π , {Z}_{π} ) , D ( {R}_{A} , {Q}_{A} ) ] ] \pm K ( α , β , \frac{\partial }{\partial ɛ} Γ ) \qquad ( eqn . 6. )$$

Expanding the right side of the equation (eqn. 6.) for K, where Rₚ=0 in Γ for the measurement and feedback utility functions and integrating over all events F, in time yields,

$${\int }_{ɛ} [ G [ α , β , \frac{\partial }{\partial ɛ} Γ [ P ( {A}_{α} , {A}_{β} , Π , {Z}_{π} ) , D ( {R}_{A} , {Q}_{A} ) ] ] ] \partial ɛ \pm {\int }_{ɛ - 1} [ K [ α , β , \frac{\partial }{\partial ɛ} Γ [ P ( {A}_{α} , {A}_{β} , Π , {Z}_{π} ) , D ( {Q}_{A} ) ] ] ] \partial ɛ \qquad ( eqn . 7. )$$

In another example, the inventive model may take in to consideration the Continuous Compliance Assessment Objective Function

The Continuous Compliance Assessment Objective function, it is assumed to be continuous in G, provides measureable feedback to agents and enables them to make adjustments to policies and attributes to meet their respective objectives in the market. In another example, the Continuous Compliance Assessment Objective function provides feedback that enables agents steadily, though asymptotically, to converge on their objectives while simultaneously recognizing that these objectives, like real life, evolve as the agent's experiences, perceptions and relationships with other agents, data, and processes evolve. Agents will apply objective measurement functions that they deem most effective in their specific environment.

In another example, the objective function's purpose is to provide utility to all agents. Agents' policies will reflect their results and experience they gain from this function as attribute descriptions. Policy evolves as making risk management decisions are made that influence future outcomes based on past risk assessments. Agent adjustments to policies aggregate to impact and influence market behaviors going forward.

In another example, the inventive model provides a mechanism for testing the effectiveness of polices governing data and information quality and the derivative enterprises and economies that depend on that quality and transparency.

The Continuous Compliance Assessment Objective function can be expressed as:

$$K ( ɛ - 1 ) = Min Max [ {\int }_{k} [ K ( α , β , \frac{\partial }{\partial ɛ} Γ ) \partial k ] ] \qquad ( eqn . 8. )$$

Note: For every ε, we assume agents sample K(ε−1) or last known event in attempt to make adjustments or not to policies based upon their continuous risk management decisioning in K(ε−1). This therefore provides feedback into the G at the evaluation at ε.

Agents' min-max preferences provide descriptions of their decision policies. The objective function in eqn. 8 provides the utility to alter future outcomes of known events and adapt to changing market states. Overtime agents learn to penalize or promote behaviors that detract or contribute to achieving specified objectives. This reduces uncertainty and risk aversion in volatile markets.

### In Another Example of Application of the GRACE-CRAFT Model

In this example, the GRACE-CRAFT model integrated over all events ε for some time set [T] is fully described as:

$${G}_{ɛ} := ( {V}_{ɛ} , {E}_{ɛ} ) \to {\int }_{ɛ} [ G [ α , β , \frac{\partial }{\partial ɛ} Γ [ P ( {A}_{α} , {A}_{β} , Π , {Z}_{π} ) , D ( {R}_{A} , {Q}_{A} ) ] ] ] \partial ɛ \pm {\int }_{ɛ - 1} [ Min Max [ {\int }_{k} [ K ( α , β , \frac{\partial }{\partial ɛ} Γ ) ] \partial k ] ] \partial ɛ \qquad ( eqn . 9 )$$

This function maximizes the utility of information based data quality measurement. As such it measurably increases risk assessment effectiveness which measurably increases the efficiency of risk management investment prioritization. As a result, the whole ontology (or, in the business context of this paper, “the market”) enjoys measurable gains in operational and capital efficiencies as a direct and predictable function of measurable data and information transparency and quality. It enables noncompliance liability exposure to be rationally and verifiably measured and managed by providing policy makers, executives, and managers with simple tools and a consistent and verifiable mechanism for measuring and managing non-conformance liability exposure. As a result, they are freed to focus on the quality of the objectives for which they are responsible and accountable.

### Another Example of Application of GRACE-CRAFT Model: Continuous Compliance Assessment Objective Function:

In this example, the model accommodates whatever type of objective function best suits an agent's policy requirements. In some cases this might be a Nash Equilibrium or other game theory derived objective functions. In many business and financial ontology contexts linearized or parametric Minimax and other statistical decision theory functions may be more appropriate.

### Another Example of Application of GRACE-CRAFT Model: a Data Quality Measure—an Approach

For example a data quality measure function would measure a particular metric of interest such as “quality” (actual model used trust as a metric). The full disclosure of the data quality measure function as disclosed in Gotheck, Parsia and Hendler, 2002, Trust Networks on the Semantic Web, University of Maryland. URL:www.mindswan.orgivapers/CIA03.pdf, is fully incorporated by reference herein. The product of the function evaluated continuously in G′ would be evaluated and used to make adjustments either by automated machine process or human adjustments using [a, β, Γ]. It is assumed that a set of values for quality have been predefined and standardized by the market, i.e., the set of all standard values that represent quality=[q₁, . . . , qₚ], where q∈e. Therefore, based on outcome at an instance in the continuum of events attributes, policies and obligations are adjusted and reintroduced into P(Aₐ, A_{β}, Π, Z_{π}) in an attempt to ensure maximum trust between known entities (vertices) represented by the recursion formula:

$${q}_{is} = {\sum }_{j = 0}^{n} \frac{\{ \begin{matrix}( {q}_{js} \cdot {q}_{ij} ) & if {q}_{ij} \geq {q}_{js} \\ ( {q}_{ij}^{2} ) & if {q}_{ij} < {q}_{js}\end{matrix} \}}{{\sum }_{j = 0}^{n} {q}_{ij}} \qquad ( eqn . 10. )$$

The assigned quality q, an attribute metric of interest that is tracked continuous in G′, is defined as the perceived quality from vertex i to vertex s and is calculated where i has n neighbors with paths to s. This algorithm ensures that the risk down the information value chain is more\less than the quality at any intermediate vertex.

### Another Example of Application of GRACE-CRAFT Model: Policy Effectiveness Measurement—an Approach

This algorithm and approach assists agents in determining statistically the effectiveness of their policies on enforcement and compliance while meeting certain objectives. Measures are consistently compared to last known policy outcomes. While a benchmark is assumed to be measured at the first introduction of a policy set, it is not a necessity and measure can begin at any time during the lifecycle of the agent belonging to the member business concept ontology. However, it is important to know where one has begun to influence behaviors with policy. As such this mechanism provides a consistent, repeatable, and independently verifiable means of quantifiably assessing the degree of compliance with policies governing simple and complex applications of policies to specific processes, events and transactions, objects, and persons.

### Define:

Π=Policy rule set

π=Policy rule
Assume: π₁+, . . . , +πₙ₋₁∈Π
∴{π(1)+, . . . , +π(n−1)}∪Θ [symbol] (π(n)∈Π)=Proof, Θ
   Thus to evaluate the rules (assertion) in Π and quantify value θ for Proof Θ we can use the following series expression:

$${\sum }_{i = 0}^{n} {π}_{i} * {r}_{i} = θ ,$$

where he value of rᵢ=risk weighting factor∈Φ Ontology set. Let r=(1− [symbol] ), where [symbol] is the data owners “perceived risk” of sharing as defined in Φ Ontology set. For example an owner may have 60% perceived risk to share with entity X.
Now assume the following Proof Θ types:

### Orthogonal Proof, Θ:

1.) {π₁+, . . . , +π_{n}}⊥Π [symbol] all assertions are independently formed

2.) All {π₁+, . . . , +πₙ} must be evaluated as logical true, value=1

### Relative Proof, Θ′:

1.) {π₁+, . . . , πₘ}⊥ in Π

2.) {π₁+, . . . , πₘ} not all true but {r₁+, . . . , rₘ}≦acceptable limits.

Let the Orthogonal Proof Θ be the benchmark from which we measure the policy compliance effectiveness for Relative Proofs Θ′. Θ ‘is samples over a discrete time t period from which policy set evaluations generate rulings ach measured as θ′ for user data access request in the RAFT model.

Therefore policy compliance effectiveness measure is the Standard Deviation in Θ′ or the degree to which θ′ of Relative Proof Θ′ has variance from the Orthogonal Proof Θ. The Standard deviation is:

$$\begin{matrix}{σ}_{Policy} = \sqrt{\frac{1}{N - 1} {\sum }_{i = 1}^{N} * {( {θ}^{′} - θ )}^{2}} \\ = \sqrt{\frac{1}{N - 1} {\sum }_{l = 1}^{N} {( {\sum }_{j = 1}^{m} ( {π}_{j}^{′} * {r}_{j}^{′} ) - {{\sum }_{i = 1}}^{k} ( {π}_{i} * {r}_{i} ) )}^{2}} ,\end{matrix}$$

for N samples and where r is the risk weight factor in ontology set Φ.
Therefore σ_{Policy} is the degree in variance from the Orthogonal Proof Θ. This variance is the direct measure of effectiveness in policy compliance in Θ′. The N Samplings of Θ′ are taken from the GRACE-CRAFT Immutable Audit Log over a known time period t.

### Another Example of Application of GRACE-CRAFT Model: Bringing Transparency to the Credit Default Swap Market

For practical application we will build certain concepts and components of a simple GRACE-CRAFT model using a Credit Default Swap mechanism as application context. The objective of this application is to provide consultative guidance on how one defines the business domain ontology, policies and attributes that govern an instance of the GRACE-CRAFT model.

Above, it is described the types of functions the GRACE-CRAFT model supports. These include the Event Forcing functions ε: The Entropy functions a and β: The Data Process Policy functions and their corresponding Obligation functions

$$\frac{Δ {A}_{α}}{Δ ɛ} , \frac{Δ {A}_{β}}{Δ ɛ} , Π , {Z}_{π}$$

The Data Provenance functions

$$\frac{Δ {R}_{A}}{Δ ɛ} , \frac{Δ {Q}_{A}}{Δ ɛ}$$

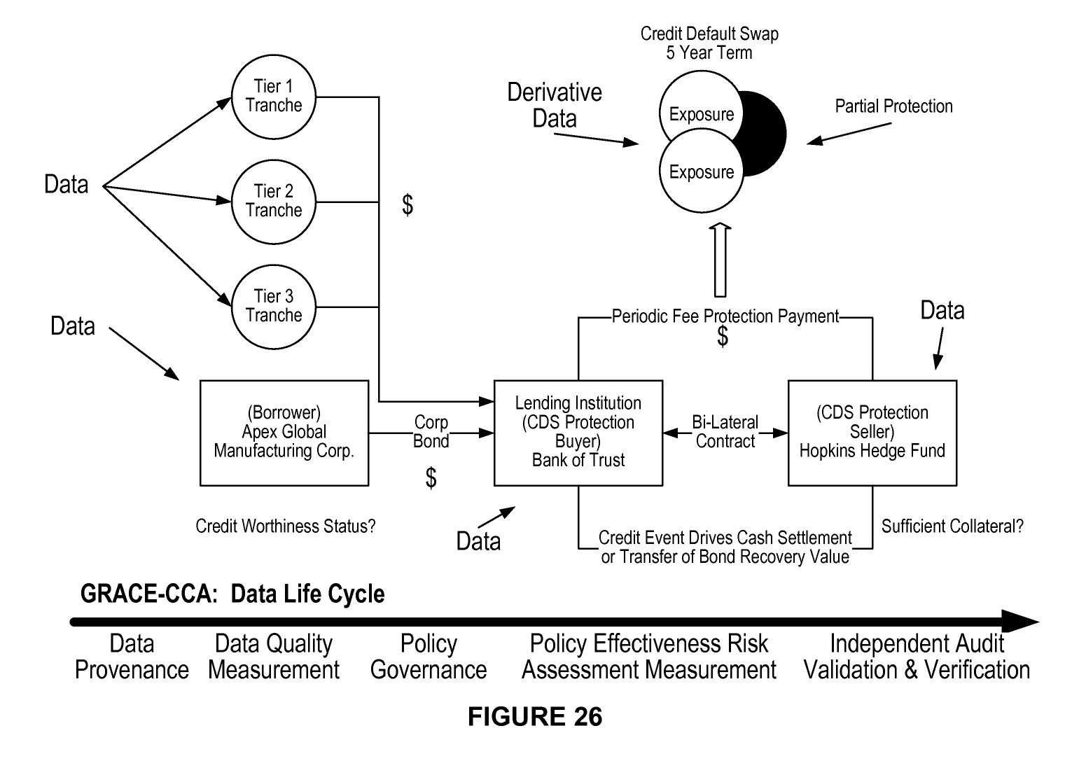

These functions can be designed empirically, statistically or probabilistically or be based upon existing real-world physical system models. Each selected function needs inputs for initial conditions. You'll often use ranges of values to support certain functions and to conduct experiments and simulate different situations and circumstances. In the Credit Default Swap evaluation model we'll construct by way of example, we will demonstrate one approach to building the necessary components using use cases that can be designed from a simplified diagram of a typical CDS landscape (See FIG. 26). This is an effective approach for discovery and exploration of the entities, relationships between entities, attributes, and policies governing business process, data, obligations, etc. These entities, relationships, attributes and polices are the basic building blocks of the model's ontology.

### Setting the Table

A typical Credit Default Swap (CDS) landscape 2600 is shown in FIG. 26. This diagram illustrates business entities and their respective relationships in a simplified CDS life cycle. Many use cases can be designed from this simplified diagram. The diagram represents the beginnings of a knowledge base a GRACE-CRAFT modeler will develop to support the ontological representation if his or her GRACE-CRAFT model. For purposes of this application we are simplifying the CDS market application representation for the sake of brevity. FIG. 26, by way of example, illustrates in chart and block diagram form a global risk assessment center of excellence (“GRACE”) CCA data life cycle 2600, e.g., relating to credit default swaps, which may incorporate data provenance, data quality management, policy governance, policy effectiveness risk assessment measurement and independent audit validation and verification.

In another example of application of the invention, a borrower 2602, Apex Global Manufacturing Corporation, as seen in FIG. 26, needs additional capital to expand into new markets. Bank of Trust, Apex's lending institution 2604, examines Apex Global Manufacturing Corp's financials and analyzes other indicators of performance they think are important and concludes that Apex represents a “good” risk. Bank of Trust then arranges an underwriting syndication 2606 and sale of a 10 year corporate bond 2608 on behalf of Apex Global Manufacturing Corp. The proceeds from the sales of Apex's bonded debt obligation come from syndicated investors in Tier 1, 2610, Tier 2, 2612, and Tier 3, 2614, tranches of Apex's bond. Each of these syndicates of investors 2610, 2602, 2614, have unique agreements in place covering their individual exposure. Typically these include return on investment guarantees and percent payouts in case of default.

Bank of Trust decides to partially cover its calculated risk exposure to an Apex default event by entering into a bi-lateral contract with a CDS protection seller 2630, e.g., Hopkins Hedge Fund. They based the partial coverage decision on an analysis of the current market cost of full coverage and the impact that would have on their own ROI compliance requirements which are driven by the aggregate interest rate spreads on the Bank's corporate bond portfolio.

Bank of Trust's bi-lateral agreement with Hopkins encompasses the terms and conditions negotiated between the parties. Value analysis of the deal is based upon current information (data and knowledge) given by both parties and is used to define the characteristics of the CDS agreement. It is assumed that “this” information is of known quality (a data provenance attribute) from the originating data sources and processes used to build the financial risk assessment and probabilistic models that determined the associated risks and costs of the deal, e.g. the interest on the Net Present Value of cash flows 2642 to be paid by the Bank during the five year life of the CDS 2650 and the partial payout 2660 by the Hopkins Hedge Fund in case a default event on the Apex bond. It is important to keep in mind that once the bi-lateral agreement is in place, the Apex corporate bond 2608 and the CDS agreement 2640 with Hopkins Hedge Fund are linked assets; and can be independently traded in financial markets around the world.

In theory a CDS 2650 should trade with the corporate bond 2608 it is associated with. In practice this has not always been the case because CDS trades have typically been illiquid party-to-party deals. Another characteristic of typical CDS trades has been that they have not been valued at mark to market, but rather at an agreed Book value on a day relative to the trade. This can overstate the value significantly. Valuations for the CDS 2650 and the underlining instrument 2608 being hedged are based upon measures such as average risk exposures, probability distributions, projected cash flows, transaction costs, etc. associated with the asset linkage. These analyses are typically made from aggregate data sources and known processes used to build the structured deals that provide the basis for valuation. In a better world, when these assets trade to other parties the information layer, i.e., the provenance of the deal describing the structure, risk, and valuation would transfer as well. Unfortunately, in the real world of unregulated transaction volumes ballooning from $900 Billion in 2000 to over $45 Trillion in 2007 this risk quality provenance seldom transferred with the instruments. The result is not pretty; but it is instructive.

In another example, the GRACE-CRAFT modeler first identifies and documents the policies that describe and govern the quality of the data used to define risk of the instruments. These might include data source requirements, quality assertion requirements from data providers, third party risk assessment rating requirements, time stamp or other temporal attributes, etc. The same is true of the polices governing the quality and integrity of the processes used to manipulate the data, support the subsequent valuation of the instruments, and support the financial transactions related to trading the instruments.

The GRACE-CRAFT modeler will use this awareness and understanding of the nature and constraints of the polices governing the data used to assess risk and establish the valuation of the instruments being examined to identify and track changes over time and model the affects of those changes on the effectiveness of the policies governing the valuation of the instruments themselves.

FIG. 26, illustrates the modeler's representation of the information layer inputs identified as data sources. It also shows how the data flows through a typical CDS landscape and the CDS itself as a derivative information product of that data.

The precision of the model will be governed by the modeler's attention to detail. The analyst must choose what data from what source or sources to target. This will generally, but not always be a function of understanding the deal buyers' and sellers' requirements, the mechanics and mechanisms of the deal. This understanding will inform the analysts as identification and understanding of the important (generally quality and risk defining) attributes of the data from each source, and the policies used to govern that data and the transactions and other obligations associated with the deal.

The inventive GRACE-CRAFT model can be used to analyze and experiment with alternative information risk assessment results that result from different policies governing source data quality and derivative products. As such the modeler can use his or her model test and evaluate how various data quality, risk management, and other policy scenarios might affect the quality and value of derivative investment products like the Apex CDS. The full disclosure of the Rums' Capital Allocation Choices, Information Quality, and the Cost of Capital in Lenz, C. and R. Verrecchia, 2005, Rums' Capital Allocation Choices, Information Quality, and the Cost of Capital, The Wharton School, University of Pennsylvania, URL: httn://fic.wharton.upenn.ecluffic/papers/04/0408.pdf, is incorporated by reference herein in its entirety.

In another example, the GRACE-CRAFT model supports a setting in which sell-side firms report their risk assessment metrics, analysis, and other valuation reasoning to the market. Reporting can be direct or via trusted agencies to safeguard competitive and other proprietary interests. Buy-side managers in this setting are able to independently assess and validate reported reasoning and, if they wish, counter with their own. In such a setting, when a trade is completed the established market value reflects both firms' reports back to the market. The quality of the reports, which includes independent assessment and verification, affects investment risk management decisioning. This, in turn, affects expected cash flows, cost of capital, and liquidity opportunities. This setting supports the notions that reporting to capital markets play a crucial role in allocating capital and that the quality of information affects an agent's future net cash flows and capital liquidity opportunities.

### Another Example of Application of the Invention: Managing Transaction Volumes

In our scenario, FIGS. 26 and 43-45, Bank of Trust organized the syndication of a 10 year corporate bond based on sound financial analysis of Apex Global Manufacturing. Now, fast forward five years. Apex's corporate bond has combined with other companies' debt and resold in three tranches 2610, 2612, 2614, to investors in several countries. How do the various lending institutions that organized these other companies' bond issuances know if Apex is in compliance with the covenants governing its own bond? What will the effect be on their own balance sheet if Apex defaults? How does Hopkins Hedge Fund 2630 or Bank of Trust 2604 know if either party sells their respective linked assets to other parties?

Obviously corporate performance numbers and rankings are available from such sources such as EDGAR, S&P and Moody's. Regular audits can be very effective for monitoring compliance requirements and asset ownership transfers. The problem is that the availability of sufficient time and expert resources manual audits justifiably require is not always compatible with the efficient market requirements. This is exacerbated in real time global market environments where multinational policy and jurisdiction issues can further complicate manual audit practices.

The sheer number of bonds makes it too costly to manually monitor the financial performance of the companies that secured the bonds. Similarly, the sheer number of CDSs makes it impossible to monitor the performance of the bonds being insured with CDSs. Both instruments, bonds and CDSs, can be and are traded independently to third parties in multiple markets governed by multiple jurisdictions and related polices. The result is a lack of timely information on the performance of the underlying corporations.

Next as stated earlier the modeler will want to use “use cases” as a means to drive requirements for known data attributes, policies, etc., to build from here the knowledge base in this context of the CDS business domain which becomes the ontology for the model. The following examples describe how the financial performance of a company can be tracked and reported and how the transfer of a bond from one bank to another can be tracked and reported.

### Another Example of Applying the Invention: Monitoring the Health of Apex Global Manufacturing Corp.

In our scenario, FIGS. 26 and 43-45, Bank of Trust issued the bond based on sound financial analysis of Apex Global Manufacturing Corp. that included the following information:

Credit rating: BBB

Quick ratio: 0.8

Debt to equity: 1.34

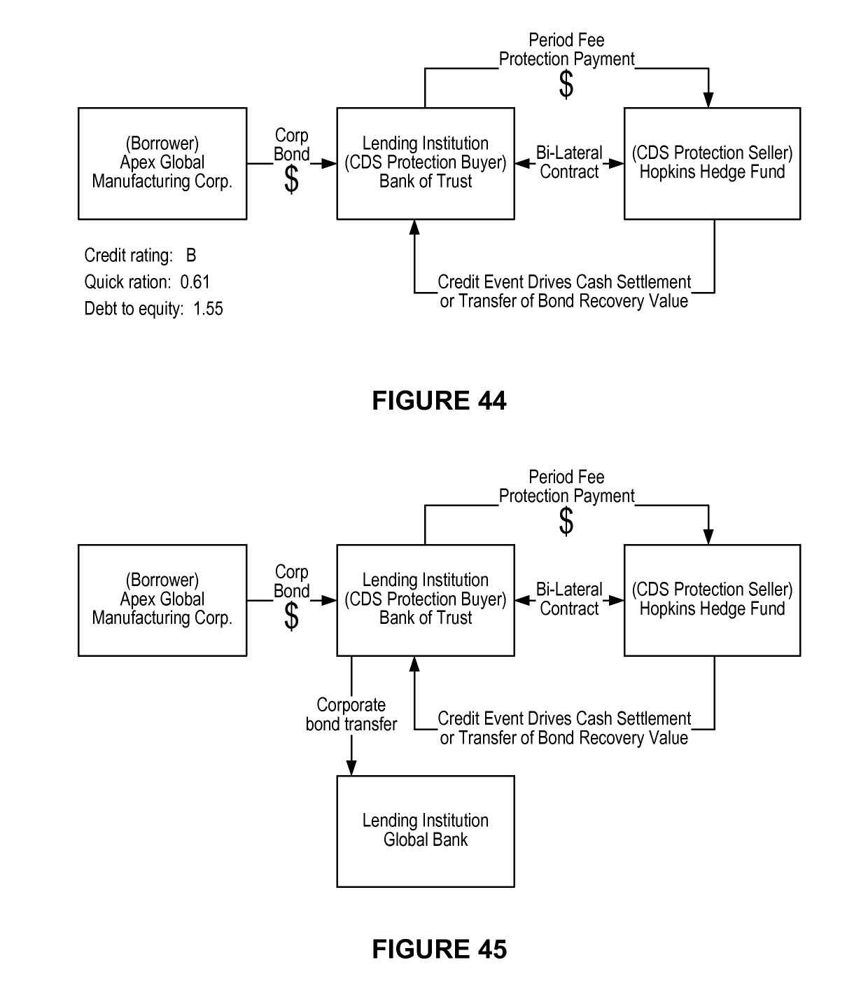

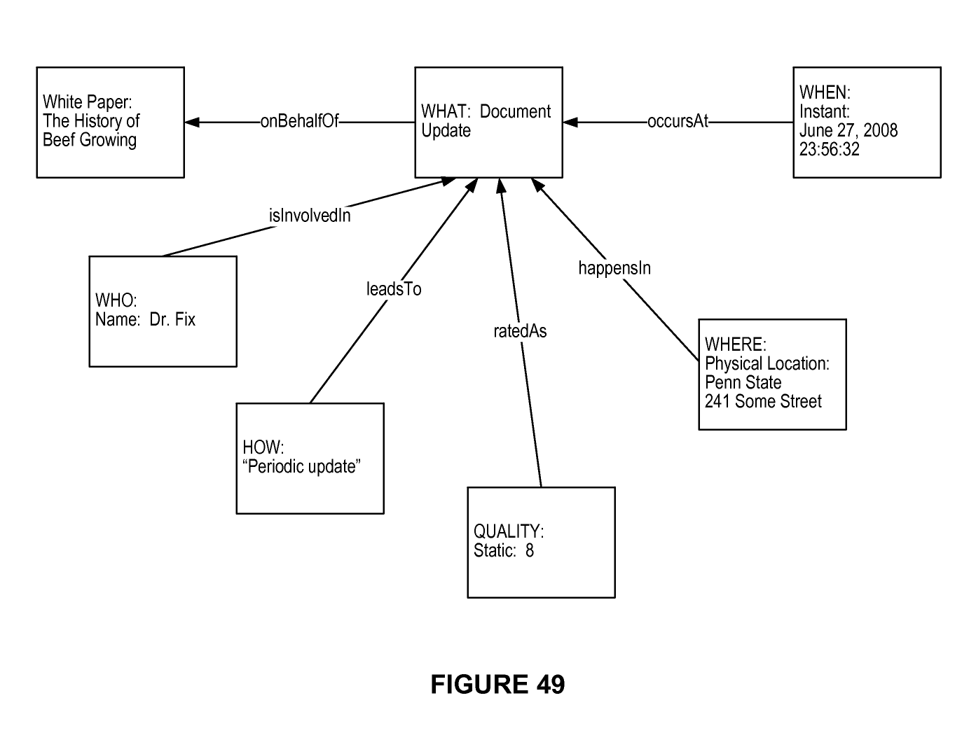

We'll consider this to be Time 0 as shown in FIG. 49. Now fast forward three months to Time 1 as shown in FIG. 44. How does the lending institution know if the company is still performing as well as when it first issued the bond? Does the information on the CDS reflect current states of the entities involved?

In another example, the modeler ideally would monitor the financial statements of Apex Global Manufacturing as well as it's Standard & Poor's credit rating, as example. Then he or she would use this information and apply the policies defined for the modeled system. For example, the policies might include:

If a company's credit rating falls below B (or a 5.30% probability of default—S&P Fitch scale), report the findings.

If a company's quick ratio falls below 0.65, report the findings.

If a company's debt to equity ratio changes more than 15.67% from previous period and quick ratio is below 0.65, report the findings

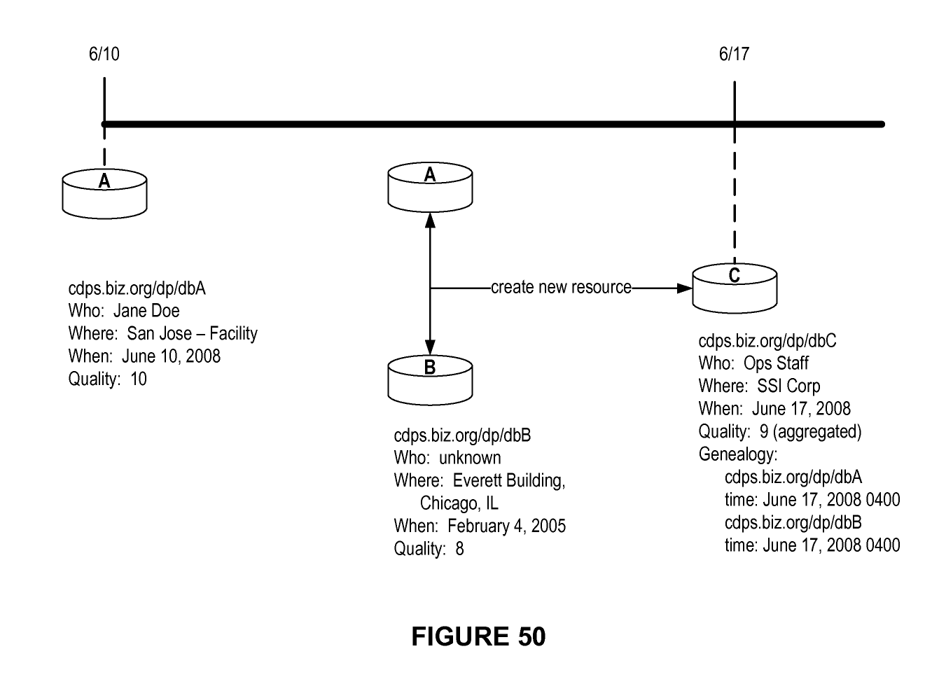

As shown in FIG. 50, Apex Global Manufacturing shows the following financial results:

Credit rating: 13

Quick ratio: 0.61

Debt to equity: 1.55

Based on the policies, the model will report the change in the credit rating from BBB to B, and the fact that the quick ratio changed more than 23.27% along with a significant increase of 15.67% in debt to equity ratio. The application will perform the same analysis for all companies issued bonds. The same type of service would be provided to the protection seller to ensure they are aware of changes that impact their level of risk. The information can be delivered as reports, online, or other format as required by the institutions.

### Another Example of Applying the Invention: Tracking Changes Over Time

Now jump ahead two years to Time 2. Bank of Trust transfers the corporate bond to another lending institution 4502, e.g., Global Bank as shown in FIG. 45. Under current conditions, the transfer may or may not be made known to the protection seller 2630. It now becomes more difficult for the seller 2630 to assess the risk associated with the bond. The protection seller 2630 may have broken a portfolio of CDSs up and sold them to other markets to transfer risks.

A based on a policy that states:

If a lender transfers a bond to another institution, owners of CDSs that include the bond will be notified.

The use cases developed in this application context help the modeler identify the business processes, actors, data process policy driven attributes, etc. needed to continue the model setup for simulation. The results then are considered the knowledge base discovery building blocks for the GRACE-CRAFT model instance.

Another Example of GRACE-CRAFT Model that Utilizes Building Blocks of Ontologies, Policies, and Data Provenance Attributes

Based upon the use case descriptions and diagramming above the modeler discovers important knowledge aspects of the specific business domain model. This collection then can be attached to the ontological representation which becomes the knowledge base of the GRACE-CRAFT model instance. The GRACE-CRAFT model is built around an ontology describing the elements in the system, policies describing how the system should behave, and data provenance tracking the state of the system at any given point in time. Each of these components is described in more detail below.

Ontology. An ontology describes the elements that make up a system, in this case the CDS landscape, and the relationships between the elements. The elements in the CDS system include companies, borrowers, lenders, investors, protection sellers, bonds, syndicated funds, credit ratings, and many more. The ontology is the first step in describing a model so that it can be represented in a software application.

The relationships might include the following:

Borrowers apply for bonds

Lenders issue bonds

Syndicated funds provide money to lenders

Lenders enter bi-lateral agreements with protection sellers.

Policies.

Policies define how the system behaves. Policies are built using the elements defined in the ontology. For example:

A company must be incorporated to apply for a bond.

A company must have a certain minimum financial rating before it can apply for a bond.

A bond can only be issued for a value greater than $1 million.

The value of a bi-lateral agreement must not exceed 90% of the cash value of the bond.

A company's credit rating must not fall below CCC.

A company's quick ratio must remain above 0.66 and debt to equity must be below 1.40.

A company's debt to equity ratio should not change by more than 15% from last quarter measured.

If a lender transfers a bond to another institution, owners of CDSs that include the bond will be notified.

Policies are based on the elements defined in the ontology, and provide a picture of the expected outcomes for the system. Policies are translated in to rules that can be understood by the modeler or a software application. While it may take several hundred data attributes and policies to accurately define a real-world system, a modeler may choose a subset that applies to an experimental focus of the system.

Data Provenance.

Data provenance tracks the data in the system as it changes from one point in time to another. For example, the financial rating of a corporation as it changes from month to month. Or the elements that make up a CDS such as the quality of the information that describes the instrument.

Data provenance becomes important when expectations do not match outcomes. Data provenance provides the means to track possible causes of the discrepancy by allowing an analyst or auditor to reconstruct the events that took place in the system. More important, being able to trace the provenance of data quality across generations of derivative products can provide forewarning of potential problems before those problems are propagated any further.

### Another Example of Applying the Invention: Bringing Transparency to the Credit Default Swap Market

The GRACE-GRAFT model may enable lending institutions and protection sellers to closely model and simulate the effectiveness of data and derivative information risk assessments which drive more efficient risk management decisioning and investment. GRACE-CRAFT modeling also promises to provide early warning of brewing trouble as business environments, regulations, other policies change over time. Finally, GRACE-CRAFT modeling may provide analysts and policy makers with important insights into the relative effectiveness of alternative policies for achieving a defined objective.

### Another Example of GRACE-CRAFT Model—Simple Supply Chain Model, Simplifying the Math

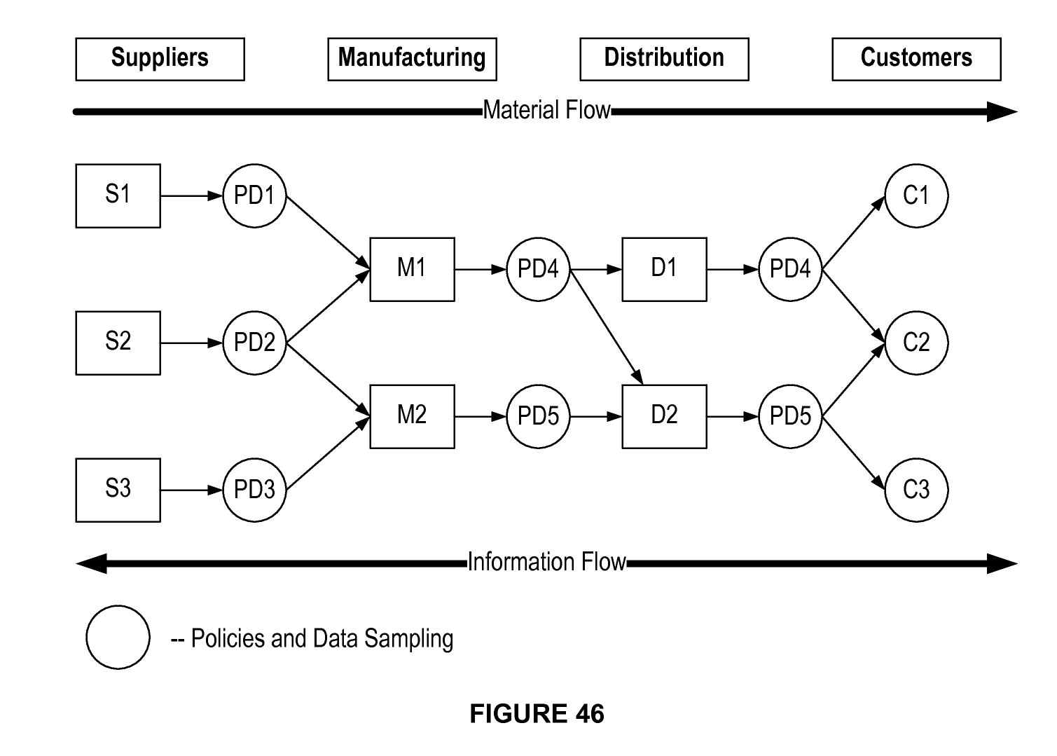

Another example of the GRACE-CRAFT-model is presented in the context of a simple economy supply chain 4602 as shown in FIG. 46. The diagram displays entities identified with respective identification labels. Apex Global Manufacturing Corporation as defined previously, is used as an entity in this example to demonstrate that this example of GRACE-CRAFT model can link business domains or ontologies in this case such that both policy driven data and processes can be tracked and trace over time.

This example uses the same business entity, Apex Global Manufacturing Corporation that is used in the CDS example. In this example, the GRACE-CRAFT model is used to model strategically linked information value chains and information quality tracking across multiple domains. This example shows how the quality of data used to model Apex's manufacturing domain of activity 4602 impacts the quality of data used to model aspects of its financial domain of activity. This example shows how the attention to data quality in two key domains of company activity can directly impact the value of the products it manufactures with this data in each domain of its activities—and thus directly impacts the value of the company itself.

This example shows how the company's operational financial performance data, which is derived from data interactions in its supply chain domain of activity, can be linked to the data products and information risk assessments produced in its financial domain of activity. Financially linked parties will be naturally interested in the provenance and quality of financial performance data relating to Apex Global Manufacturing Corp.

With this linkage established, data—and the polices governing its quality and provenance—becomes more transparent across market specific boundaries.

FIG. 46 shows an entity diagram of a typical manufacturing supply chain 4602. In this example we demonstrate how a modeler samples data from different sources in the supply chain 4602 to model and monitor how different events might impact the quality of that data; and subsequently the quality of supply chain 4602 operations. In this context the quality of the data reflects the quality of the supply chain 4602 operations and the data sources become virtual supply chain 4602 quality data targets that define the dimensions of the GRACE-CRAFT model. The quality of the data attributes imbedded in the information 4604 layer reflects the quality of the physical material and processes the parallel production, transportation, regulatory, and other layers of the physical supply chain. With the choice of data target nodes selected, the GRACE-CRAFT model can be reduced to a computational form. This example is modeled for purposes of simulation and as such its function is to guide, not to dictate; to illuminate assumptions, assertions, and consequences of policy on data quality or other attributes of interest. It is intended to support efficient simulation and assessment of the effectiveness of polices governing, among other things, data quality, and processes used to create, use, and distribute data and derivative products to do work in this simple supply chain representation 4602. The reader will realize the example can become very large computationally if the modeler chooses larger sets of entities, data nodes, events and policies to experiment with. Stakeholders can use this model to track data provenance through generations of derivative works. Data provenance tracing and assurance is a key concept and functional capability of this model's application to a simple supply chain and the application mechanism it supports.

FIG. 46 represents a simple entity relationship diagram of how the modeling principles described above can be applied to modeling and simulating the effectiveness of polices governing Apex's global supply chain data, and how that affects the operational and completive efficiency of the physical supply chain itself.

FIG. 46 shows a simple supply chain 4602 with identified data nodes (PD1-PD7) distributed at key informational target points defined from requirements of the system model. In the model 4602, suppliers S1, 4610, S2, 4612, and S3, 4614, respectively, provide data to data nodes PD1, 4620, PD2, 4622, and PD3, 4624, from which it is passed on the manufacturing facilities M1, 4630, and M2, 4632. Supplier S2, 4612, supplies both manufacturing facilities M1, 4630 and M2, 4632, so that the data passes from node PD2, 4622, to both manufacturing facilities M1, 4630 and M2, 4632.

Manufacturing facilities M1, 4630 supplies information to a data node PD4 4640 and manufacturing facility M2, 4632 supplies data to a data node PD5, 4642. Manufacturing facility M1, 4630 supplies output products to both distributors D1, 4650, and D2, 4652 and so data node PD4, 4640, passes on information to both distributor D1, 4650, and D1, 4652, while the data node PD5, 4642, passes on information to distributor D2, 4652. Distributor D1, 4750, supplies information to data node PD6, 4660, and distributor D2 supplies information to data node PD7, 4662. Distributor D1, 4650, distributes product to customers C1, 4670 and C2, 4672, while distributor D2, 4652, distributes product to customers C2, 4672 and C3, 4674, so that data node PD6, 4660, supplies information to customers C1, 4670, and C2, 4672, and data node PD7, 4662, supplies information to customers C2, 4672 and C3, 4674. It will be understood, from the information flow arrows 4604, that information may flow between the information connection points in both directions between the entities and nodes as so connected in the illustrative supply chain flow diagram 4602 of FIG. 46. Also as illustrated in FIG. 46, information analysis and flow control policies and data sampling may occur in each of the data nodes PD1-PD7. Material, e.g., in the form of supplies, manufactured product and distributed product may flow in the direction indicated by the material flow arrow 4606, and it will be determined by may contractual, physical, operational, specification, time and other rules, policies contractual terms and the like that defines these flows and may dictate some or all of the informational flows embodied in the supply chain 4602 of FIG. 46. It will also be understood that in such a supply chain, as is typical in the art a product being passed through the supply chain 4602 as noted in FIG. 46 in the form of supplies, manufacturing output and distribution output product may be a product, a service of some combination of the two. It will also be understood by those skilled in the art, as is well known in the art, that each of the customers C1, 4670, C2, 4672, and C3, 4674, may also be acting as a manufacturing facility supplying further customers (not shown) down the line with finished products based on being supplied themselves through the supply chain illustrated by way of example in FIG. 46.

It will be appreciated by those skilled in the art that herein disclosed, at least with respect to FIGS. 26 and 42-46, is a method comprising: providing a business supply chain model comprising an ontology comprising elements making up a domain of the business supply chain model, the domain including: at least one supplier within a supply chain of the business according to an agreement between the business and the supplier to supply an amount of at least one of a product and the provision of a service of the supplier to at least one manufacturing facility of the business by a selected time; at least one protection seller, operating with the business according to an agreement between the protection seller and the business insuring the supply by the supplier to the business of at least a portion of the amount of the product or the provision of the service over the selected time period; at least one of the supplying and the insuring being based on the supplier meeting a set of initial insuring policy criteria established by at least one of the business and the protection provider, the meeting of at least one of which criteria, as a variable criteria, being subject to change over the selected time period; at least one agent of at least one of the business and the protection provider collecting information relevant to measuring any change in at least one variable insuring policy criteria according to a definition of a relevant change in the insuring policy criteria during the selected time period; and determining, via a computing device, based on at least one of the insuring policy rules as applied to the information collected, a warning to at least one of the business and the protection provider that an obligation of the supplier to the business is at risk of non-performance before the end of the selected period of time.

To the same extent as noted above, it will be understood by those skilled in the art that there is herein disclosed a method comprising: providing a business supply chain model comprising an ontology comprising elements making up a domain of the business supply chain model, the domain including: at least one supplier within a supply chain of the business according to an agreement between the business and the supplier to supply an amount of at least one of a product and the provision of a service of the supplier to at least one manufacturing facility of the business by a selected time; at least one protection seller, operating with the business according to an agreement between the protection seller and the business insuring the supply by the supplier to the business of at least a portion of the amount of the product or the provision of the service over the selected time period; at least one of the supplying and the insuring being based on the supplier meeting a set of initial insuring policy criteria established by at least one of the business and the protection provider, the meeting of at least one of which criteria, as a variable criteria, being subject to change over the selected time period; at least one agent of at least one of the business and the protection provider collecting information relevant to measuring any change in at least one variable insuring policy criteria according to a definition of a relevant change in the insuring policy criteria during the selected time period; and providing, via a computing device, an assurance of the data provenance of the information collected.

### Another Example of GRACE-CRAFT Model:

The GRACE CRAFT Model is calculated from an equation shown in (eqn. 11.) below.

$${G}_{ɛ} := ( {V}_{ɛ} , {E}_{ɛ} ) \to {\int }_{ɛ} [ G [ α , β , \frac{\partial }{\partial ɛ} Γ [ P ( {A}_{α} , {A}_{β} , Π , {Z}_{π} ) , D ( {R}_{A} , {Q}_{A} ) ] ] ] \partial ɛ \pm {\int }_{ɛ - 1} [ Min Max [ {\int }_{k} [ K ( α , β , \frac{\partial }{\partial ɛ} Γ ) ] \partial k ] ] \partial ɛ \qquad ( eqn . 11. )$$

A transformation of (eqn. 9.) into a form of practical application for a computational system is developed by first expressing the model as:

$${G}_{ɛ} := ( {V}_{ɛ} , {E}_{ɛ} ) \to {\sum }_{ɛ} [ G [ α , β , \frac{Δ Γ}{Δɛ} [ P ( {A}_{α} , {A}_{β} , Π , {Z}_{π} ) , D ( {R}_{A} , {Q}_{A} ) ] ] ] \pm {\sum }_{ɛ - 1} [ Min ( ) , Max ( ) {\sum }_{k} [ K ( α , β , \frac{Δ}{Δɛ} Γ ) ] ] \qquad ( eqn . 12. )$$

Entropy functions α and β are known to operate on the set A_{α} and A_{β} randomly. Making this assumption one could choose to apply a statistical approach to random changes for the values of A_{α} and A_{β} over time. Of course a logical guess is needed for initial values. It is assumed highly probable entropy effects in A_{α} and A_{β} is small in magnitude for small time segments and is real and measurable. We assume unpredictable Knightian uncertainties low probability random influences that affect large scale magnitude changes to A_{α} or A_{β} independently are valid and can be modeled statistically as well, depending on model design and requirements.

Either statistically or probabilistically these entropy functions can be modeled as finite differences for a set of events although not changed by these events as define earlier.

α=α(A_{α})=Probability function denoting the probability of a change in A_{α}±ΔA_{α}.
B=β(A_{β})=Probability function denoting the probability of a change in A_{β}±ΔA_{β}.
Agents must consider a range of probability models in which to apply to specific business concepts, the ontology defined in (eqn. 11.)

The Continuous Compliance Assessment Utility function can be simplified for purposes of practical application as:

$$\frac{Δ Γ}{Δɛ} [ P ( {A}_{α} , {A}_{β} , Π , {Z}_{π} ) , D ( {R}_{p} , {Q}_{p} ) ] = [ \frac{Δ P}{Δɛ} ( {A}_{α} , {A}_{β} , Π , {Z}_{π} ) , \frac{Δ D}{Δɛ} ( {R}_{A} , {Q}_{A} ) ] \qquad ( eqn . 13. )$$

### Carrying the

$$\frac{Δ}{{Δ}_{ɛ}}$$

into the Data Process Policy function yields,

$$\frac{Δ P}{Δɛ} = ( \frac{Δ {A}_{α}}{Δ ɛ} , \frac{Δ {A}_{β}}{Δ ɛ} , Π , {Z}_{π} ) \qquad ( eqn . 14. )$$

And similarly with die Data Provenance function,

$$\frac{Δ D}{Δ ɛ} = ( \frac{Δ {R}_{A}}{Δ ɛ} , \frac{Δ {Q}_{A}}{Δ ɛ} ) \qquad ( eqn . 15. )$$

where the Recording and Querying functions are functions of ΔA_{α} and ΔA_{β} respectively. This means the functions are used only when a change in attribute is measured. These functions act to store and retrieve changes in A_{α} and A_{β} as matrix arrays. The Continuous Compliance Objective function is represented as,

$$\pm {\sum }_{ɛ - 1} [ min ( ) , Max ( ) {\sum }_{k} [ K ( α , β , \frac{Δ}{Δ ɛ} Γ ) ] ]$$

Bringing all terms back into the full model:

$${G}_{ɛ} := ( {V}_{ɛ} , {E}_{ɛ} ) \to {\sum }_{ɛ} G [ α ( {A}_{α} ) , β ( {A}_{β} ) , ( \frac{Δ {A}_{α}}{Δɛ} , \frac{Δ {A}_{β}}{Δɛ} , Π , Z π ) ( \frac{Δ {R}_{p}}{Δɛ} , \frac{Δ {Q}_{p}}{Δɛ} ) ] \pm {\sum }_{ɛ - 1} [ Min ( ) , Max ( ) [ {\sum }_{k} K [ ( α ( {A}_{α} ) , β ( {A}_{β} ) , ( \frac{Δ {A}_{α}}{Δɛ} , \frac{Δ {A}_{β}}{Δɛ} , Π , Z π ) , \frac{Δ}{Δɛ} ( \frac{Δ {R}_{p}}{Δ ɛ} , \frac{Δ {Q}_{p}}{Δ ɛ} ) ) ] ] ] \qquad ( eqn . 16. )$$

Representing elements of (eqn. 16) as a matrix set yields,

G=[ΔĀ_{α},ΔĀ_{β},Δ P̅,Δ D̅]± K̅_{min max}=[ΔĀ_{α},ΔĀ_{β},Δ P̅,Δ D̅] (eqn. 17.)

As example for a single arbitrary measurable event [symbol] ₁, assuming only (1) attribute, (1) policy, and (1) obligation per sensor node for the nodes PD1, PD4, PD6, PD7 as shown in FIG. 4, the matrix set in (eqn. 17.) can be expanded into its respective elements as,
(Degrees of freedom, DOF=(4) for the data target set)

$$[ \begin{matrix}{a}_{{α}_{1}}^{α} \\ {a}_{{α}_{2}}^{α} \\ {a}_{{α}_{3}}^{α} \\ {a}_{{α}_{4}}^{α}\end{matrix} ] , [ \begin{matrix}{a}_{{β}_{1}}^{β} \\ {a}_{{β}_{2}}^{β} \\ {a}_{{β}_{3}}^{β} \\ {a}_{{β}_{4}}^{β}\end{matrix} ] , [ \begin{matrix}{a}_{{α}_{1}}^{{ɛ}_{1}} & {a}_{{β}_{1}}^{{ɛ}_{1}} & {π}_{1}^{{ɛ}_{1}} & {z}_{{π}_{1}}^{{ɛ}_{1}} \\ {a}_{{α}_{2}}^{{ɛ}_{1}} & {a}_{{β}_{2}}^{{ɛ}_{1}} & {π}_{2}^{{ɛ}_{1}} & {z}_{{π}_{2}}^{{ɛ}_{1}} \\ {a}_{{α}_{3}}^{{ɛ}_{1}} & {a}_{{β}_{3}}^{{ɛ}_{1}} & {π}_{3}^{{ɛ}_{1}} & {z}_{{π}_{3}}^{{ɛ}_{1}} \\ {a}_{{α}_{4}}^{{ɛ}_{1}} & {a}_{{β}_{4}}^{{ɛ}_{1}} & {π}_{4}^{{ɛ}_{1}} & {z}_{{π}_{4}}^{{ɛ}_{1}}\end{matrix} ] , [ \begin{matrix}( {a}_{{α}_{1}}^{α} , {a}_{{β}_{1}}^{β} , {a}_{{α}_{1}}^{{ɛ}_{1}} , {a}_{{β}_{1}}^{{ɛ}_{1}} ) & ( {a}_{{α}_{1}}^{{α}_{n}} , {a}_{{β}_{1}}^{{β}_{n}} , {a}_{{α}_{1}}^{{ɛ}_{n}} , {a}_{{β}_{1}}^{{ɛ}_{n}} ) \\ ( {a}_{{α}_{2}}^{α} , {a}_{{β}_{2}}^{β} , {a}_{{α}_{2}}^{{ɛ}_{1}} , {a}_{{β}_{2}}^{{ɛ}_{1}} ) & ( {a}_{{α}_{2}}^{{α}_{n}} , {a}_{{β}_{2}}^{{β}_{n}} , {a}_{{α}_{2}}^{{ɛ}_{n}} , {a}_{{β}_{2}}^{{ɛ}_{n}} ) \\ ( {a}_{{α}_{3}}^{α} , {a}_{{β}_{3}}^{β} , {a}_{{α}_{3}}^{{ɛ}_{1}} , {a}_{{β}_{3}}^{{ɛ}_{1}} ) & ( {a}_{{α}_{3}}^{{α}_{n}} , {a}_{{β}_{3}}^{{β}_{n}} , {a}_{{α}_{3}}^{{ɛ}_{n}} , {a}_{{β}_{3}}^{{ɛ}_{n}} ) \\ ( {a}_{{α}_{4}}^{α} , {a}_{{β}_{4}}^{β} , {a}_{{α}_{4}}^{{ɛ}_{1}} , {a}_{{β}_{4}}^{{ɛ}_{1}} ) & ( {a}_{{α}_{4}}^{{α}_{n}} , {a}_{{β}_{4}}^{{β}_{n}} , {a}_{{α}_{4}}^{{ɛ}_{n}} , {a}_{{β}_{4}}^{{ɛ}_{n}} )\end{matrix} ] \pm [ \begin{matrix}{a}_{{α}_{1}}^{α - 1} \\ {a}_{{α}_{2}}^{α - 1} \\ {a}_{{α}_{3}}^{α - 1} \\ {a}_{{α}_{4}}^{α - 1}\end{matrix} ] , [ \begin{matrix}{a}_{{β}_{1}}^{β - 1} \\ {a}_{{β}_{2}}^{β - 1} \\ {a}_{{β}_{3}}^{β - 1} \\ {a}_{{β}_{4}}^{β - 1}\end{matrix} ] , [ \begin{matrix}{a}_{{α}_{1}}^{{ɛ}_{1} - 1} & {a}_{{β}_{1}}^{{ɛ}_{1} - 1} & {π}_{1}^{{ɛ}_{1} - 1} & {z}_{{π}_{1}}^{{ɛ}_{1} - 1} \\ {a}_{{α}_{2}}^{{ɛ}_{1} - 1} & {a}_{{β}_{2}}^{{ɛ}_{1} - 1} & {π}_{2}^{{ɛ}_{1} - 1} & {z}_{{π}_{2}}^{{ɛ}_{1} - 1} \\ {a}_{{α}_{3}}^{{ɛ}_{1} - 1} & {a}_{{β}_{3}}^{{ɛ}_{1} - 1} & {π}_{3}^{{ɛ}_{1} - 1} & {z}_{{π}_{3}}^{{ɛ}_{1} - 1} \\ {a}_{{α}_{4}}^{{ɛ}_{1} - 1} & {a}_{{β}_{4}}^{{ɛ}_{1} - 1} & {π}_{4}^{{ɛ}_{1} - 1} & {z}_{{π}_{4}}^{{ɛ}_{1} - 1}\end{matrix} ] , [ \begin{matrix}0 & ( {a}_{{α}_{1}}^{α - 1} , {a}_{{β}_{1}}^{β - 1} , {a}_{{α}_{1}}^{{ɛ}_{1} - 1} , {a}_{{β}_{1}}^{{ɛ}_{1} - 1} ) \\ 0 & ( {a}_{{α}_{2}}^{α - 1} , {a}_{{β}_{2}}^{β - 1} , {a}_{{α}_{2}}^{{ɛ}_{1} - 1} , {a}_{{β}_{2}}^{{ɛ}_{1} - 1} ) \\ 0 & ( {a}_{{α}_{3}}^{α - 1} , {a}_{{β}_{3}}^{β - 1} , {a}_{{α}_{3}}^{{ɛ}_{1} - 1} , {a}_{{β}_{3}}^{{ɛ}_{1} - 1} ) \\ 0 & ( {a}_{{α}_{4}}^{α - 1} , {a}_{{β}_{4}}^{β - 1} , {a}_{{α}_{4}}^{{ɛ}_{1} - 1} , {a}_{{β}_{4}}^{{ɛ}_{1} - 1} )\end{matrix} ] \qquad ( eqn . 18 )$$

If this is the first event recorded then the Objective functions observation is likely to be null matrix since there will be “zero event” history before beginning the model simulation. However based upon assumptions made for initial conditions and the time of actual computational sampling all entropy effects may be measurable and can be used to make correction before marching forward with more events and observations. The Data Provenance Querying function (and not the queried attributes contained in the Objective function) can be sampled for attribute values for any past event sampling and usually will be driven by policy as represented in (eqn. 16.).

The next steps of using this model are for the modeler to design the GRACE-CRAFT specific model application functions: The Event Forcing functions ε: The Entropy functions a and β: The Data Process Policy functions and their corresponding Obligation functions

$$\frac{Δ {A}_{α}}{Δ ɛ} , \frac{Δ {A}_{β}}{Δ ɛ} , Π , {Z}_{π} .$$

The Data Provenance functions

$$\frac{Δ {R}_{A}}{Δ ɛ} , \frac{Δ {Q}_{A}}{Δ ɛ}$$

Finally the range and initial conditions for these functions and all attributes must be defined or estimated to complete the design of the simulation.

The modeler may choose to design these functions empirically, statistically or probabilistically or be based upon existing real physical system models.

### Yet Another Example of Applying the Invention.

In another example, the CCA Architecture defines the usage of Data Provenance such that it achieves the objectives of the business requires and does not limit future capability of its use. As this term used in context of this example, Data Provenance refers to the history of data including its origin, key events that occur over the course of its lifecycle, and other traceability related information associated with its creation, processing, and archiving. It is the essential ‘ingredient that ensures that users of data (for whom the data may or may not have been originally intended) understand the background of the data. This includes concepts such as, What (sequence of resource lifetime events), Who generated the-event (Person Or Organization), Where the event came from (location), How the event transformed the resource, the assumptions made in generating it, and the processes used to modify it, When the event occurred (started/ended), Quality measure (used as a general quality assessment to assist in assessing this information, within the DATA policy governance) and Genealogy (defines sources used to create a resource). The use of Data Provenance in the CCA Architecture has many applications within a social business and legal context. Other examples of the application of Data Provenance is as follows.

Data, Quality:

The lineage can be used via policy to estimate data quality and data reliability based on the (Who, Where) source of the information and the process (What, How) used to transform the information. The level of detail in the Data Provenance will determine the extent to which the quality of the data can be estimated. This information can be used to help the user of the data determine authenticity and avoid spurious data sources. Since a “trusted data information exchange” governed by policy provides a certified semantic knowledge of the Data Provenance, it is possible to automatically evaluate it based on Quality metrics that are defined and provide a “quality score”. Hence, the Quality element can be used separately or in conjunction with policy based estimations to determine quality. It can be considered the “authoritative” element for Data Quality.

Audit Trail:

Data Provenance can be used to trace the audit trail of data, and determine resource usage, who has accessed information. The audit trail is especially important when establishing patents, or tracing intellectual property for business or legal reasons.

Attribution:

Pedigree can establish the copyright and ownership of data, enable its citation, and determine liability in the case of erroneous use of data.

Informational:

A generic use of Data Provenance lineage is to query base on lineage metadata for data discovery. It can be browsed to provide a context to interpret data.

Data Provenance Basic Actions

There are three basic actions performed on Data Provenance information, record, query, and delete. Record is the action by which data Provenance information is created and modified. Query provides a means to retrieve information from a Data Provenance store. The delete action removes information from a Data Provenance store.

Data Provenance Ontology

This section describes the classes that describe each data provenance concept and make up part of the Data Provenance ontology. The Data Provenance as used for each CCA Service Application may vary in accordance with future business requirements for Data Provenance.

What Semantics

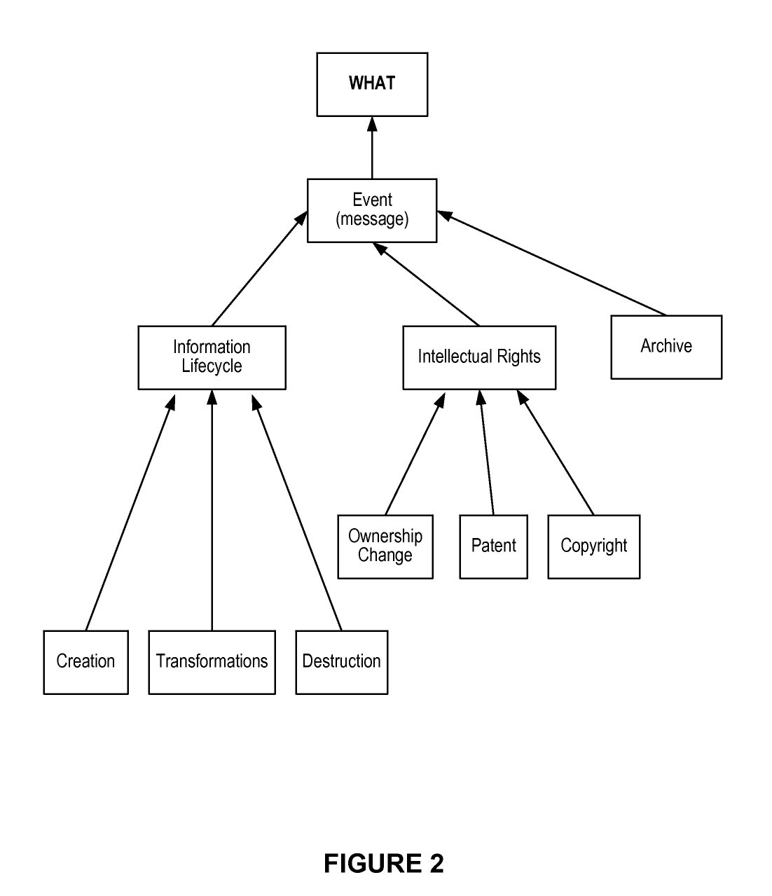

What, is a set of events (messages) capturing the sequence of events that affect the Data Provenance of a resource during its lifetime. What tracks the lifetime events that bring a resource into existence, modify its intrinsic or mutual properties or values, and its destruction and archiving. FIG. 2 shows how these events are categorized as information lifecycle, intellectual rights and archive. It is from the What that drives all operations for Record and Delete actions acting upon Data Provenance. Events are associated with message requests invoking the CCA policy. The Information Lifecycle events are solid concepts. These events are an example of events essential to Data Provenance.

Creation—specifies the time this resource came into existence. The creation event time stamp is placed in the When concept. The Where, What, Who and How may contain data from this event. There will be situations where Creation events will not occur for a resource but the resource nonetheless exists. A mechanism needs to be in place that create a resource simulating the Creation event.

Transformations—specifies when the resource is modified. The transformation event time stamp is placed in the When concept. The Where, What, Who and How may contain data from this event.

Destruction—specifies when the resource is no longer tracked by Data Provenance. There will not be any removal of historic Data Provenance information. Data Provenance information for a given resource will be archived when an archive event occurs. From that point forward, information regarding the destroyed resource's Data Provenance will be obtain via the archive.

Intellectual Rights are events dealing with actions that require a change of ownership, patent or copyright. One can deduce that these events are a subtype of Transformations. However, transformations deal with a change of the resource whereas Intellectual Rights events are legal event signifying a change of ownership, patent, or copyright.

Archive is an event signifying the Data Provenance for a given resource that was moved from an active transactional state to the archive state. The archive state could mean a separate offline store or a store where different policy controls are in place.

When Semantics

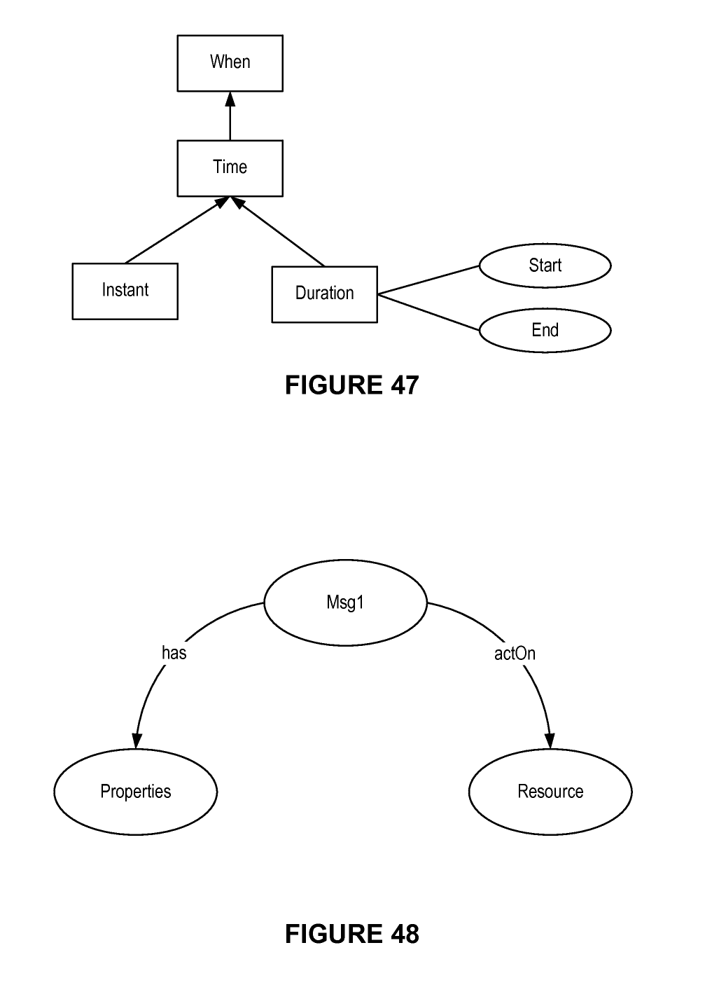

As shown in FIG. 47, When 4702, represents a set of time stamps 4704 representing the time period during which a Data Provenance event 4700 occurred during the lifetime of the resource. Some events 4710 might be instantaneous while others 4712 may occur over an interval of time, hence there is a start time 4730 and end 4740 time. The Time Instant 4710 is used when a single event does not specify a start or end of a duration period. For instance, a document being posted is a single Time Instant event 4710. It happened at this time with no start or end period.

Where Semantics

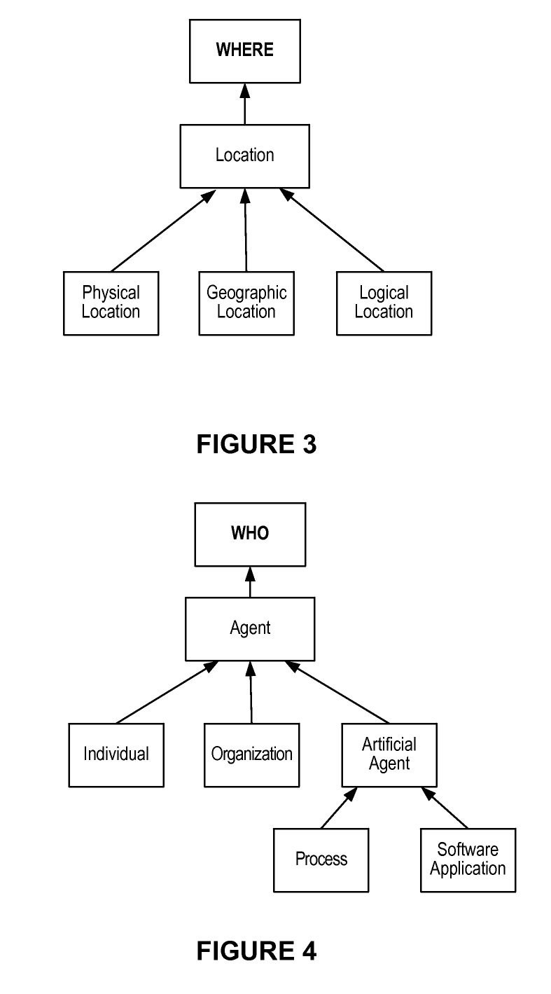

As shown in FIG. 3, in a portion 300 of the data provenance process, Where, 302, represents the location 304 of where the various events originated. Physical location 310 represents an address within a city, state, province, county, country, etc. The Geographical location 320 represents a location based on latitude and longitude. The logical location link 330 the WHERE resource 302 to its URI location. This could be a database, a service interface, etc.

Who Semantics

As shown in FIG. 4, in a portion 400 of the data provenance process, a WHO resource 402, refers to the agent 404 who brought about the events. An agent can be a person 410, organization 420, or an artificial agent 430 such as a process 432, or software application 434.

The Agent class is used for attribution to determine who the owner of a resource.

How Semantics

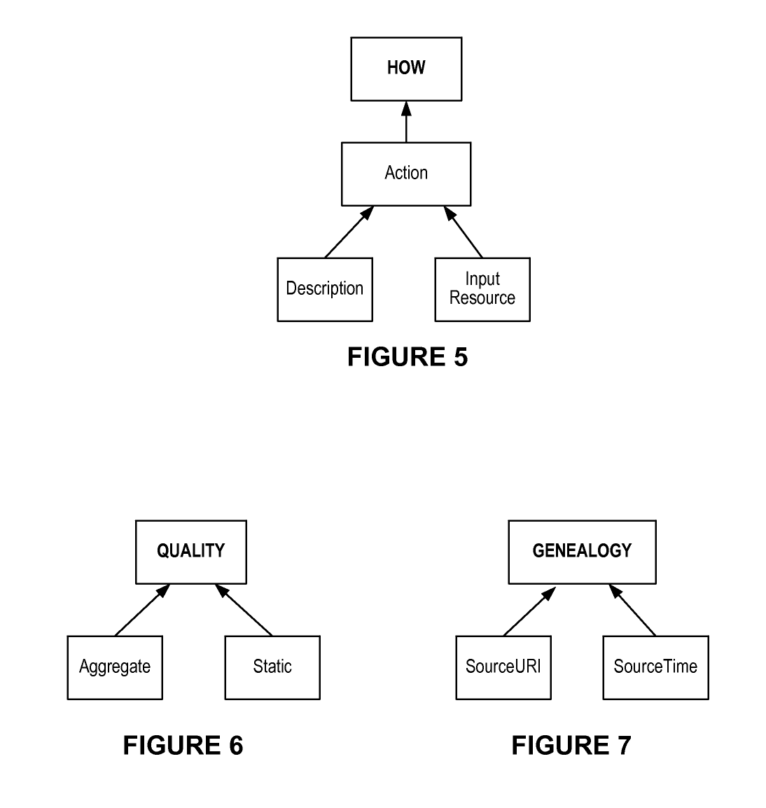

With respect to FIG. 5, in a portion 500 of the data provenance process, a HOW resource 502 documents the actions 504 taken on the resource. It describes how the resource was created, modified (transformed) or its destruction, e.g., as represented in block 510. If there are inputs required to, e.g., perform data correlation or fusing of more than one Data Source, the Input Resource 520 can define the input resources.

Quality Semantics

With respect to FIG. 6, in a portion 600 of the data provenance process, a QUALITY resource 602, is represented through policy driven aggregation 609 or it is a single static value 606. The aggregate value is achieved by a policy defined algorithm which performs analysis on Data Provenance values as well as other resource information to determine the Quality Aggregate value. Perhaps the algorithm used to determine the aggregate value is defined in the policy. The Static preset value is a value achieved through human perception.

In another example, a Slot Exchange company had a quality aggregate that we based on feedback received from slot purchasing customers. The computer program of this invention, at some duration, would inspect all the feedback ratings and derive an up to date value for the slot trade rating for a company. There may be one or more Quality measures for any given resource. For instance, a science publication may have other quality measures such as Technical Content, Writing Skills, Scientific Accuracy, Number of Readers, Last Edit Date. These could be Static values set by someone or they could be Aggregate measures determined by policy.

Genealogy Semantics

With respect to FIG. 7, in a portion 700 of the data provenance process, a GENEOLOGY concept provides the linkage to answer the question, what information sources Data Provenance make up this resource's Data Provenance, such as a source URI 710 or a source time 720.

The Genealogy concept is only used when a resource^{c} consists of other resources which resources have Data Provenance information tracking capability on The Source URI is a pointer to the Data Provenance of resource and consists of information obtained from this resource SourceTime is the time that the source resource was used to construct the new resource.

There is an example of the use of this concept in the following section on Data Provenance Gene. It will help to understand the use of this concept.

Other Semantics

There are at least two ontology Semantics that can be associated with Data Provenance, Why and Which. Why describes the decision making rationale of an action on a given resource. Which describes the instruments of software applications used in creating or processing resource.

Data Provenance Graphs

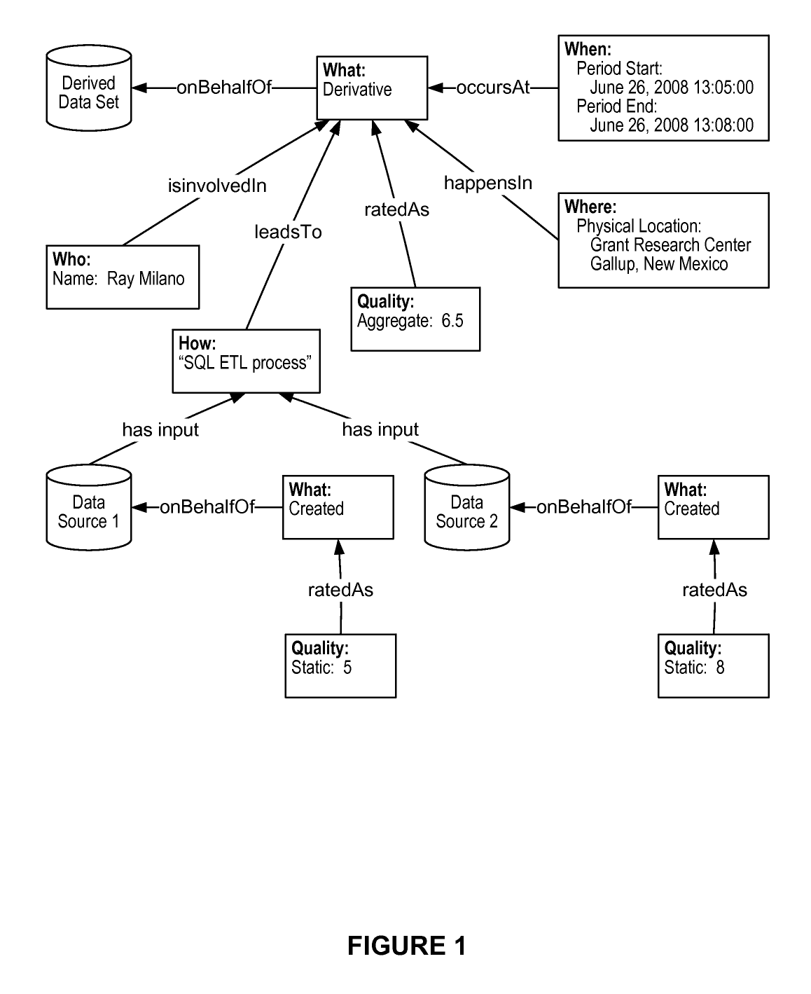

FIG. 49, similarly to FIG. 1, shows a portion 4900 of the data provenance process, shows an example of Document Update Graph that illustrates the relationships of the What, 4902, i.e., a document update, When, 4904, i.e., an instant in time, Who, 4910, i.e., an individual who “is InvolvedIn”, How, 4930, i.e., through a periodic update, which “leadsTo,” the document update, Where, 4920, i.e., a physical location that the document update “happensIn,” and Quality 4940, which the update of a documented being updated is “ratedAt. By reading this graph we can surmise the document “The History of Beet Growing” was updated on Jun. 27, 2008 by Dr. Fix. The update was performed at Penn State and has a quality rating of 8.

In another graph example, FIG. 1, Derivative Graph, shows a derivative Data Set being updated by a SQL ETL process which started on June 26^{th} at 1:051³M and completed at 1:08 PM in the Grant Research Center. This derivative Data Set has an aggregated Quality rating of 6.5 as this rating was aggregated by averaging the Data Source 1 and Data Source 2 static Quality metric.

Data Provenance Time Stamps

The Data Provenance record and delete actions require a time stamp. If there are multiple objects being created, updated, destroyed or archived, a time stamp is required for each object. This is not to infer a separate time stamped event for each object but rather a linking of all Data Provenance actions through a key to a single time stamp. This would be analogous to a foreign key in a RDBMS. This is probably stating the obvious but it is essential for auditing and Data Quality algorithms.

Data Provenance and CCA Service Application Relationships

A CCA Service Application has a set of ontologies that describe the application domain which contains a set of resources and rules which govern the behavior the application. Initially a resource defined in the ontology does not have Data Provenance associated with the resource. The invention provides a mechanism to associate the Data Provenance ontology to a CCA Application resource. A relationship between the resource, message and data provenance is required to set in play any record or delete action for Data Provenance. The CCA Service Application execution is driven by receiving messages (events) and executing policy (rules) which contain the going business logic. Not all CCA Service Applications will r require to track Data Provenance. In another example, the Data Provenance capability is optional. Perhaps from a licensing perspective it will be a feature. Once it is decided that a business requires Data Provenance, the analyst will need to decide which resources defined by the CCA Service Application's ontologies will require Data Provenance information and what data properties are required, etc. A relationship between the business domain resource and the Data Provenance classes can be used to represent the relationship.

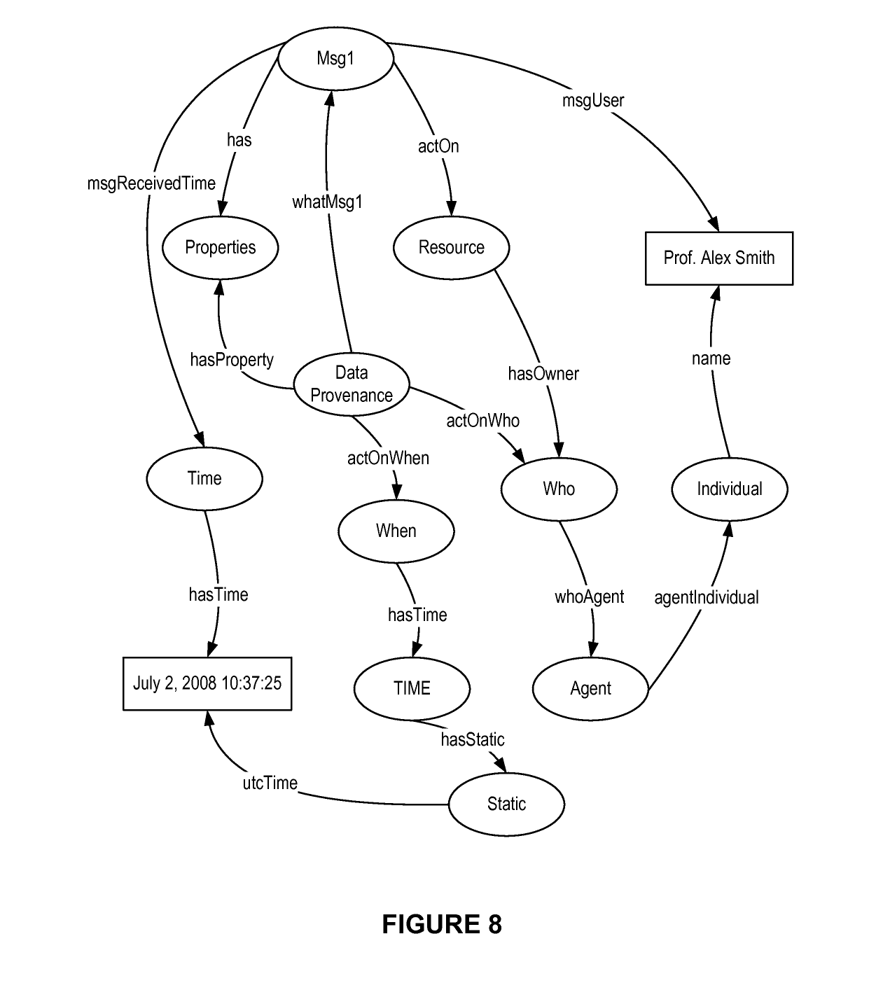

FIG. 8, in a portion 800 of the data provenance process, is a simplified domain ontology that shows the properties of the Class Msg1 802. The Properties of interest for Data Provenance are contained in Msg1 802 of the Business Object that is acted upon when a message is received. Data Provenance is enabled by establishment of the relationships in the ontology. As an example, the Data Provenance process 850 can identify whatMsg1, which Msg1 802 is connected to Properties 804 that the Msg1 “has” and Resource 806 that the Msg1 802 can “actOn” and to a Time 840 that the Msg1 was received, i.e., “msgReceivedTime” and a “msgUser” 810 identified as an individual 812 having a name. The Data Provenance 450 can also identify the individual 810 as a Who, 820, who is an Agent 822 comprising the “agentIndividual” as indicated in block 812. Also, the Data Provenance process 850 can identify when 830 as a time 832 which is static 834 such as a date, time stamp 842. As can be visualized in from these diagrams, relationships between the message(s) 802 (What event), Data Provenance 850 concept(s), and the resource(s) of a set of business objects is essential to be able to:

audit all Data Provenance actions record, destroy and query using a varying set of filters; date time, URI, Data Provenance action, etc.

Query appropriate Data Provenance information based on the resource URI.

3) Rules (policy) accessing the correct Data Provenance information for querying or determining a Quality Aggregate.

Data Provenance Policy Governance

The three actions, record, delete and query, for Data Provenance will be governed by policy.

Data Provenance Immutable Log

All Data Provenance actions will be logged such that the queries, modifications, creations, deletions, etc. can be audited and associated with the What event.

Query Data Provenance Information

Data Provenance information can be queried based on policy.

Data Provenance Genealogy

Data Provenance Genealogy, is the use of Data Provenance information to trace the genealogy of information as it is combined with other information to create a new information resource.

FIG. 50 shows resource database C 5050 being created on June 17^{th} on a time line 5002. It consists of information from database A 5010 and B 5030. Database resource A 5010 was last modified on Jun. 10, 2008 whereas database resource B 5030 was created on Feb. 4, 2005 and not updated since.

The Quality for database resource C 5050 is a simple aggregate algorithm taking the average of the Quality ratings for A 5010 and B 5020 (10+8/2). The Genealogy concept for database resource C 5050 shows it consists of two other resources, cdps.biz.org\dp\dbA, the source for database A 5010, and cdps.biz.org\dp\dbB, the source for database B 5030.

FIG. 50 shows a 2^{nd} generation of a combination of resources A and B. Resource C can be used to create another resource, say D. D's genealogy will only point back to C as C's genealogy points back to A and B.

When using multi-generational Data Provenance, discretion must be used to understand how the information from previous generations is used in subsequent generations. The ontology and policy must be used to control the Genealogy concept to ensure the generational information is to be used.

Data Provenance Archive

Data Provenance Archive removes information from a “transactional data provenance store” to a “historical data provenance store”. This will prevent the archived information from being accessed by transactional based events. The archived data provenance information will require access by the auditor.

Data Provenance Source

Data Provenance information can be accessed through data contained within a message (event). However, there will be occurrences when this is not achievable. For instance, in another example, the database resource B is never accessed via CCA. Its data provenance information will require its information to be stored in the Data Provenance information via a mechanism, for instance defined in the Data Provenance Access control below.

Data Provenance Access Control

The controlling mechanism for Data Provenance is CCA Data Provenance Service, CDPS. The CCA Application Service must not be able to directly control the actions taken by CDPS in cleating, updating, or deleting Data Provenance information. In another example, this is required to keep the (polity of Data Provenance information high and secure from application tampering).

In one embodiment, the present invention provides continuous over-the-horizon systemic situation awareness to members of complex financial networks or any other dynamic business ecosystem. In one specific embodiment, the present invention is based on semantic technologies relating to complex interdependent risks affecting network of entities and relationships to expose risks and externalities that may not be anticipated, but must be detected and managed to exploit opportunity, minimize damage, and strengthen the system. The present invention may be applied to a policy that is typically described as a deliberate plan of action to guide decisions and achieve rational outcome(s). In one example, policies may vary widely according to the organization and the context in which they are made. Broadly, policies are typically instituted in order to avoid some negative effect that has been noticed in the organization, or to seek some positive benefit. However policies frequently have side effects or unintended consequences. The present invention applies to these polices including participant roles, privileges, obligations, etc.

In another embodiment, the present invention is used to map these requirements across the web of entities and relationships. In one example, not everyone can see everything, but everyone can see everything they and their counterparties, for instance, agree they need to see; or that regulators deem is required. Transparency is enhanced and complexity is reduced when everyone gets to see what is actually happening across their network as it grows, shrinks, and evolves over time.

In another embodiment, the present invention relates to data provenance. In one aspect, data provenance refers to the history of data including its origin, key events that occur over the course of its lifecycle, and other traceability related information associated with its creation, processing, and archiving. This includes concepts such as:

What (sequence of resource lifetime events).

Who generated the event (person/organization).

Where the event came from (location).

How the event transformed the resource, the assumptions made in generating it, and the processes used to modify it.

When the event occurred (started/ended), Quality measure(s) (used as a general quality assessment to assist in assessing this information within the policy governance). Genealogy (defines sources used to create a resource).

In another embodiment, the data quality of the data provenance can be used via policy to estimate data quality and data reliability based on the (Who, Where) source of the information and the process (What, How) used to transform the information. In yet another embodiment, the audit trail of the data provenance can be used to trace the audit trail of data, and determine resource usage, who has accessed information. The audit trail can be used when establishing patents, or tracing intellectual property for business or legal reasons. In yet another embodiment, the attribution of the data provenance can be applied: pedigree can establish the copyright and ownership of data, enable its citation, and determine liability in the case of erroneous use of data. In yet another embodiment, the informational of the data provenance can be applied: a generic use of data provenance lineage is to query based on lineage metadata for data discovery. It can be browsed to provide a context to interpret data.

In another embodiment, the present invention can be applied as a means of assessing relative effectiveness of alternate policies intended to produce or influence specific behaviors in objects such as:

Policies Includes Data and Information Products Events;

Including Transactions, Processes;

Including Business Processes, Persons;

Individual or Corporate, States of Affairs Enables;

In a further embodiment, the present invention applies to semantic technologies capabilities such as sense, discover, recognize, extract information, encode metadata. As such, the present invention builds in flexibility and adaptability—such as easy to add, subtract, and change components because changes impact the ontology layer, with far less coding involved. Encode meanings and relationships separately from data and content files and application code. In another embodiment, the present invention can organize meanings using taxonomies and ontologies; reason via associations, logic, constraints, rules, conditions and axioms. In yet another embodiment, the present invention uses ontologies instead of a database.

Suitable examples of application of the present invention may include, but are not limited to, one or more of the following: as an intelligent search “index”, as a classification system, to hold business rules, to integrate DB with disparate schemas, to drive dynamic & personalized user interface, to mediate between different systems, as a metadata registry, formal representation of how to represent concepts of business and interrelationship in ways to facilitate machine reasoning and inference, logically maps information sources and describes interaction of data, processes, rules and messages across systems.

### Example

The following is an illustrative example of the present invention in the application where an enterprise and individuals needs the capacity to measure precisely the risks associated with all sorts of assets (physical and financial) as they move, evolve and change hands, like geospatial data or financial data. As such, the enterprise must keep track, secure and price assets adequately and continuously over time. This example is shown to demonstrate how the present invention can be applied to solve “real world” problems and is not meant to limit the present invention.

In one embodiment, the present invention can be used to create an independently repeatable model and corresponding systems technology capable of recreating the risk characteristics of any assets at any time. This example is also shown in the accompanying Figures.

In another embodiment, the present invention employs variables that are independent of the actual data and are support independent indexing and searching. For example, s further shown by the corresponding Figures, the present invention can codify policies into four categories. A—Actors (of humans, machines, events, etc.). B—Behaviors. C—Conditions. D—(Degrees) Measures (measurable results).

In yet another embodiment, illustrated by the accompanying Figures, the present invention relates to resource oriented architecture. Resource is an abstract entity that represents information. Resources may reside in an address space: {scheme}: {scheme-dependent-address}, where scheme-names can include http, file, ftp, etc. In one example, requests are usually stateless. Logical requests for information are isolated from physical implementation.

### Example

### Liquid Trust

The following is an example of the present invention in the application of a mortgage backed securities (“MBS”). The present invention produces a “liquid trust” (“LT”)—these are synthetic derivative instruments constructed from data about “real” MBS that currently exist on an individual bank's balance sheet or on several banks' balance sheets. The present invention applies expert perspectives of MBS SME that are captured in LT Perspectacles to define the specific data attributes to use to define the LT MBS. Each LT SME's Perspectacles is that SME's personal IP. The present invention tracks that IP and the business processes associated with it across all subsequent generations of derivative MBS and other instruments that use or reference that SME's original Perspectacles.

In one specific example, the present invention can assure Steve Thomas, Bloxom, ABANA and Heshem, Unicorn Bank, other Islamic and US/UK banks, Cisco, as well other Participant Observers and Tier I contributors that their IP contributions will be referenced bat ALL subsequent PC/LT Debt Default derivative instrument trading, auditing, accounting, regulatory applications.

All the SME/PO. And other original contributors get fractional basis point participation in all trades of the resulting LT MBS

They also get fractional basis point participation in all the regulatory, IP, and trade process policy audit transaction fees.

In another example, the banks that own the original MBS would provide the data needed to create the LT derivative MBS because the present invention can do this without compromising or revealing the names of the banks whose inventory of scrap MBS the present invention is using to forge new LT True Performance MBSs from. This means that they are shielded from negative valuation fallout from anyone knowing how much scrap they have on their sheets. This means that they are put in an excellent position to benefit as their balance sheets are improved by fees from trade and audit transactions on the LT derivative MBSMeans they will have strong incentive to KEEP the real MBS on their balance sheet (thus ending that on-off balance sheet problem once and for all). This means USG Regulators can audit improvements of bank balance sheets, without compromising knowledge of how much ‘real’ MBBS inventory any given bank has.

As a result, the trades of the synthetic LY MBS reduces uncertainty about the value of the underlying real MBS by providing a continuously auditable basis for tracking the quality of the risk and value of the underlying MBS (via the data attributes we continuously monitor and audit). This continuous audit of the quality of the data that the present invention uses to define the synthetic LT MBS provides a solid and continuously and independently verifiable basis for evaluating risk, value and quality of both the real and the LT derivative MBS. It also can generate several tiers of date quality audit transaction fees. In addition, it can also achieve one or more of the following: a) same for risk assessment business process integrity audit transition fees; b) same for third party validation/verification fees; c) same of regulatory audit fees.

In a further embodiment, the banks will get paid fractional basis points of the value of each LT derivative MBS that is derived from a real MBS that is on their balance sheets and thus, can directly improves that balance sheet. In addition, it can also achieve one or more of the following: a) the banks make a fractional basis point fee on each trade and each audit related to each trade; b) the banks make fractional basis point fees from the ongoing management, regulatory compliance audits associated with managing the funds and the LTMBS trades; c) the banks will often be owned in large part by one or more Sovereign Wealth funds that have an interest in seeing the toxic MBS converted to valuable raw material for the ongoing construction of new, high performance LT derivative MBSs.

In a further embodiment, the present invention creates an Index based on the price, value, spreads and other attributes of the LiquidTrust MBSs and various attributes related to the ‘real’ MBSs. As such, the present invention can create ‘funds’ made up of LT synthetic MBS that share various geographic, risk profile, religious, ethnic, or other characteristics. (if we wanted to we could have funds with named beneficiaries (a public school district, a local church/synagogue/mosque, a retirement fund, etc. . . . ). In yet another embodiment, the present invention develops several template risk management investment strategies. One template example shows how the present invention can use the DM-ROM to establish a specific path to a specific objective that our risk management investments are intended achieve. This reinforces that all investments are risk management investments of one type or another and, if viewed that way, can benefit from our approach.

In yet another embodiment, the present invention can define milestones along the “path”: some are time and process drive milestones; and/or others are event driven. As these milestones are reached, the present invention can manually and automatically review and reevaluate the next phase of investment. This is designed in part to show the value of continuous evaluation of the quality of the data that underpin the risk assessment effectiveness and the effectiveness and efficiency of the risk management investments (which are actualized risk management policies). In one example, the present invention can: show how an alert can be sent to various policy and investment stakeholders as investment strategy reevaluation milestones are reached; show how they can be automatically evaluated and various alternative next phase strategies triggered depending on changes in data quality underpinning risk assessments, deteriorating value of the derivative, increased quality of the data that shows the value of the derivative is actually worse that originally thought, better than originally thought, etc. The point is that the present invention can anticipate all sorts of potential states of affairs and the continuous situation awareness monitoring capability of Liquid.

In yet another embodiment, the present invention can highlight the value PC's continuous data quality assurance brings to Real Options, and all other models, including the Impact data default risk model. PC's risk assessment continuously tests the data quality against dynamically changing metrics defined by stakeholders and the present invention can continuously test the effectiveness of the assumptions of the models.

In a further embodiment, the present invention can tranche the risk of the LT MBS based on Impact data risk assessments (e.g. also audited and generate fees for all stakeholders). Trades are made on the LT MBS—they will be long and short. CDS are constructed to hedge the LY MBS Trade positions. The banks can set up the ETFs to trade the LT derivative MBS and the CDS associated with each trade.

Turning now to FIG. 1 there is illustrated by way of example a chart representative of a form of data provenance. The data provenance process 100 as illustrated in the chart of FIG. 1 can serve to produce a “What:Derivative” 102 which may then be stored as a derived data set 114 in a derived dataset database. The “What:Derivative” 102 may be formed of many inputs, including a “when” input 104, which may indicate, as an example, a time period during which input to the data provenance process 100 occurred, e.g., between 05:00 and 0800 on Jun. 26, 2008, an “ocurredAt” input. The “What:Derivative” 102 may also heve a “Where” input 110, which may include, as an example, a “happensin” physical location, e.g., as illustrated Crant Research Center, Gallup, N. Mex. This input may have a “ratedAs” rating input 112, e.g., an aggregate quality of 6.5. The “What:Derivative” 102 may also have a “WHO” input 120, e.g., identifying an individual “Ray Milano,” which may indicate that the individual “is InvolvedIn” the performance of the particular data provenance occurrence. In addition, the “What: Derivative” may have a HOW″ input 122 that is a “leadsTo” input such as the occurrence of an SQL ETL process. The HOW″ input may in turn have a “has input” input from at least one data source, such as, data source 1, 130, and data source 2, 140. The data source 1, 130 may have an “on BehalfOf” input from a WHAT resource 132, indicating that the input has been created and also passing on quality information, e.g., “ratedAs” information 134, such as, a quality static rating of 5. The data source 2, 140 may have an “on BehalfOf” input from a WHAT resource 142, indicating that the input has been created and also passing on quality information, e.g., “ratedAs” information 144, such as, a quality static rating of 8, which, averaged together with the rating of box 134, may result in the aggregate rating of 6.5 in box 112.

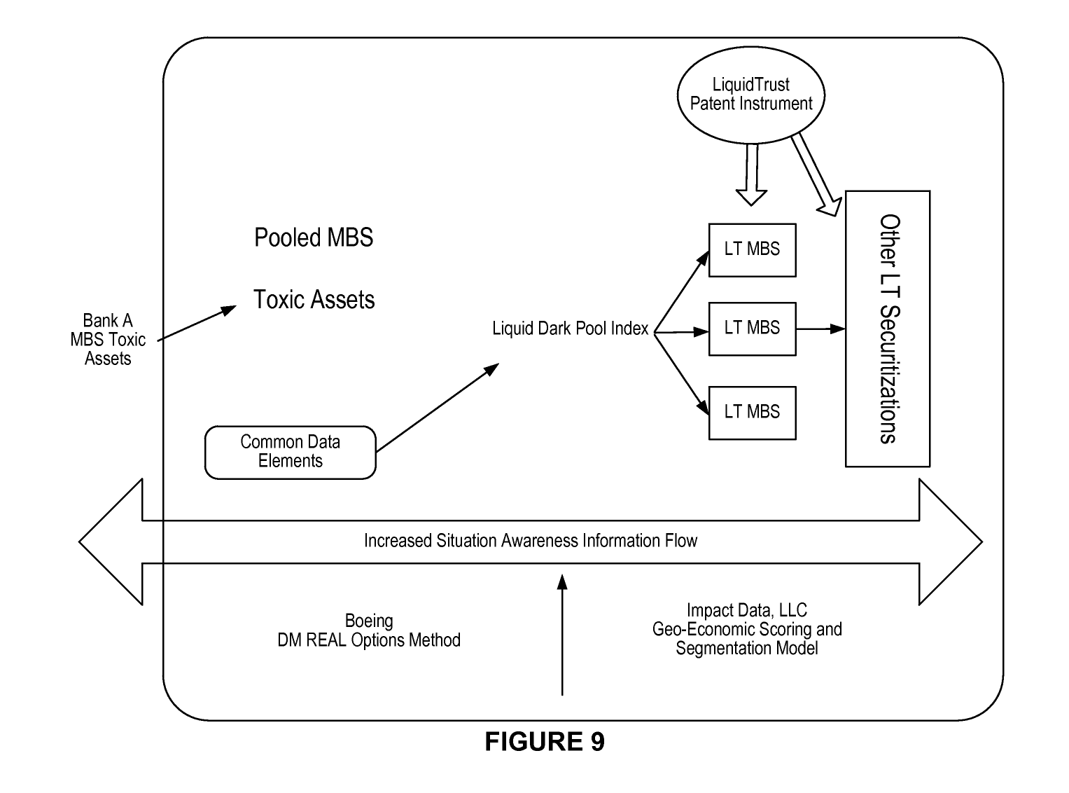

In FIG. 9 there is illustrated graphically a method 900 for creating liquid trust (“LT”) securitizations 910 according to aspects of the presently disclosed and claimed subject matter. The method 900 may include creating a liquid dark pool index 920 which may list, as an example, liquid trust mortgage backed securities (“LT MBSs”) 922, 924 and 926, which may be converted into the LT securitizations 910. The method 900 may utilize pooled MBSs 930, such as from a bank 940 having MBS toxic assets 950. These may be provided to the liquid dark pool index 920 as common data elements 960. The method 900 may further employ a bi-directions1 increases situation awareness information from the banks through the other LT securitizations and back in the opposite direction, and may include input information such as from a so-called Boeing DM REAL options method, as is know in the art as the Datar-Mathews, method for real options valuation, disclosed at http://en.wikipedia.org/wiki/Datar%E2%80%93 Mathews method for real option valuation, or in Mathews, et al., “A Practical Method for Valuing Real Options: The Boeing Approach,” Journal of Applied Corporate Finance, Volume 19, Issue 2, pages 95-104, Spring 2007, each of which is incorporated herein in its entirety by reference. As is well known in the art the DM REAL options method is a method for real options valuation. The DM REAL method can provide an easy way to determine the real option value of a project by using the average of positive outcomes for the project. The DM REAL method can be understood as an extension of the net present value (“NPV”) valuation multi-scenario Monte Carlo model with an adjustment for risk-aversion and economic decision-making. The method can, e.g., use information that arises naturally in a standard discounted cash flow (“DCF”), or NPV, project financial valuation.

Another input could be, e.g., a debt collection scoring and segmentation model, such as the Impact Data, LLC, Geo-Economic Scoring and Segmentation Model, to determine a propensity for the debt to perform. As is known in the art the Impact Data method provides a method to measure credit-worthiness with lower risk whereby credit grantors can best manage that risk by relying on informed and reliable data. As compared to, e.g., data in the form of a credit bureau score, usually containing a large amount of information that is outdated or incorrect, which increases the amount of risk a credit grantor is taking, the Impact Data's geo-economic scoring and segmentation model can help take that risk out of credit granting decisions by determining which debtors have a higher propensity to perform. See, http://www.impactdata.com/solutions/credit-grantor/ and Transforming Profitability through Data Intelligence, http://www.impactdata.com/ transforming-profitability-through-data-intelligence/ each of which is incorporated herein by reference in its entirety.

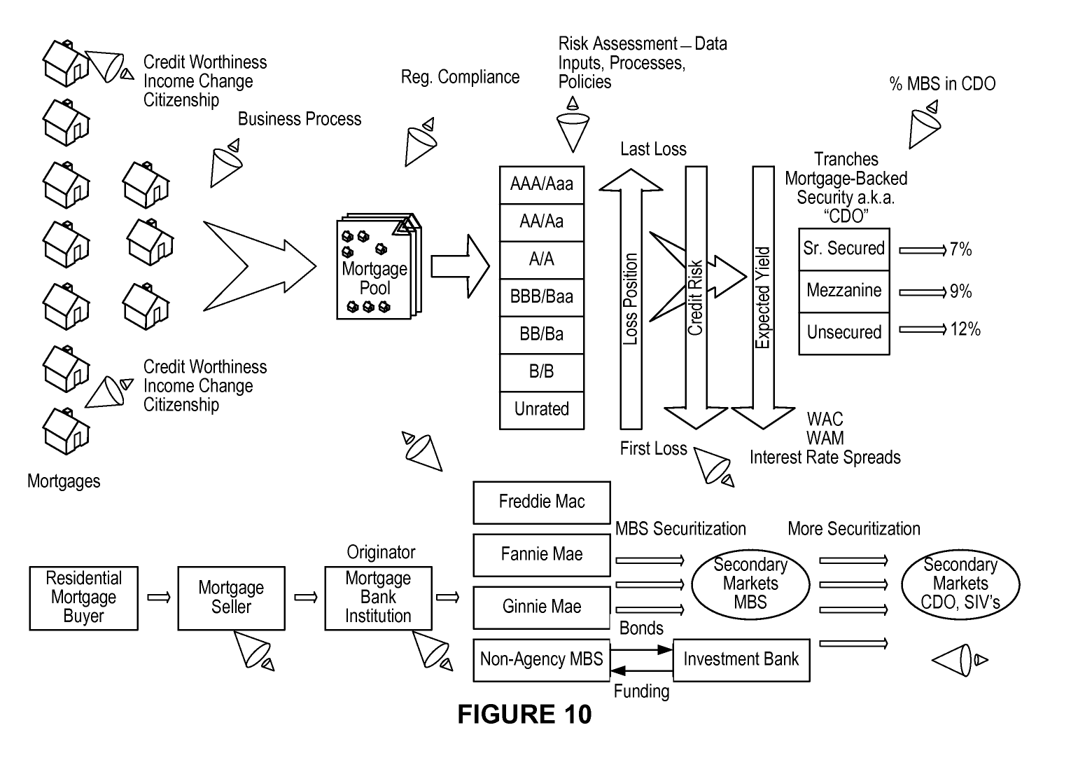

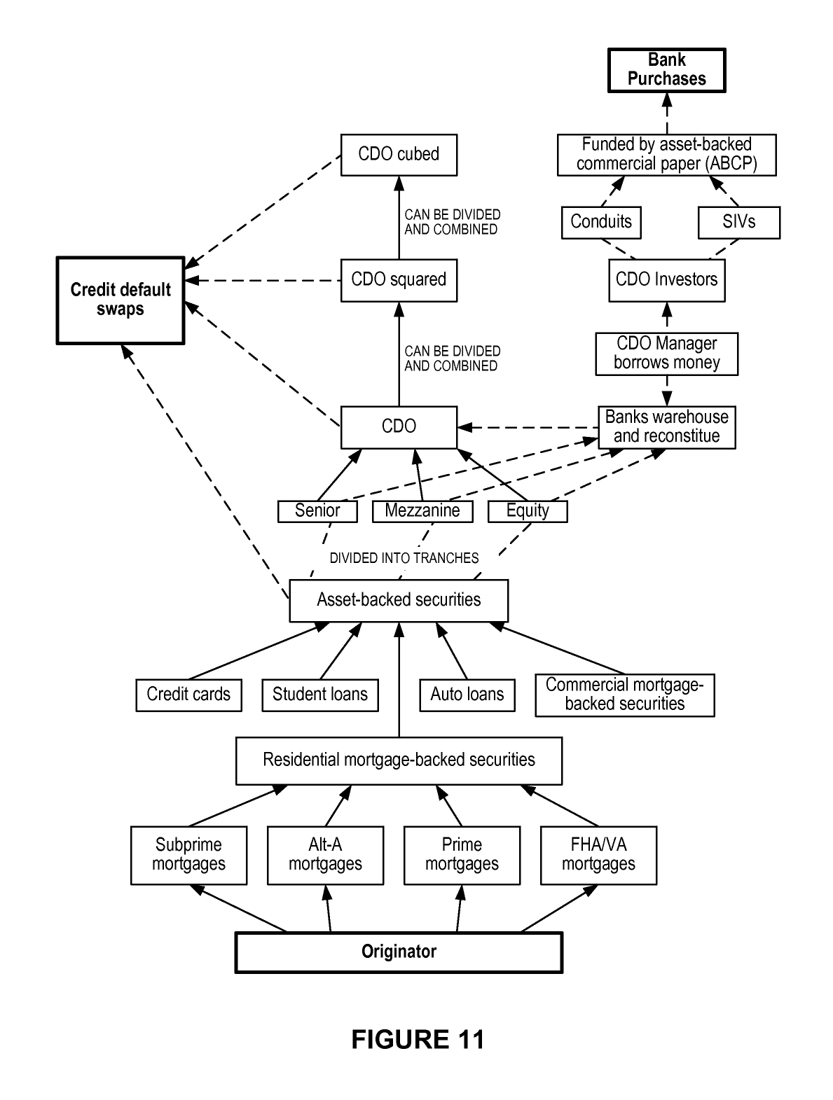

FIG. 10 illustrates an example of formation of collateralized debt obligations (“CDOs”) from, e.g., residential mortgage backed securities (“RMBSs”). As is well known in the art Collateralized debt obligations are a type of structured asset-backed security (“ABS”) which may be offered in multiple “tranches” that are issued by special purpose entities and collateralized by debt obligations including, e.g., bonds and loans, such as residential mortgages. Each tranche can offer a varying degree of risk and return so as to meet investor demand. CDOs value and payments can be derived from a portfolio of fixed-income underlying assets. CDO securities, when split into different risk classes, or tranches, may have “senior” tranches are considered the safest securities. Interest and principal payments may be made in the order of seniority, so that junior tranches offer higher coupon payments (and interest rates) or lower prices, e.g., to compensate for additional default risk. See, http://en.wikipedia. org/wiki/Collateralized_debt_obligation which is incorporated herein by reverence in its entirety.

FIG. 10 shows a system and method 1000 in chart and block diagram form for creating and distributing CDOs. The system starts with asset backed securities 1010, such as mortgage back securities on mortgages 1010 on homes 1020. The asset backed securities may be analyzed through the imaginary lenses 1022 for credit worthiness of the borrower as related, e.g., to the value of the home 1020 and the amount of the loan, income of the borrower and how that may change over time, citizenship of the borrower, and other similar criteria. These mortgages 1010 may be grouped into a mortgage pool 1024, the process for doing so being examined, e.g., through the imaginary lens 1026 of a defined business process and the pool itself 1024 may also be examined through the imaginary lens 1028 of regulatory compliance determinations. This process may involve starting with a mortgage buyer 1026 and a mortgage seller (bank or other financial institution) 1030, also examined through an imaginary lens 1032 for business process and regulatory compliance determinations. The mortgage may then be transferred to an originator, such as a mortgage bank institution 1034, also similarly examined through an imaginary lens 1036.

These mortgages, such as in the pool 1024 may be securitized by MBS creators 1040, e.g., pseudo-governmental entities such as Freddie MAC 1042 and Fannie Mae 1044 or Ginnie Mae 1046, or other “non-agency” MBS creators 1048, who may obtain funding from such as an investment bank 1070 in return for, e.g., bonds secured by the MBSs. This process may result in creating secondary markets 1060 for the MBSs and be monitored through the imaginary lens 1062 as was the case with similar monitoring noted above. The created securities may be given ratings 1050, depending at least in part on the mortgages 1010 in the pool 1024. These may involve loss position 1052 from first loss to last loss, credit risk 1054 and expected yield 1056. This process may also be monitored through the illustrated imaginary lens 1058. The CDOs, e.g., MBSs, also referred to as “derivatives” may be sold in tranches 1090, such as senior secured 1096, mezzanine 1094 and unsecured 1092, which may have increasing expected returns, but decreasing levels of security in the secured interests. This process may be monitored through the imaginary lens 1098 of, e.g., the percentage of MBSs in a CDO. Secondary markets in CDOs 1080 may also be created for the CDO and also for so-called structured investment vehicles (“SIVs”), which may be examined, e.g., through the imaginary lens 1082.

Illustrates in chart form, by way of example, a further analysis of the creation of CDOs 1152 and related credit default swaps (“CDSs”) 1102. Originators, such as originator 1104 may create a security, such as a mortgage backed security (“MBS”) 1120 from a plurality of mortgages of varying types, e.g., subprime mortgages 1110, Alt-a mortgages 1112, prime mortgages 1114 and FHA/VA mortgages 1116. These RMBSs may be joined with other bebt incured due to a loan to create asset-backed securities, such as credit card debt 1132, student loans, 1134, automobile loans 1136 and commercial mortgage backed securities 1138. The asset backed securities may then be divided into trenches, such as senior 1142, mezzanine 1144 and equity (unsecured) 1146. These tranches 1142, 1144, 1146 of ABSs 1130 and constitute a CDO or CDOs. These tranches 1142, 1144 and 1146 may be warehoused and reconstituted by, e.g., banks or other financial institutions, as indicated in block 1160, and can in turn be formed into CDOs. The CDOs can be divided and combined to form CDOS squared 1154 and the CDOs squared can be divided and combined to form CDOs cubed 1156.

Each of the levels of ABSs, CDOs, CDO squared and CDO cubed may be the subject of credit default swaps 1102. A CDO manager may borrow money 1162, from a CDO investors 1164 and obtain CDOs from the bank 1060 warehousing or reconstituting trenched ABSs in return for payment of the money and the CDO investors may create conduits or SIVs or the like to create asset backed commercial paper (“ABCPs”) which may in turn be sold to another bank or financial institution.

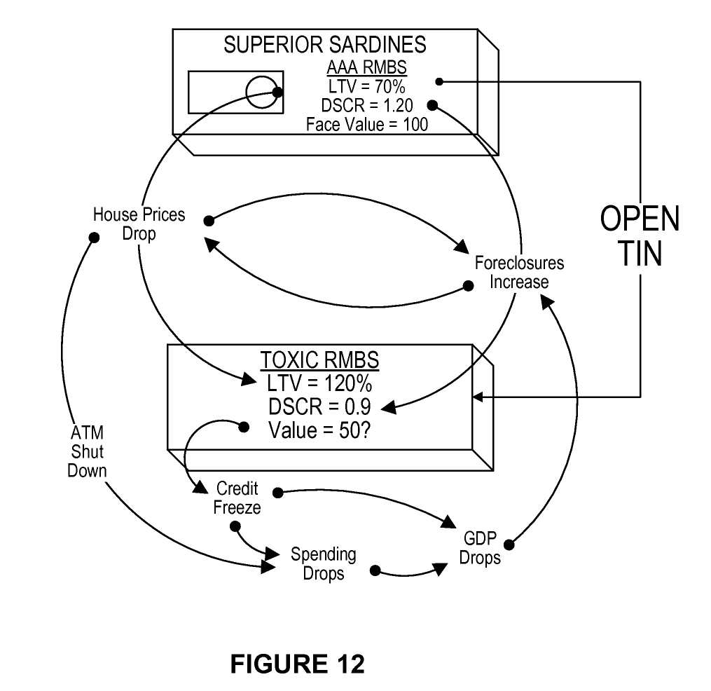

FIG. 12 illustrated in chart form problems that can arise from the process 1200 of creating asset based securities, such as retail mortgage backed securities (“RMBSs”), represented as being packaged in a can of sardines 1202, which when the top 1204 is removed from the can 1202 can reveal toxic RNBSs inside. As an example, the RMBSs as originally placed in the can 1202 or as later assumed to have been originally placed in the can 1204, may have been or have been assumed to be, relatively solid investments, e.g., having as indicated on the label on the top 1204, a loan to value “(LTV”) ratio of 70%, meaning the borrower place 305 down on the value of the home to get the mortgage, a debt service coverage rating of 1.20 and, therefore been assigned originally, or been assumed to have been assigned originally, a “face value” of 100. When the actual contents are revealed some time later in the process, however, it may be found that the RMBSs or many of them are toxic, i.e., they have an actual LTV of 120% and a DSCR of 0.9, meaning that now the face value may only be a fraction of the original or assumed original, e.g., 50%, with even that value in question. This transition in value can cause house prices to drop locally 1232 and foreclosures to increase 1234, which, as shown, can be a self-perpetuating loop. The lenders may experience reduction in available cash 240, credit freezes 1250 and spending dropping 1246, which at the macro-level causes the GDP to drop and this in turn can feed back to cause foreclosure increases and housing prices dropping.

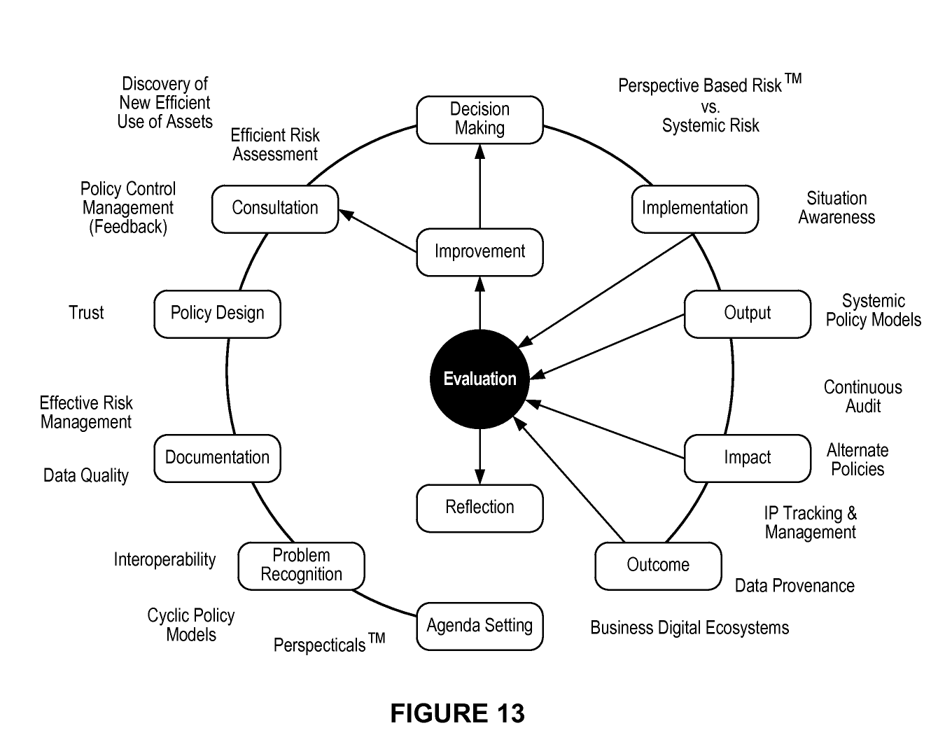

FIG. 13 illustrates in chart and block diagram form a policy management cycle 1300 useful with aspects of embodiments of the disclosed and claimed subject matter. The cycle can have a hub of evaluation 1302 which can feed improvement 1304 which can also feed decision making 1320. Evaluation 1302 can also feed reflection 1306. The cycle 1300 may have a perspective based risk v. system risk side which may include situation awareness, systemic policy models, continuous audit, alternate policies, IP tracking and management, data provenance and business digital ecosystems. This may involve implementation 1330, output 1340, impact 1350 and outcome 1360.

The cycle 1300 may also include an efficient risk assessment side that may include discovery of new efficient uses of assets, policy control management, with feedback, trust, effective risk management, data quality, interoperability and cyclic policy models, which may collectively be referred to as Perspecticals™. The cycle may also contain consultation 1318, policy design 1316, documentation 1314, problem recognition 1312 and agenda setting 1310. The improvement 1304 may provide input to decision making 1320 and consultation 1318. Implementation 1330, output 1340, impact 1350 and outcome 1360 can provide input into evaluation 1302.

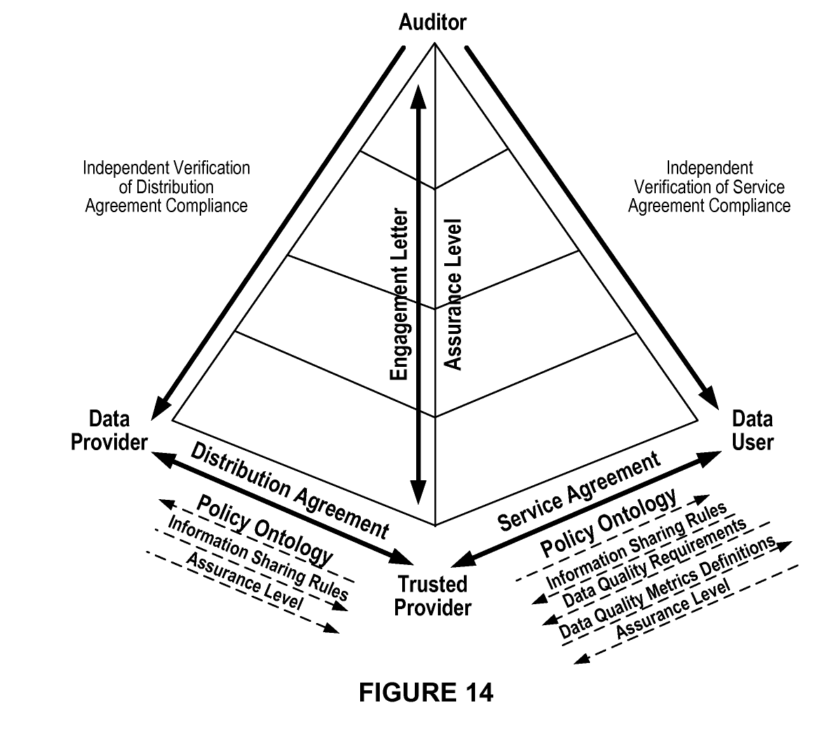

FIG. 14 shown in chart form a process 1400 for defining and using policy sets, e.g., in the context of a legal agreement framework. At the base of the illustrated assessment level pyramid 1460 may be a data provider 1402 and a data user 1404 as well as a trusted provider 1406. The data provider 1402 may be connected to the trusted provider by a distribution agreement 1410. The trusted provider 1406 may be connected to the data user 1404 by a service agreement 1420. The distribution agreement may include a policy ontology 1412, information sharing rules 1414 and an assurance level 1416. The service agreement 1420 may include a policy ontology 1422, information sharing rules 1424, data quality requirements 1426, data quality metrics definitions 1428 and an assurance level 1430. At the top of the assessment level pyramid 1460 may be an auditor 1450 connected to the trusted provider by an engagement agreement 1472. The auditor 1450 may also be connected to the by an agreement 1470 that provides for independent verification of distribution compliance and the data user is connected to the auditor by an agreement 1478 that provides for independent verification of the service agreement compliance.

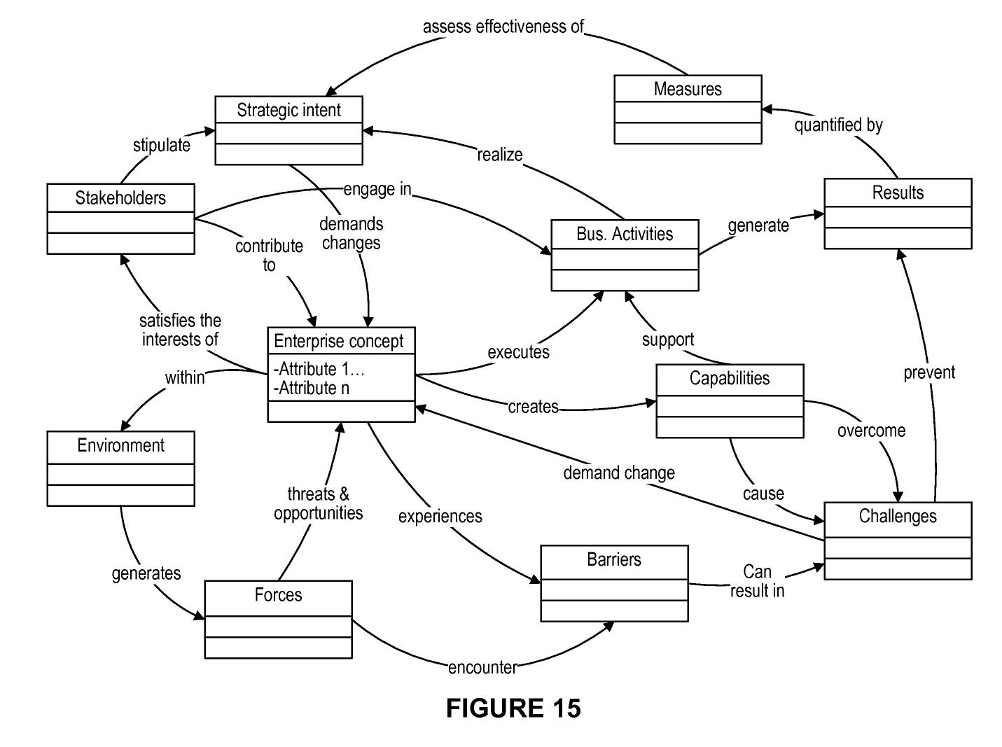

FIG. 15 illustrates an example of a process 1500 for linking of persons, processes, objects and states of affairs within a facet/enterprise concept. An enterprise concept 1502 may have attributes, such as attributes 1−n. The enterprise concept may be linked to a stakeholder(s) 1510 as satisfying an interest(s) of the stakeholder(s) and the stakeholder(s) 1510 may provide input or feedback in the form of contributions to the enterprise concept. 1502 an environment 1512 may be within the enterprise concept 1502 and may generate forces 1540, which may feed back to the enterprise concept 1502 as threats and/or opportunities. The forces 1540 and the enterprise concept may respectively encounter and experience a barrier(s) 1514 that may result in a challenge(s) 1536, which can prevent a result(s) 1534. The challenge(s) may demand a change in the enterprise concept 1502. The enterprise concept may create a capability(ies) 1516 which may either cause or overcome a challenge(s) 1536. The enterprise concept may execute a business activity(ies) 1518, which may receive support from the capability(ies) 1516. The business activity(ies) 1518 may generate a result(s) and/or realize a strategic intent(s) 1530. A result(s) may be qualified by a measure(s), which may be utilized to assess the effectiveness of a strategic intent(s) 1530. The shareholder(s) may engage in a business activity(ies) and may stipulate a strategic intent(s) 1530.

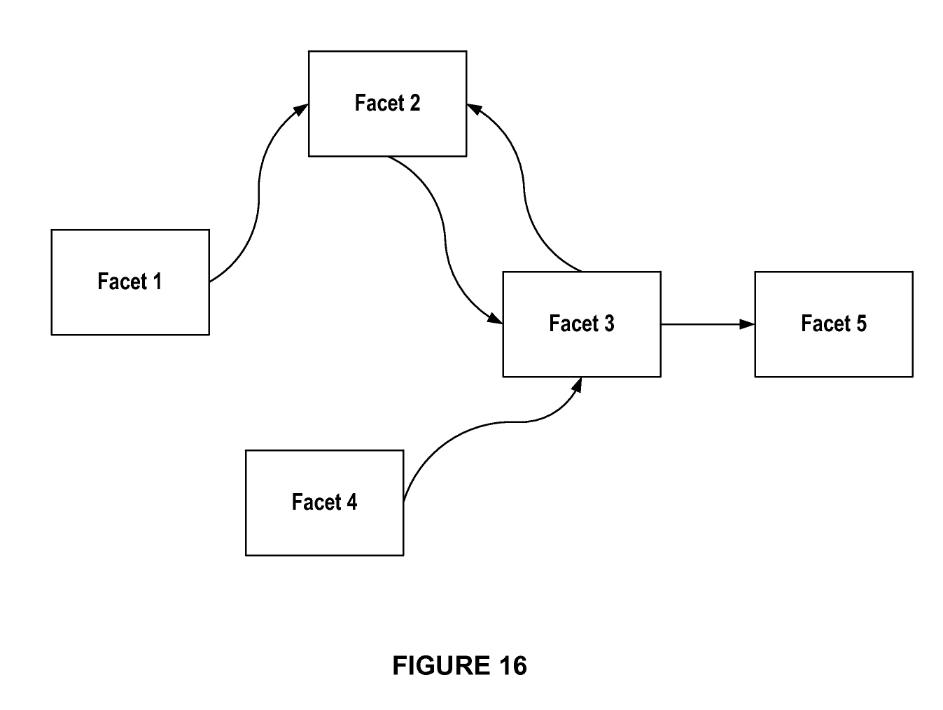

FIG. 16 illustrates in block diagram for a process 1600 for treating business concepts as a cluster of interconnected facets which may be utilized in aspects of embodiments of the disclosed and claimed subject matter. Facet 1 1602 may lead to Facet 2 1604 and to Facet 3 1606, and receive feedback in return from Facet 3 1606. Facet 4 1608 may also provide input into Facet 3 1606 and Facet 3 1606 may provide input into Facet 5 1610.

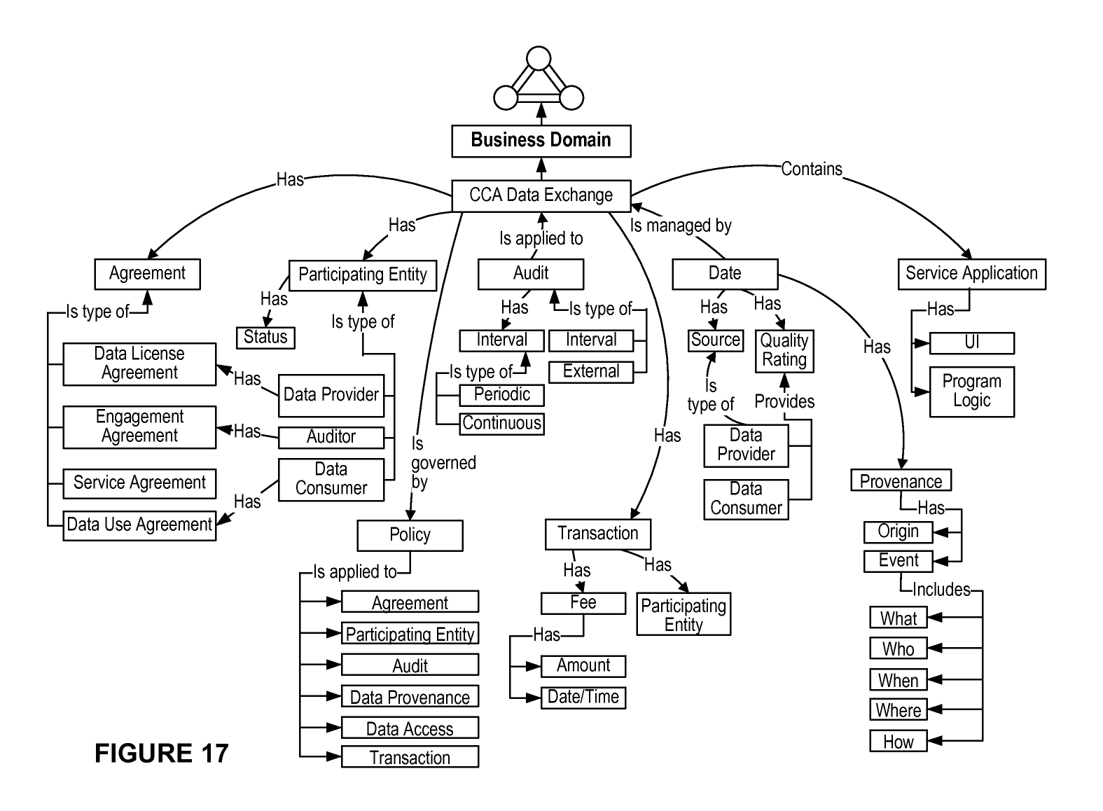

FIG. 17 illustrates in block diagram and chart form a system and method 1700 for trusted data exchange according to aspects of embodiments of the disclosed and claimed subject matter. A business domain 1702, which may be used to form an ontology 1703 may be formed from a continuous compliance assessment (“CCA”) utility function which may help to define some or all of a data provenance system and method, e.g., relating to data exchange, of which utility function 1704 the business domain 1702 may be a form. The utility function 1704 may have an applicable agreement 1710 and a participating entity 1712, and may have an audit 1714 applied to it. The CCA data exchange utility function 1704 may have data 1716 that is managed and may contain a service application 1718. The CCA data exchange utility function 1704 may be governed by policy(ies) 1720 and may have transactions 1740.

The agreement 1710 may be a type of data license agreement 1734, engagement agreement 1736, service agreement 1738 or data use agreement 1766. The participating entity 1712 may be a data provider 1774, an auditor 1776 or a data consumer 1778. The audit may be internal 1790 or external 1792 and may have an interval 1780, which may be periodic 1784 r continuous 1786. The data may have a source 1796, e.g., a data provider 1788 and a quality rating 1798, which may be received from the data provider 1788 or from a data consumer 1789. The data 1716 may also have data provenance, i.e., an origin 1752 and an event 1754, which event 1754 may include what 1756, who 1758, when 1760, where 1762 and how 1764. The service application 1718 may have a user interface 1770 and program logic 1772.

The policy 1720 may be applied to an agreement 1721, a participating entity 1724, an audit 1726, data provenance 1728 data access 1730 and a transaction 1732. The transaction 1740 may have a participating entity(ies) 1744 and a fee 1742, which may have an amount 1746 and a date/time 1748.

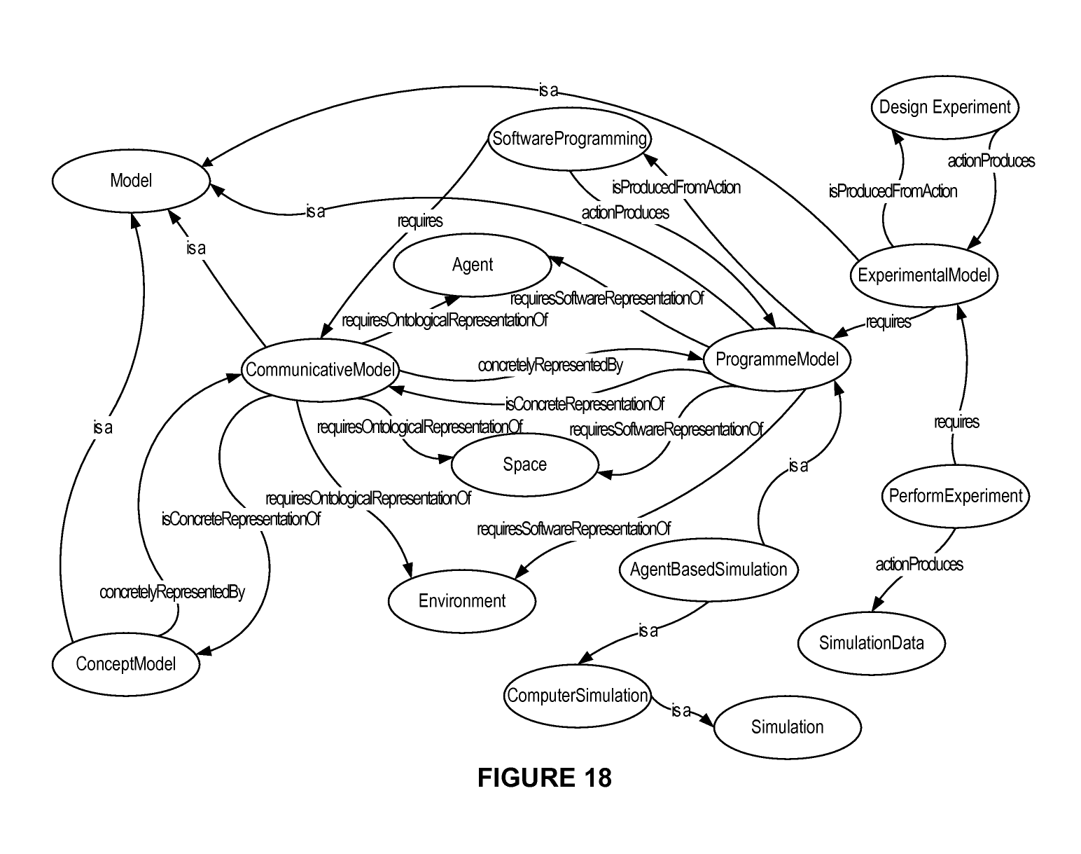

FIG. 18 illustrates in chart and block diagram form a system and method 1800 for providing an agent-based model and simulation core. The system and method 1800 may include a model 1802 and an experimental model 1804, which is a model 1802. The experimental model 1804 may be produced from an action of a design experiment 1806. An experiment 1820 may require the experimental model 1804 and may be an action that produces simulation data 1822. The experimental model 1804 may require a programmed model 1814. The programmed model may be the product of a software programming action 1850. The programmed model 1814 may be the model 1802 and may require a software representation of an agent 1840, a space 1860 and an environment 1870. The system and method 1800 may also have a concept model 1810 and a communicative model 1812. The concept model 1810 may be the model 1802 and may be concretely represented by the communicative model 1812. The communicative model 1812 may require an ontological representation of the agent 1840, the space 1860 and the environment 1870 and may concretely represent the programmed model 1814. A computer simulation 1832 may be a simulation 1890 and an agent based simulation 1830 may be a programmed model 1814 and may be a computer simulation 1832.

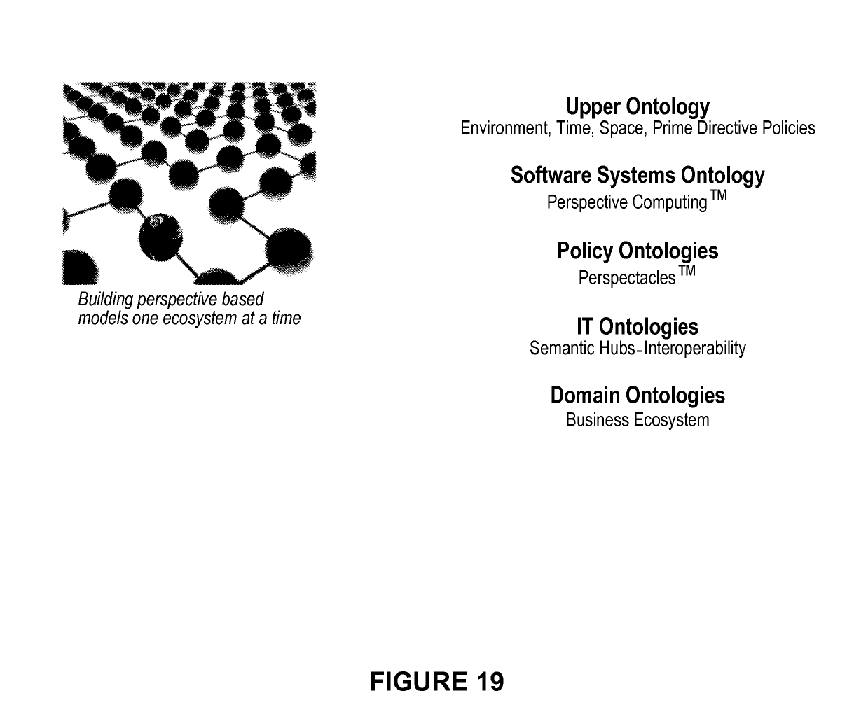

FIG. 19 shows a chart of a method and system 1900 for creating and using Perspectables™ in the form of ontologies of policies and the modeling and simulation of a Perspective Risk™ model. An upper ontology 1910 may include environment, space, time, and prime directive policies. A software systems ontology 1908 may include Perspective Computing™. Policy ontologies 1906 may include Perspectables™. Information technologies (“IT”) ontologies may include semantic hubs used in interoperability. Domain ontologies 1902 may include the business ecosystem.

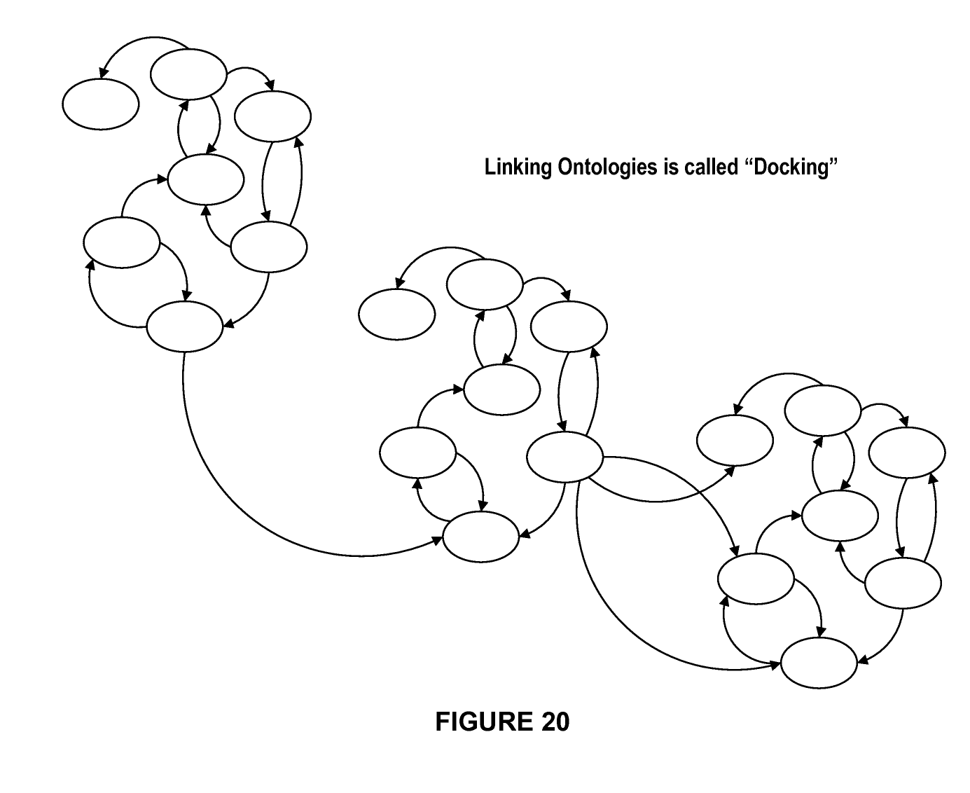

FIG. 20 shows a chart of a system and method 2000 for linking (“docking”) ontologies. A plurality of ontologies 2002, 2004 and 2006, may be constructed of vertices 2010 and vector edges 2020 indicating a direction and strength of a connection between adjacent interconnected vertices 2010. Linking (“docking”) of ontologies 2002, 2004 and 2006 may occur through the linking of a vertex in ontoloty 2002 to a vertex in ontology 2004, e.g., with the edge 2030. Linking of the ontology 2002 with the ontology 2006 may occur by the interconnection of a vertex 2010 in the ontology 2002 with a plurality of vertices 2010 in the ontology 2006, e.g., with the edges 2032, 2034 and 2036 to respective vertices 2010 in ontology 2006.

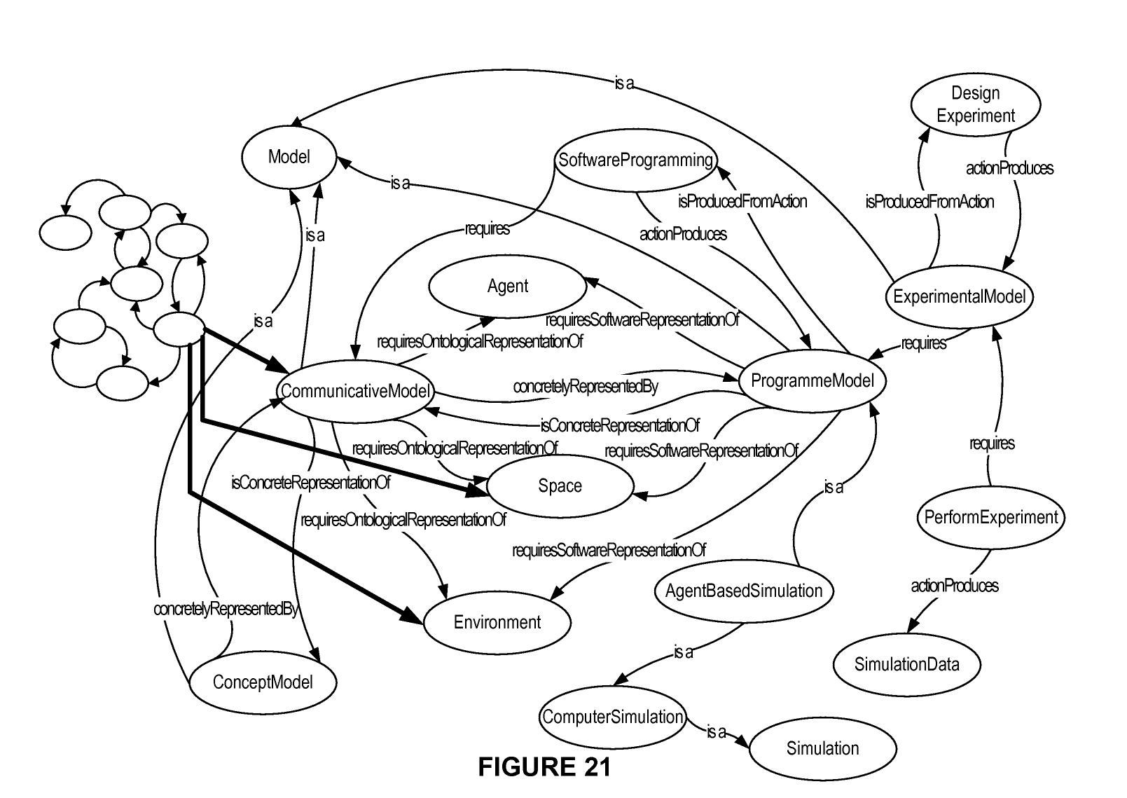

FIG. 21 shows a chart of another method and apparatus for a Perspective Risk™ model simulator, with an agent-based model and simulation core similar to that illustrated in FIG. 18, with similar elements given the same numbers with a prefix of 21 in FIG. 21 as opposed to 18 in FIG. 8. FIG. 21 also shows the model simulator 2100 linked to a shorter hand representation another ontology 2192, e.g., through the connection of a vertex in the ontology 2192 with, respectively the communication model vertex 2112, the space vertex 2160, and the environment vertex 2170, just as is, as an example, the programmed model vertex 2114 in the ontology 2100, and thus the vertex in the ontology 2192 could correspond to a programmed model vertex 2114.

FIG. 23 illustrates, by way of example a graphical representation of a business domain ontology 2300, e.g., of policies that can serve as Perspectables™, as a part of, e.g., a Perspective Risk™ model/simulator. Vertices 2302, which may be formed in groups and/or clusters, may be interconnected by edges 2304.

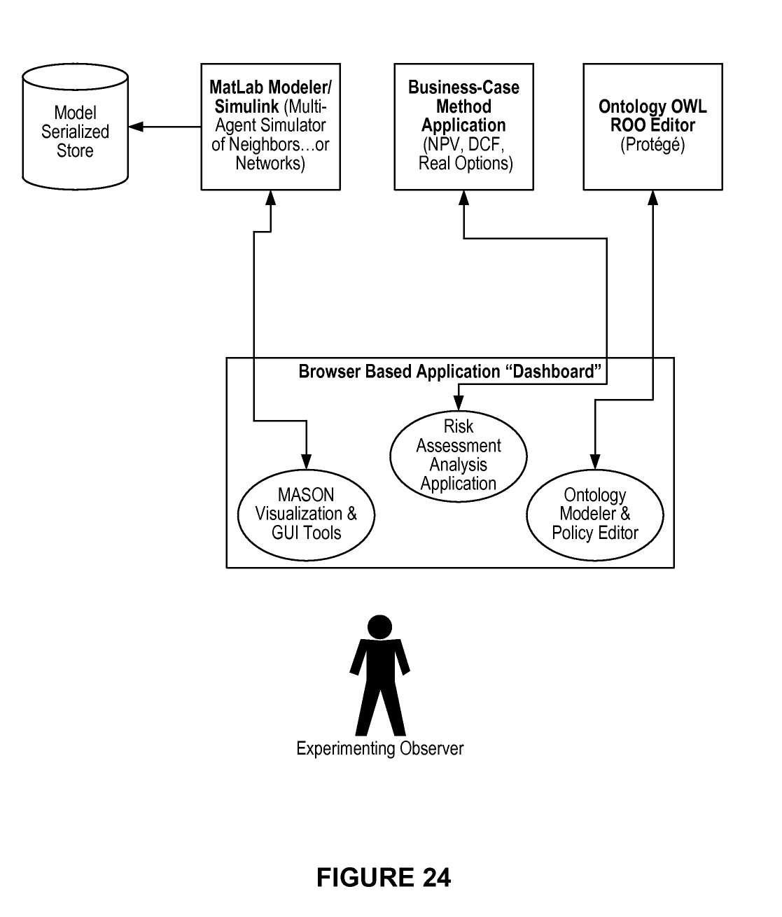

FIG. 24, by way of example, illustrates in chart and block diagram form a Perspectives Computing™ and Perspective Risk™ model and simulation process 2400. The process 2400 can include utilizing by a user, e.g., an experimenting observer 2410, of a browser-based application dashboard 2402. The dashboard 2402,ay include visualization and/or other GUI tools, such as MASON 2402, a display of information relating to the risk assessment and analysis application 2408 and an ontology modeler and editor 2406. The visualization and GUI tools may be supplied from a multi-agent simulator of neighbors or networks, such as, MatLab modeler/Simulink, which may be obtained from a database 2450 containing, e.g., a model serialized store. The risk assessment analysis application 2408 may be supplied from a business case method application, such as for determining net present valus (“NPV”), discounted cash flow (“DCF”) analysis, Real Options analysis, etc. 2430. The ontology modeler and policy editor may be supplied from an ontology editor, such as web ontology language (“OWL”), or an OWL ontology construction tool (“ROO”) or Protégé ontology editor software.

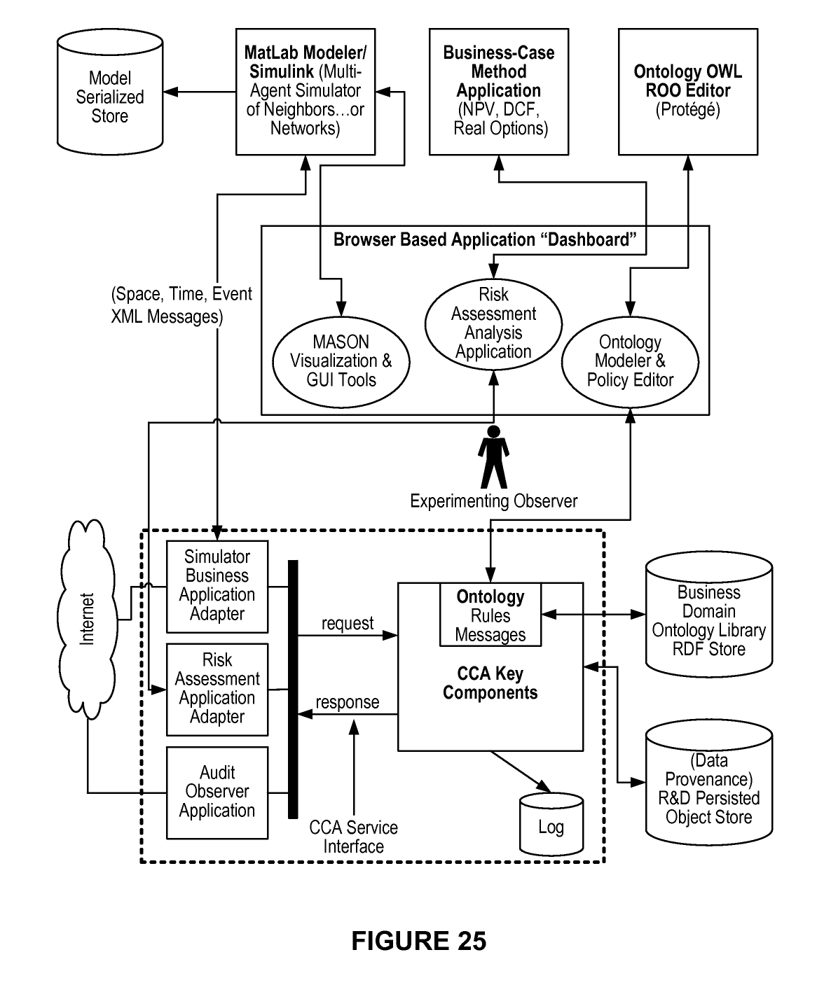

FIG. 25 illustrates in chart and block diagram form, as an example, a system and method 2500 for Perspective Computing™, e.g., utilizing a Perspective Risk™ model and simulation service, according to aspects of the disclosed and claimed subject matter. Then process includes the elements discussed above with respect to FIG. 24, with the same reference numerals, having a prefix of 25 rather than 24. In addition the system and method 2500 includes a continuous compliance assessment (“CCA”) service application 2560, which may include a CCA key component 2652, including ontology rules and messages 2564. The CAA key components 2562 may receive inputs from databases 2566, containing a business domain ontology library RDF storage and/or 2568, containing information relating to data provenance, such as an RoD persisted object storage, may provide as an output a log stored in a database 2570. The CCA service application 2560 may also include a CCA service interface 2570 for providing requests to and/or responses from the CCA key components 2562 from one or more of a simulator business application adapter 2580, a risk assessment application adapter 2582 and an audit observer application 2584. The risk assessment application adapter 2582 may be in contact with the risk assessment analysis application 2508 in the browser based application dashboard 2502. The audit observer application 2584 and simulator business application adapter 2580 may be connected to the Internet 2590. The overall system method 2500 may process space, time and event messages, such as XML messages.

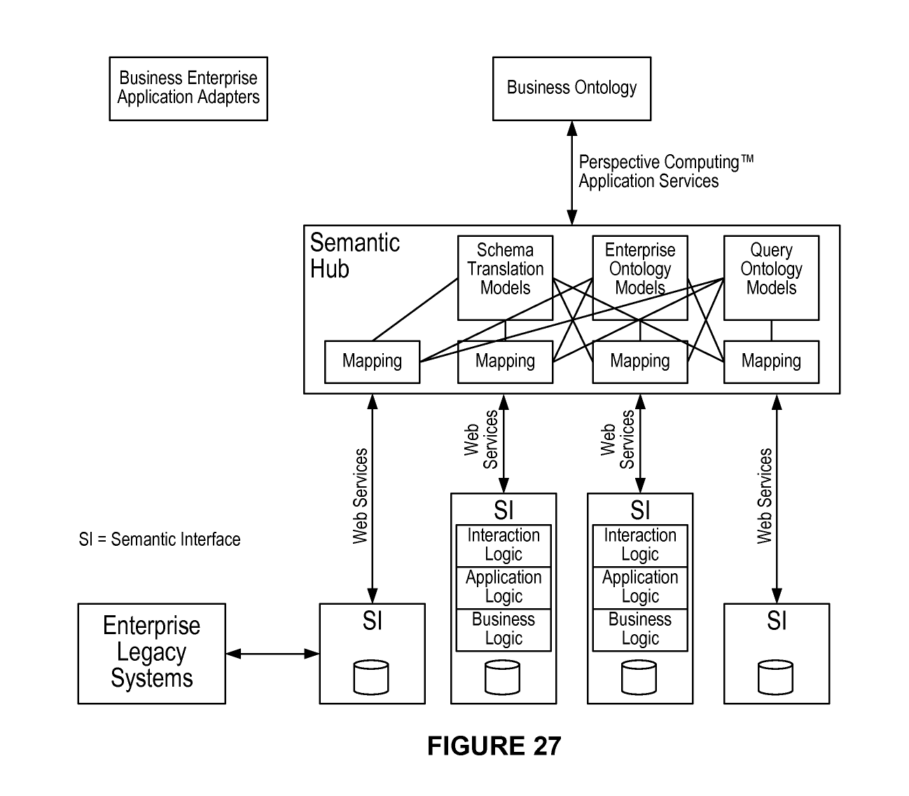

FIG. 27 shows, in chart and block diagram form an example of a system and method 2700 for utilizing business enterprise application adapters 2702 as applied with a business ontology 2704 along with Perspective Computing™ application services 2706. The application services 2706 connect the business ontology 2704 to a semantic hub 2710, in which reside the interconnected schema transaction models 2712, enterprise ontology models 21714, query ontology models 2716, mapping 2720, mapping 2722, mapping 2724 and mapping 2726. The semantic hub 2710 interconnects with a web services database 2734, through mapping module 2720, which database 2734 in turn connects with enterprise legacy systems 2732. The hub 2710 also interconnects with logic web services 2740, through mapping 2722, including interaction logic 2742, application logic 2744 and business logic 2746 along with a logic database 2748. The hub 2710 also interfaces with additional logic 2750 through mapping 2724, containing interaction logic 2752, application logic 2754 and business logic 2756 and a database 2758. The hub 2710 also connects to an additional web services module 2760 having a database 2762, through mapping 2726.

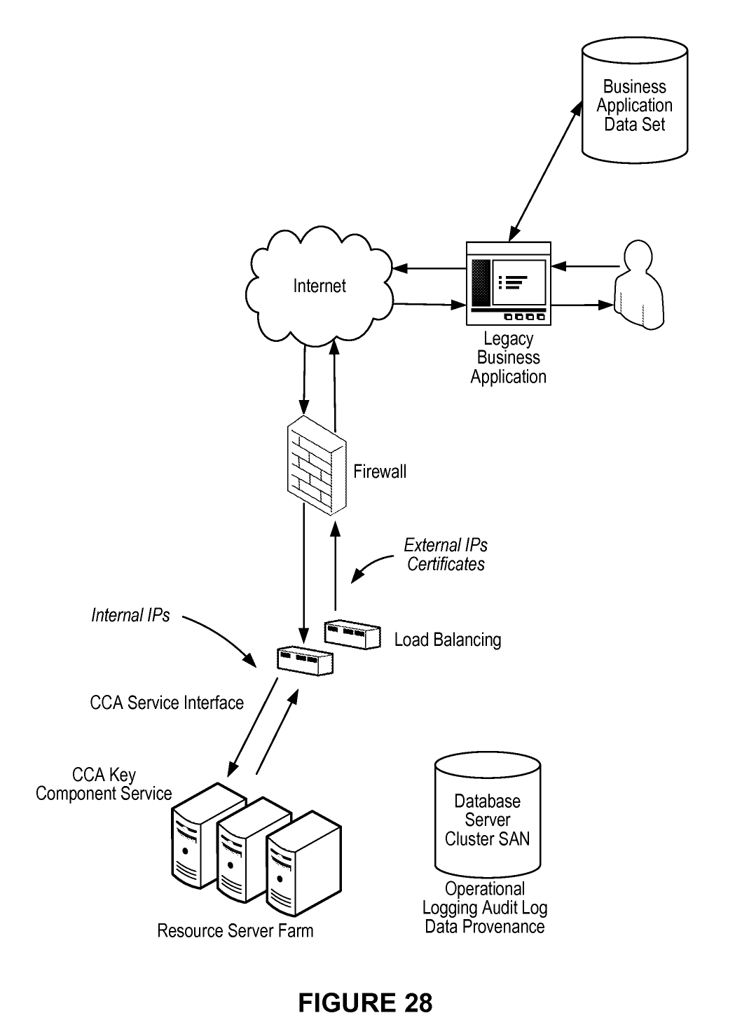

FIG. 28 illustrates in chart and block diagram for, as an example, a system and method 2800 for implementing a physical architecture, e.g., for a legacy application. A small area network (“SAN”) 2802 may include a plurality of networked computers 2806, which may be part of a CCA Key component service 2810 and may be connected to a resource server farm 2804 and to a database 2808 which may serve the SAN server cluster, e.g., including operational logging, audit logging and data provenance. The service 2810 may be connected through a CCA service interface 2820 and through internal Internet protocol load balancing 2830, 2832 and a firewall 2840 to the Internet 2860. Also connected to the internet may be a legacy business application 2870 running on a server 2872 and interfacing with a user 2874 and connected to a business application data set database 2876.

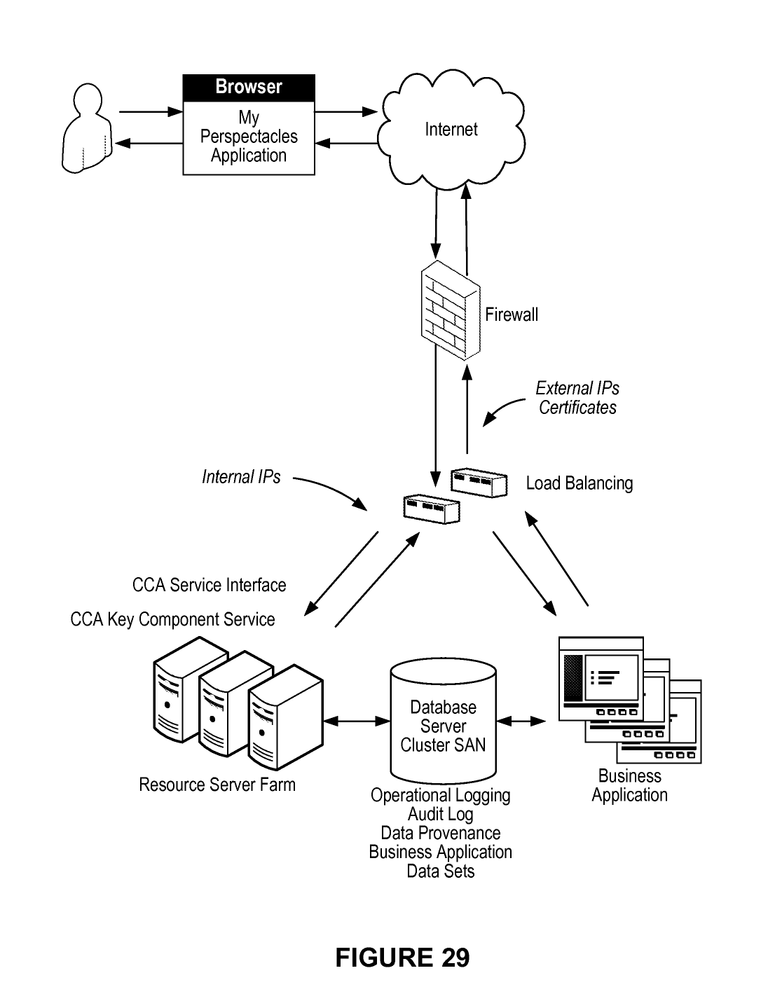

FIG. 29 illustrates as an example, in chart and block diagram form another physical architecture 2900 for a new business application, having some elements in common with FIG. 28 with the prefix of 29 instead of 28. In addition, there is shown in FIG. 29 a business application connected 2910 connected to the SAN database 2908, which in addition may contain business application data sets, and to the load balancing 2930, 2932. Further, in place of the business legacy application server 2872, there may be a user 2974 connected through a browser 2972 to a hosted “My Perspectacles Application” running on the browser 2970.

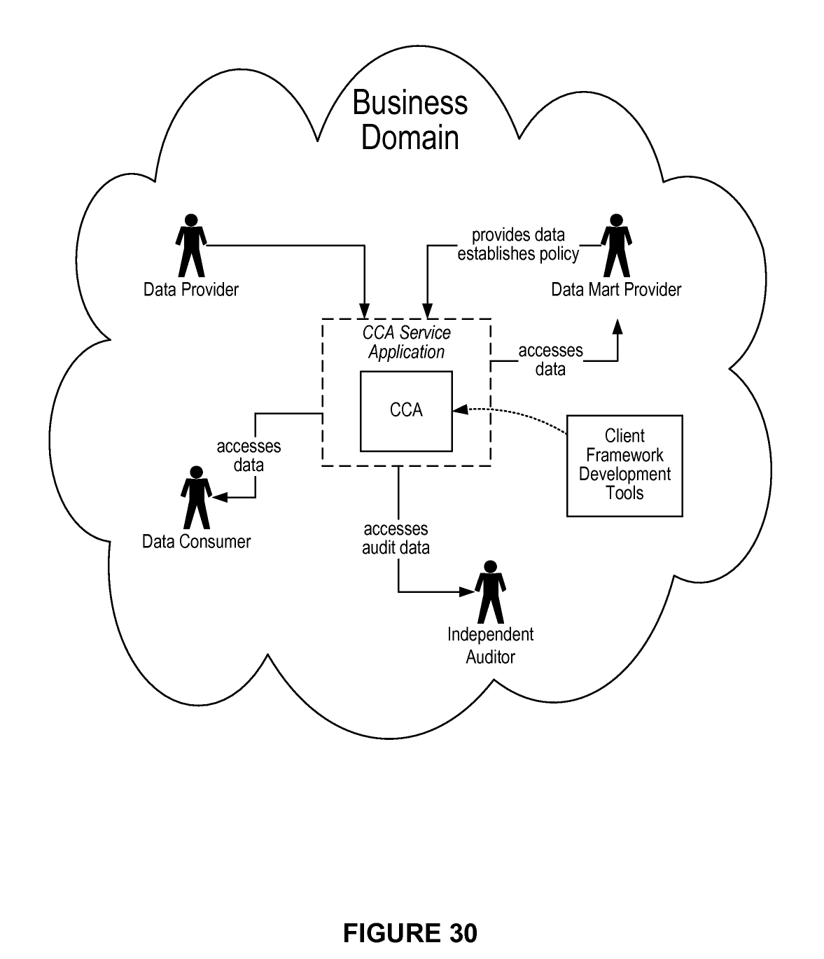

FIG. 30 shows in chart and block diagram form, by way of example, a high-level abstraction of a system and method 3000 for using and implementing a CCA service application 3004, which may include a CCA module 3008 within a business domain 3002. Client framework development tools 3006 may be connected to the CCA module 3008. An independent auditor 3010 may interface with the CCA service application 3004. A data customer 3020 may access data from the CCA service application 3004. A data provider 3030 may provide data to the CCA service application 3004. A data-mart provider 3040 may provide data to and receive data from the CCA service application 3004.

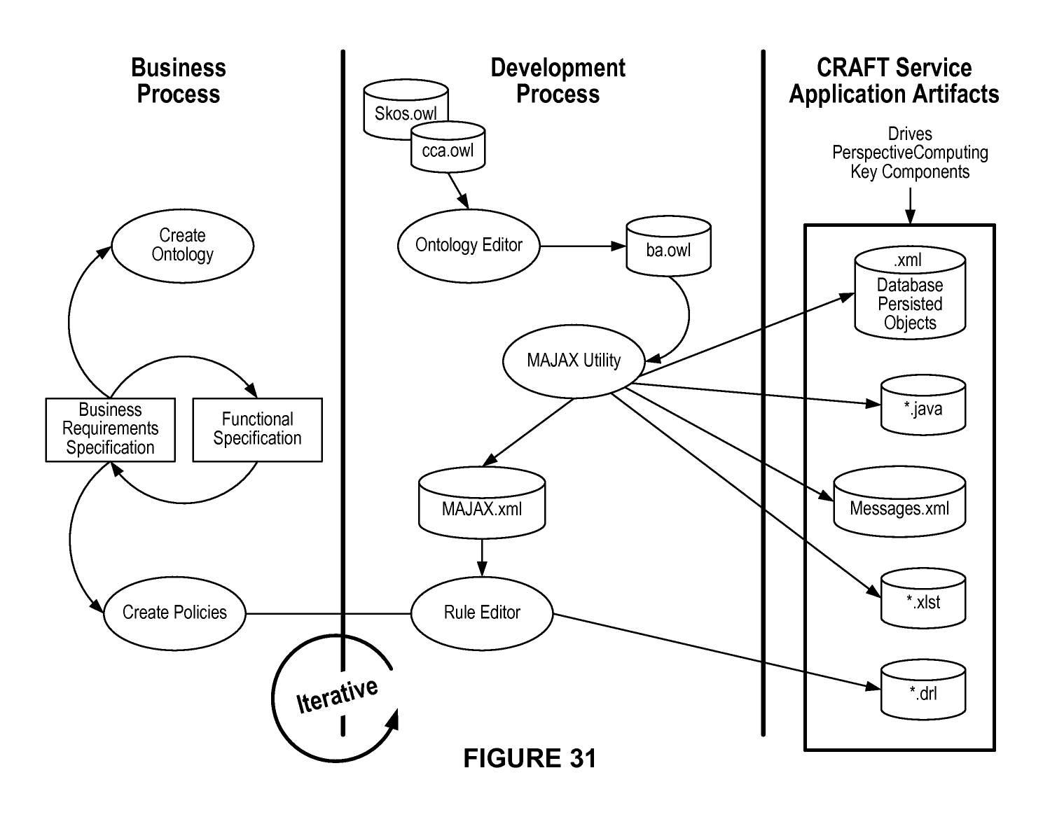

FIG. 31 shows in chart and block diagram form a system and method 3100, by way of example, for developing and using client framework development tools according to aspects of embodiments of the disclosed subject matter. The system and method 3100 may include business processes 3102, which may include a business requirements specification 3110, interconnected to provide input and receive input from a functional specification 3110, and interconnected to provide input to a create policies module 3114, and a create ontology module 3116. The business processes interactively connect to development processes 3104, through the create ontology module 3116 and the create policies module 3114. The development process 3104 may include a MAJAX utility, i.e., as is well known in the art, a Javascript library that provides access to a III Millennium catalog from pages within an organization's domain. In addition the MAJAX utility may be connected to a MAJAX.xml database 3122, which connects to the create policies module 3114 through a rules editor module 3124. The MAJAX utility 3120 may also receive input from a ba.owl database 3126, which may also receive input from an ontology editor 3128, which is connected to the create ontology module 3116 and to receive input from either or both of an skos.owl and/or a cca.owl database 3130, 3132. The MAJAX utility 3120 may provide input to a .xml databse 3150 containing persisted objects, a Java database 3148, a messages.xml database 3146 and a .xlst database 3144, all of which may be a part of the drives Perspective Computing™ key components portion 3140 of a “Consultative, Responsibility, Accountability, Fairness and Transparency” (“CRAFT”) services application artifacts portion 3106. Also within the drives Perspective Computing™ key components portion 3140 is a .drl database 3142.

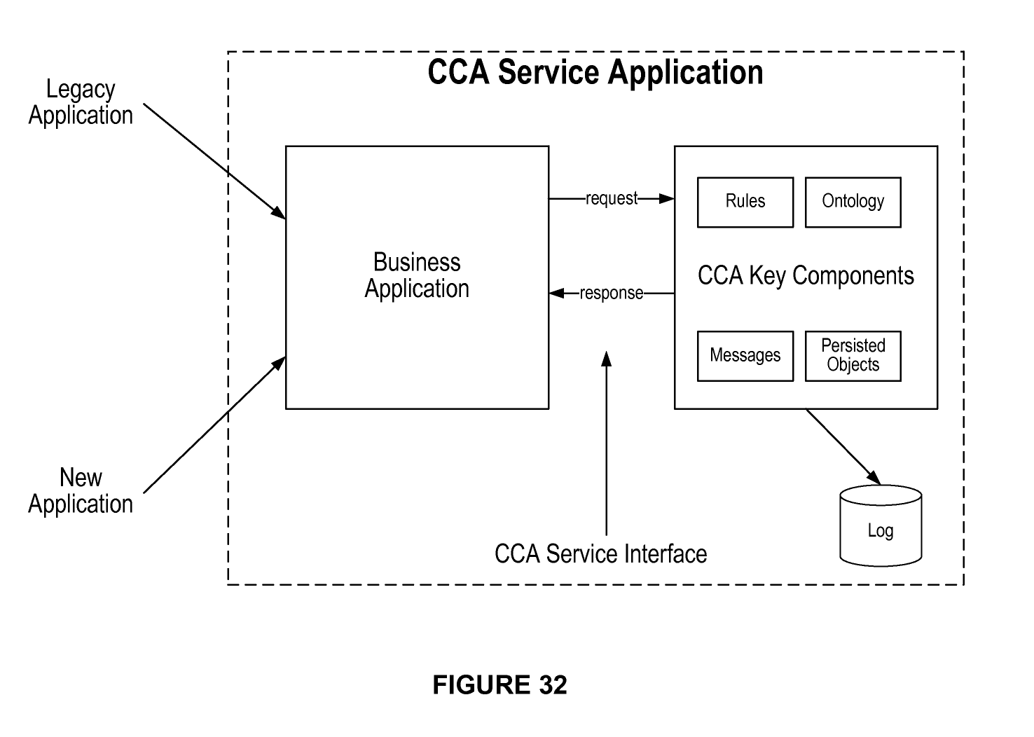

FIG. 32, by way of example, shows in block diagram and chart form a method and apparatus 3200 for implementing a Perspective Computing™ service application. The method and apparatus 3200 may include a CCA service application 3202. The CCA service application 3202 may further include a business application 3204 and a CCA key components functionality 3206. The business application 3204 may receive legacy application and new application inputs and may provide requests to and receive responses from the CCA key components functionality 3206 through a CCA service interface 3220. The CCA key components functionality 3206 may include ontology 3212, rules 3214 persisted objects 3216 and messages 3218 and may provide output to a log storage in a database 3208.

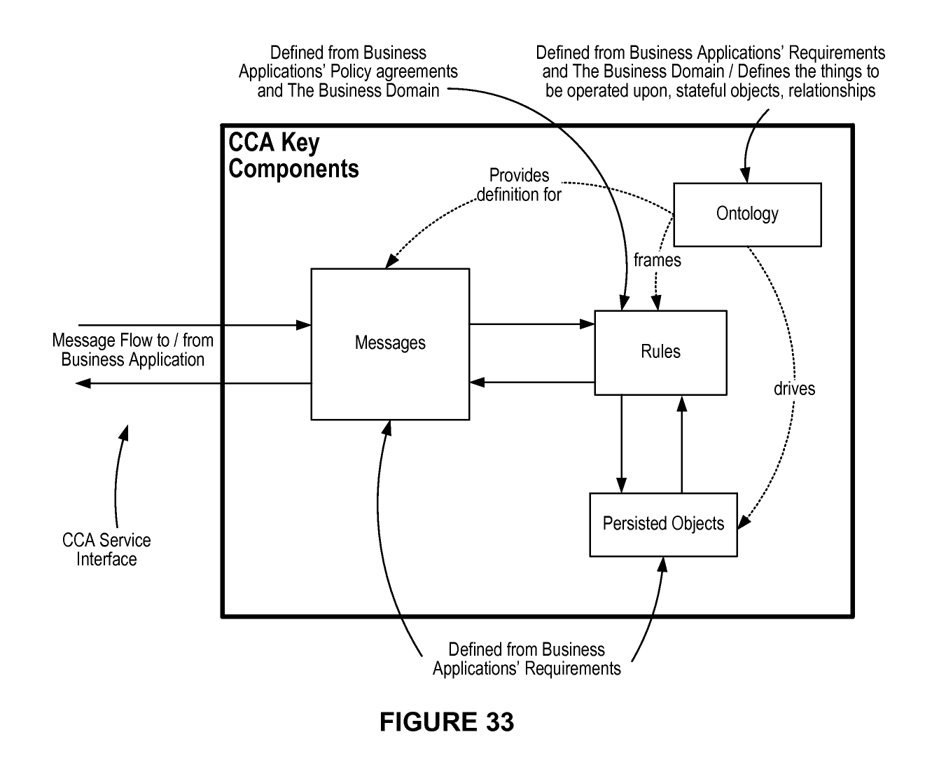

FIG. 33 by way of example, and in chart and block diagram form, discloses a method and apparatus 3300 for implementing Perspective Computing™ key components. The Perspective Computing™ key components 3302 may include messages 3304, rules 3306, ontology 3310 and persisted objects 3308. The ontology 3310 may have input 3330 defined from business application requirements and the business domain, and may define things to operate upon, stateful objects and relationships, and may provide inputs to the rules 3306 and persisted objects 3308. The rules 3306 may also receive input 3320 defined from business applications policy agreements and the business domain and may exchange input and output with the persisted objects 3308. The persisted objects 3308 may receive input 3340 defined from business applications requirements. The ontology 3310 may frame the rules 3306 and provide definition for the messages 3304. The messages 3304 exchange inputs and outputs with the rules 3306 and with a message flow from the business application. The messages may receive input 3312 defined by the business applications requirements.

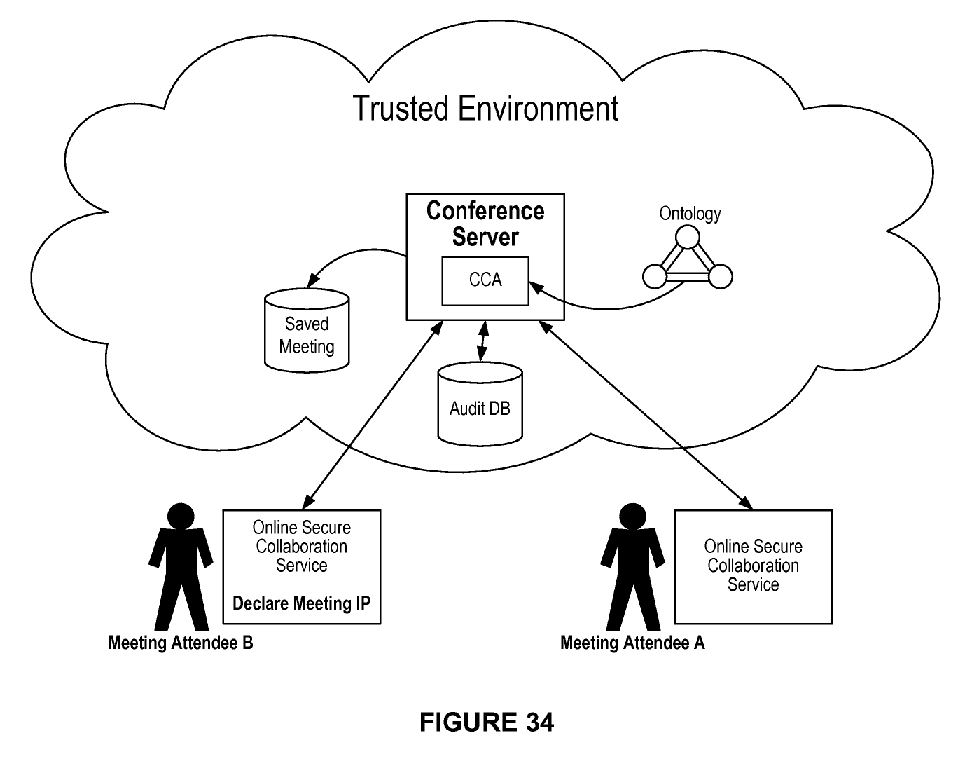

FIG. 34 shows in block diagram and chart form, by way of example, a method and apparatus for implementing IP tracking with IM. The method and apparatus 3400 may employ a trusted environment 3402, which may contain a conference server 3404, including a CCA module 3405, which conference server 3404 may receive input from an ontology 3410, and may supply information to a saved meeting database 3406 and an audit database 3408. The conference server may exchange information with an online secure collaboration service 3432 for an attendee 3430 and an online secure collaboration service 3422, implementing, declare meeting IP for an attendee 3420.

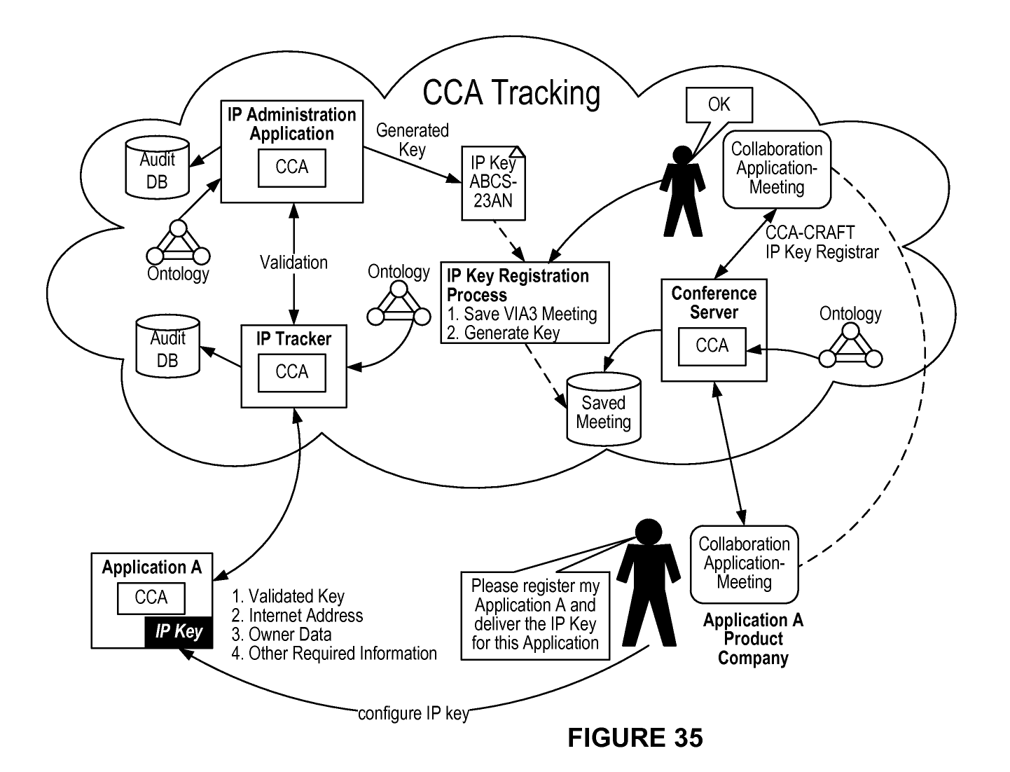

FIG. 35 shows in block diagram and chart form, as an example, a system and method 3500 for using a collaboration too, such as by licensing manager to manage intellectual property licensing. The system and method 3500 may include a CCA tracking functionality 3502. Within the CCA tracking 3502 may b an intellectual property (“IP”) administration application 3510 also containing its own CCA application. The IP administration application (“IPAA”) 3510 may be connected to a database 3512 containing audit information. The IPAA may be connected to and exchange validation information with an IP tracker 3520, also containing its own CCA module. The IP tracker may also be connected to a database 3522 containing audit information and may receive information from a business ontology 3526. The IPAA 3502 may also receive input from a business ontology 3514 and may generate a key and provide the generated key 3548 to an IP key registration process 3546, which may be conneaed to a database 3542 saving meeting information. A conference server 3540 also having its own CCA module may connect a CCA-CRAFT IP key registrar 3532 using a collaboration application meeting module 3532 and a requester 3560, requesting the registration of an application and the delivery of a registration key for the application, through a collaboration application meeting module 3562 at the company owning the application being registered. The conference server 3540 may also be connected to the saved meeting database 3542, where, e.g., a record of the meeting where the requester 3560 obtained from the registrar 3530 the IP identification key and the key itself, and also is connected to a business ontology 3544. The IP tracker 3520 may exchange information with an Application 3570 being registered by the user/requester 3560, and may include a CCA module 3572, for attaching the IP key 3574 configured by the user/requester 3560 along with information relating to the validated key, an Internet address, IP owner data and other required tracking information.

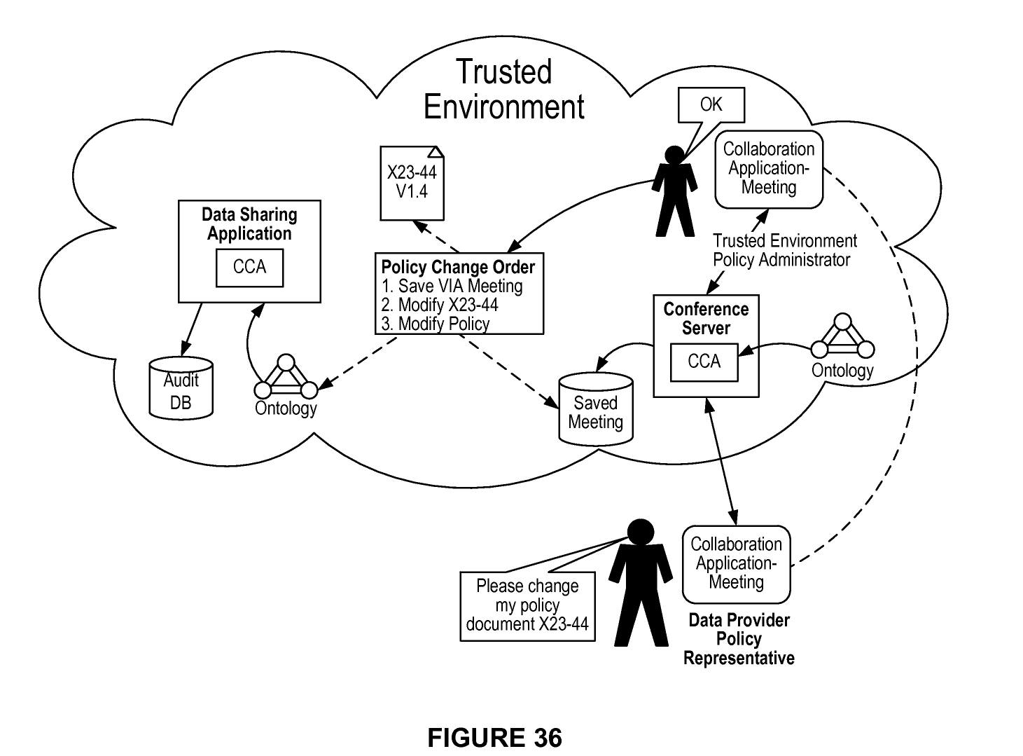

FIG. 36 shows by way of example, in block diagram and chart form, a system and method 3600 for tracking policy change requests. The system and method 3600 may operate within a trusted environment 3602. Within the trusted environment 3602 may reside a data sharing application 3610 having a CCA module and in connection with a database 3612 containing audit information and a business ontology 3614. A conference server 3640 havnig a CCA module may connect a collaborative application meeting 3662 for a user data provider policy representative 3660, requesting a change be made in a policy 3648, e.g., one represented by or contained within a document identified as an example as X23-44. The request may be made to a collaboration application meeting module 3632 being used by a trusted environment policy administrator 3630. The conference server may also be connected to a business ontology 3644 and may provide information about the collaboration meeting to a database 3642 containing information about the saved meeting and information about the policy change order to modify the policy in question as received from the administrator 3630.

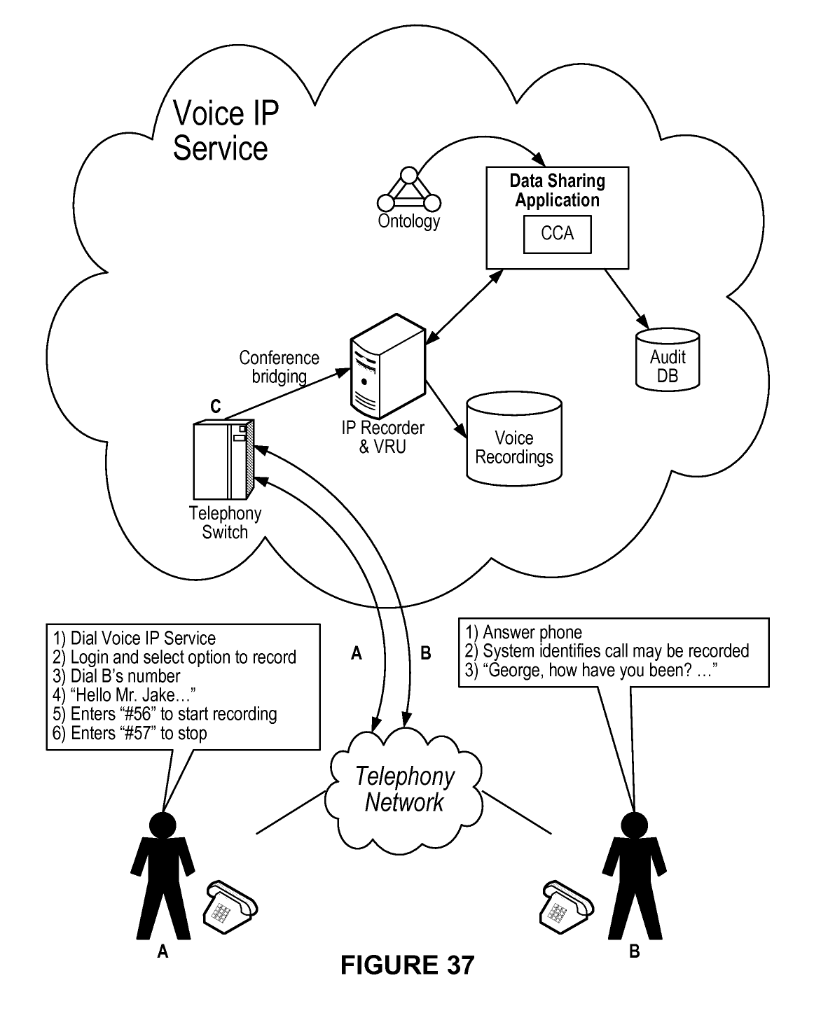

FIG. 37 illustrates, by way of example, in chart and block diagram for a system and method 3700 for IP tracking over the telephony system. The system and method 3700 may operate with a telephony system 3702, e.g., an Internet Protocol voice service 3702. A data sharing application 3710, having a CCA module may be in communication with a database 3712 storing audit information and with a business ontology 3714 and may exchange information with an Internet protocol recorder and voice recognition unit (WRIT), which may be connected to a database 3740, which may store information about telephone connection, such as voice recordings. A telephony switch 3746 may perform a telephone conference bridging function and provide information regarding same to the IP recorder and VRU. The telephony switch operates over the telephony network 3780, e.g., a voice over Internet protocol (“VoIP”) network and may connect a telephone 3762 of a user 3760 with a telephone 3772 of a user 3770, whereby, e.g., the user 3760 may select to have the telephony conversation with the user 3770 recorded, which may be done by the IP recorder and VRU 3744.

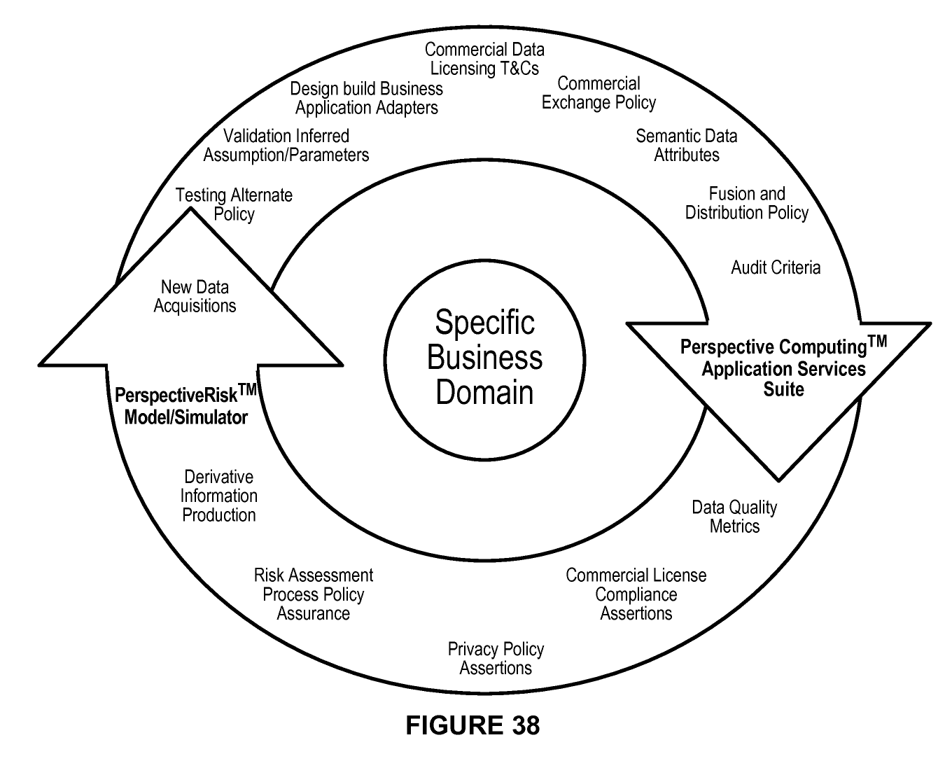

FIG. 38 illustrates in chart form elements 3800 of a specific business domain 3810 that may be utilized according to aspects of the disclosed and claimed subject matter of this application. A Perspective Computing™ services suite, as illustrated, may feed a Perspective Risk™ model simulator with new data acquisitions. The Perspective Computing™ applications services suite may include data quality metrics, commercial license compliance assertions, private policy assertions, risk assessment process policy assurance and derivative information production. The Perspective Risk™ model simulator suite may include audit criteria, fusion distribution policy, semantic data attributes, commercial exchange policy, commercial data licensing terms and conditions (“Ts&Cs”), design build business application adapters, validation inferred assumptions'/parameters and testing of alternate policy.

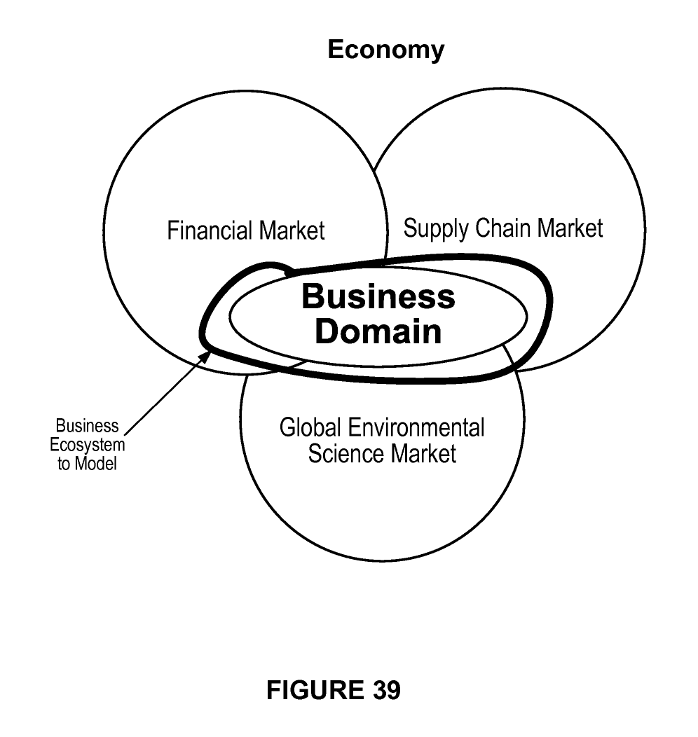

FIG. 39 illustrates in chart form a method and apparatus 3900 for business capability exploration, e.g., within a targeted business domain. Within an economy 3902 may be a business domain 3910 intersecting and operating with and within a financial market 3904, a supply chain market 3906 and a global environmental science market 3908, and the interactions of each of these may distort an original business domain 3910 into a business ecosystem that needs to be modeled.

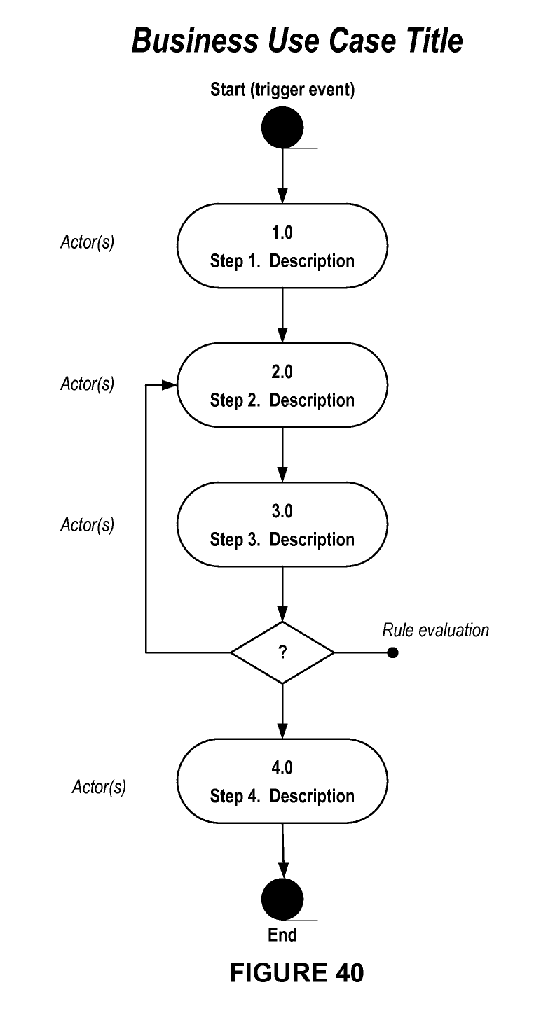

FIG. 40 shows, by way of example, a block diagram of a process 4000 for business use case analysis according to aspects of the disclosed and claimed subject matter of the present application. The business use case may have a title and may start at node 4002 and proceed to block 4004 where in a step 1, a description may be given to the business use case, which may define an actor(s) from one or more. In block 4006 a step 2 description may be given, which may define an actor(s) from one or more additional actors. In block 4008 a step 3 description may be given, which may define an actor(s) from one or more further actors. In decision block 4010 a decision may be made as to, e.g., whether all of the right actors are included, e.g., based on evaluation of some policy rule, and in block 4020 a step 4 describing all of the required actors is made and the process 4000 then proceeds to an end node 4030.

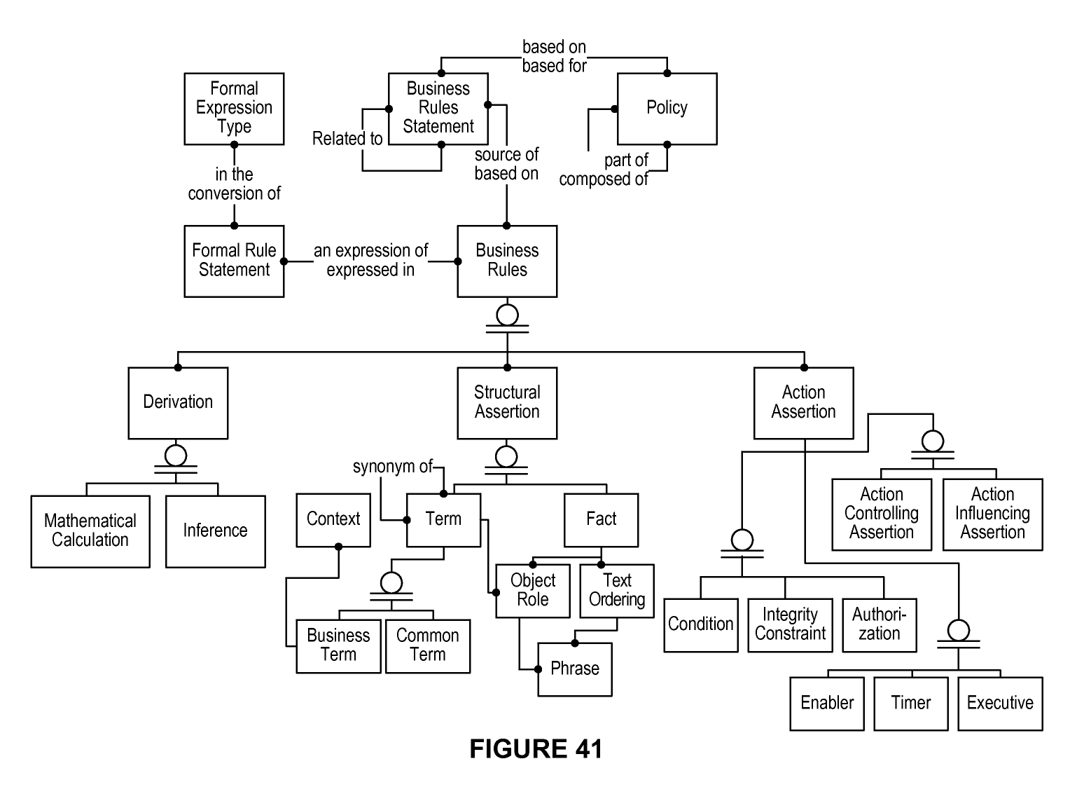

FIG. 41 shows in chart and block diagram form, as an example, a method and apparatus for a business rules model based on policy-characterized rule sets requirements 4100, Business rules 4110 may be based upon, composed of or part of policy 4118, which in turn may be based upon or based for or a source of business rules 4116, which may have other related business rules. Business rules may be an expression of or expressed in formal rules statements 4112, which may be based in the conversion of formal expression types. The business rules 4110 may be linked to derivation 4120, which may in turn be linked to inferences 4124 and/or mathematical calculation 4122. The business rules 4110 may be linked to structural assertions, which may in turn be linked to terms 4140 and facts 5152. Terms 4140 may be linked to business terms 4134 and common terms 4136 and the business terms 4134 may depend upon context 4138. The terms may have synonyms. The facts may depend from object rules 4154, which may be linked also to terms 4140, and to text ordering 4156. The business rules may be linked to action assertions 4162 which may in turn be linked to action controlling assertions 4166 and action influencing assertions 4168 and to conditions 4172, integrity constraints 4174 and authorizations 4176, as well as enablers 4182, timers 4184 and executives 4186.

FIG. 48 shows in block diagram and chart form relationships 4800 that may apply to aspects of embodiments of the disclosed subject matter. A message 4802 may cause a resource 4806 to act on the message 4802 and may have properties 4804 that the resource can act on.

What is claimed:

1. A system for measurement and verification of data related to at least one financial derivative instrument, wherein the data related to the at least one financial derivative instrument is associated with at least a first financial institution and a second financial institution, comprising:
at least one computer configured to collect during at least part of the term of the financial derivative instrument from at least one agent of at least one of the first financial institution and the second financial institution-data relating to at least one of:
(a) any change in any quality of the data metric related to the at least one financial derivative instrument, for any quality of data metric associated with the first financial institution; and
(b) any change in any quality of the data metric related to the at least one financial derivative instrument, for any second quality of data metric associated with the second financial institution; and
wherein the at least one computer is configured to dynamically map any change of the quality of the collected data, and provide a data provenance of the collected data.

2. The system of claim 1, wherein the Collected data relates to a plurality of financial derivative instruments.

3. The system of claim 1, wherein the financial derivative instrument is a financial instrument that is derived from some other asset, index, event, value or condition.

4. The system of claim 1, wherein each of the first and second financial institutions is selected from the group consisting of: (a) bank; (b) credit union; (c) hedge fund; (d) brokerage firm; (e) asset management firm; (f) insurance company.

5. The system of claim 1, wherein the data provenance is provided essentially continuously.

6. The system of claim 1, wherein the data provenance is-provided essentially in real-time.

7. The system of claim 1 further comprising:
the data provenance comprising at least one of lineage, pedigree, parentage, genealogy and affiliation of the information.

8. The system of claim 1 further comprising:
the data provenance comprising at least one of the origin and process of collection and provision to the database.

9. The system of claim 1 further comprising:
the data provenance comprising materials and transformations related to creating a derivative data product.

10. The system of claim 1 further comprising:
the data provenance comprising at least one of:
an event being recorded, the one of a person and an organization that recorded the event, where the event occurred, how the event transformed a resource, including at least one of assumptions made in defining the transformation and the process of the transformation, when the event occurred, the quality of the measurement of the change and the source of the original resource.

11. The system of claim 1 further comprising:
the data provenance being applied to determine the quality of the data.

12. The system of claim 1 further comprising:
the quality of the data being determined from at least one of the event being recorded, the process of the transformation, the person and organization and the where.

13. A system for assessing risk in an ongoing business financing arrangement comprising:
a computing device configured to provide a business financing model comprising an ontology comprising elements making up a domain of the business financing model, including the business financing arrangement, the domain including:
at least one borrower borrowing an amount of funding for one of a purchase or a lease of an asset, a lender providing the amount of the funding to the borrower according to an agreement between the borrower and the lender for the borrower to repay the lender the amount of the funding over a selected time period;
at least one protection seller, operating with the lender according to an agreement between the protection seller and the lender insuring the payment by the borrower to the lender of at least a portion of the amount of the funding over the selected time period;
at least one of the borrowing and the insuring being based on at least one of the borrower and the lender meeting a set of initial lending policy criteria established by at least one of the lender and the protection provider, the meeting of at least one of which criteria, as a variable criteria, being subject to change over the selected time period;
at least one agent of at least one of the lender and the protection provider collecting during at least a part of the term of the business financing arrangement information relevant to measuring any change in at least one variable lending policy criteria according to a definition of a relevant change in the lending policy criteria during the selected time period; and
the computing device configured to receive information collected by the agent and to provide an assurance of data provenance of the received information.

14. A method for assessing risk in an ongoing business financing arrangement comprising:
providing, via a computing device, a business financing model comprising an ontology comprising elements making up a domain of the business financing model, including the business financing arrangement, the domain including:
at least one borrower borrowing an amount of funding for one of a purchase or a lease of an asset, a lender providing the amount of the funding to the borrower according to an agreement between the borrower and the lender for the borrower to repay the lender the amount of the funding over a selected time period;
at least one protection seller, operating with the lender according to an agreement between the protection seller and the lender insuring the payment by the borrower to the lender of at least a portion of the amount of the funding over the selected time period;
at least one of the borrowing and the insuring being based on at least one of the borrower and the lender meeting a set of initial lending policy criteria established by at least one of the lender and the protection provider, the meeting of at least one of which criteria, as a variable criteria, being subject to change over the selected time period;
at least one agent of at least one of the lender and the protection provider collecting during at least a part of the term of the business financing arrangement information relevant to measuring any change in at least one variable lending policy criteria according to a definition of a relevant change in the lending policy criteria during the selected time period; and
providing, via the computing device, an assurance of data provenance of the collected information.

15. The method of claim 15 further comprising:
the data provenance comprising at least one of lineage, pedigree, parentage, genealogy and affiliation of the information.

16. The method of claim 15 further comprising:
the data provenance comprising at least one of the origin and process of collection and provision to the database.

17. The method of claim 15 further comprising:
the data provenance comprising materials and transformations related to creating a derivative data product.

18. The method of claim 15 further comprising:
the data provenance comprising at least one of:
an event being recorded, the one of a person and an organization that recorded the event, where the event occurred, how the event transformed a resource, including at least one of assumptions made in defining the transformation and the process of the transformation, when the event occurred, the quality of the measurement of the change and the source of the original resource.

19. The method of claim 15 further comprising:
the data provenance being applied to determine the quality of the data.

20. The method of claim 15 further comprising:
the quality of the data being determined from at least one of the event being recorded, the process of the transformation, the person and organization and the where.
